(19) United States
(12) Patent Application Publication
(10) Pub. No.: US 2022/0131146 A1
(43) Pub. Date: Apr. 28, 2022

(54) SECONDARY BATTERY AND ELECTRONIC DEVICE

(71) Applicant: SEMICONDUCTOR ENERGY LABORATORY CO., LTD., ATSUGI-SHI (JP)

(72) Inventors: Jo SAITO, Atsugi (JP); Yohei MOMMA, Isehara (JP); Kunihiro FUKUSHIMA, Isehara (JP); Shunsuke HOSOUMI, Fujisawa (JP); Kazuki TANEMURA, Isehara (JP); Tetsuya KAKEHATA, Isehara (JP); Shunpei YAMAZAKI, Tokyo (JP); Toshikazu OHNO, Atsugi (JP); Mayumi MIKAMI, Atsugi (JP); Tatsuyoshi TAKAHASHI, Atsugi (JP); Kazuya SHIMADA, Atsugi (JP)

(21) Appl. No.: 17/506,864

(22) Filed: Oct. 21, 2021

(30) Foreign Application Priority Data
Oct. 26, 2020 (JP) 2020-179129
Nov. 9, 2020 (JP) 2020-186325
Mar. 22, 2021 (JP) 2021-047835

(51) Int. Cl. H01M 4/58; H01M 10/0569; H01M 4/38; H01M 10/052

(52) U.S. Cl. CPC H01M 4/582; H01M 10/0569; H01M 2220/30; H01M 10/052; H01M 2300/0037; H01M 4/382

(57) ABSTRACT

The present invention relates to a secondary battery and an electronic device. The secondary battery includes a positive electrode active material which exhibits a broad peak at around 4.55 V in a dQ/dVvsV curve obtained when the charge depth is increased. The secondary battery includes a positive electrode active material which, even when the charge voltage is greater than or equal to 4.6 V and less than or equal to 4.8 V and the charge depth is greater than or equal to 0.8 and less than 0.9, does not have the H1-3 type structure and can maintain a crystal structure where a shift in CoO₂ layers is inhibited. The broad peak at around 4.55 V in the dQ/dVvsV curve indicates that a change in the energy necessary for extraction of lithium at around the voltage is small and a change in the crystal structure is small. Accordingly, the positive electrode active material hardly suffers a shift in CoO₂ layers and a volume change and is relatively stable even when the charge depth is large.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 to 3). Crystal structures of positive electrode active materials have also been studied (Non-Patent Documents 1 to 3).

X-ray diffraction (XRD) is one of methods used for analysis of a crystal structure of a positive electrode active material. With the use of the Inorganic Crystal Structure Database (ICSD) described in Non-Patent Document 4, XRD data can be analyzed.

### REFERENCES

### Patent Documents

[Patent Document 1] Japanese Published Patent Application No. 2019-179758
[Patent Document 2] PCT International publication No. 2020/026078
[Patent Document 3] Japanese Published Patent Application No. 2020-140954

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.
[Non-Patent Document 2] T. Motohashi et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 149 (12), 2002, A1604-A1609.
[Non-Patent Document 4] A. Belsky et al., “New developments in the Inorganic Crystal Structure Database (ICSD): accessibility in support of materials research and design”, Acta Cryst., B58, 2002, pp. 364-369.
[Non-Patent Document 5] W. S. Rasband, ImageJ, U. S. National Institutes of Health, Bethesda, Md., USA, http://rsb.info.nih.gov/ij/, 1997-2012.
[Non-Patent Document 6] C. A. Schneider, W. S. Rasband, K. W. Eliceiri, “NIH Image to ImageJ: 25 years of image analysis”, Nature Methods, 9, 2012, pp. 671-675.
[Non-Patent Document 7] M. D. Abramoff, P. J. Magelhaes, S. J. Ram, “Image Processing with ImageJ”, Biophotonics International, volume 11, issue 7, 2004, pp. 36-42.

### SUMMARY OF THE INVENTION

Development of lithium-ion secondary batteries and positive electrode active materials used therein has room for improvement in terms of charge and discharge capacity, cycle performance, reliability, safety, cost, and the like.

An object of one embodiment of the present invention is to provide a positive electrode active material or a composite oxide which can be used in a lithium-ion secondary battery and in which a charge and discharge capacity decrease due to charge and discharge cycles is suppressed. Another object is to provide a positive electrode active material or a composite oxide having a crystal structure that is unlikely to be broken by repeated charge and discharge. Another object is to provide a positive electrode active material or a composite oxide with high charge and discharge capacity. Another object is to provide a highly safe or highly reliable secondary battery.

Another object of one embodiment of the present invention is to provide a positive electrode active material, a composite oxide, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

To achieve any of the above objects, one embodiment of the present invention provides a positive electrode active material which exhibits a broad peak at around 4.55 V in a dQ/dVvsV curve obtained when the charge depth is increased. This broad peak indicates that a change in the energy necessary for extraction of lithium at around the voltage is small and a change in the crystal structure is small. Accordingly, the positive electrode active material hardly suffers a shift in CoO₂ layers and a volume change and is relatively stable even when the charge depth is large.

Another embodiment of the present invention can provide a positive electrode active material which, even when the charge voltage is greater than or equal to 4.6 V and less than or equal to 4.8 V and the charge depth is greater than or equal to 0.8 and less than 0.9, does not have the H1-3 type structure and can maintain a crystal structure where a shift in CoO₂ layers is inhibited.

Specifically, one embodiment of the present invention is a secondary battery including a positive electrode. In the case where the positive electrode is used as a positive electrode, a lithium metal is used for a negative electrode, and 1 mol/L lithium hexafluorophosphate and a mixture containing ethylene carbonate (EC) and diethyl carbonate (DEC) at a volume ratio of 3:7 and vinylene carbonate at 2 wt % are used for an electrolyte solution to form a battery; the battery is subjected to charge to 4.9 V at 10 mA/g in a 25-° C. environment; and capacitance (Q) and voltage (V) are measured during the charge, a dQ/dVvsV curve obtained by differentiation of the capacitance (Q) with the voltage (V) (dQ/dV) has a peak at greater than or equal to 4.5 V and less than or equal to 4.6 V, and the peak has a full width at half maximum of greater than or equal to 0.10.

A secondary battery of another embodiment of the present invention includes a positive electrode. In the case where the positive electrode is used as a positive electrode, a lithium metal is used for a negative electrode, and 1 mol/L lithium hexafluorophosphate and a mixture containing ethylene carbonate (EC) and diethyl carbonate (DEC) at a volume ratio of 3:7 and vinylene carbonate at 2 wt % are used for an electrolyte solution to form a battery; the battery is subjected to charge to 4.9 V at 10 mA/g in a 25-° C. environment; and capacitance (Q) and voltage (V) are measured during the charge, a dQ/dVvsV curve obtained by differentiation of the capacitance (Q) with the voltage (V) (dQ/dV) has a first peak at greater than or equal to 4.5 V and less than or equal to 4.6 V and a second peak at greater than or equal to 4.15 V and less than or equal to 4.25 V, and a ratio P1/P2 between an intensity P1 of the first peak and an intensity P2 of the second peak is less than or equal to 0.8.

A secondary battery of another embodiment of the present invention includes a positive electrode. In the case where the positive electrode is used as a positive electrode, a lithium metal is used for a negative electrode, and 1 mol/L lithium hexafluorophosphate and a mixture containing ethylene carbonate (EC) and diethyl carbonate (DEC) at a volume ratio of 3:7 and vinylene carbonate at 2 wt % are used for an electrolyte solution to form a battery; the battery is subjected to constant current charge to 4.75 V at 10 mA/g in a 45-° C. environment; and the positive electrode of the battery is then analyzed by powder X-ray diffraction with CuKα₁ radiation in an argon atmosphere to exhibit an XRD pattern having at least a diffraction peak at 2θ of 19.47±0.10° and a diffraction peak at 2θ of 45.62±0.05°.

A secondary battery of another embodiment of the present invention includes a positive electrode. In the case where the positive electrode is used as a positive electrode, a lithium metal is used for a negative electrode, and 1 mol/L lithium hexafluorophosphate and a mixture containing ethylene carbonate (EC) and diethyl carbonate (DEC) at a volume ratio of 3:7 and vinylene carbonate at 2 wt % are used for an electrolyte solution to form a battery; the battery is subjected to charge and discharge alternately repeated four times and subsequent constant current charge to 4.8 V at 10 mA/g in a 25-° C. environment, where the charge is constant current charge to 4.8 V at 100 mA/g and subsequent constant voltage charge to 10 mA/g and the discharge is constant current discharge to 2.5 V at 100 mA/g; and the positive electrode of the battery is then analyzed by powder X-ray diffraction with CuKα₁ radiation in an argon atmosphere to exhibit an XRD pattern having at least a diffraction peak at 2θ of 19.47±0.10° and a diffraction peak at 2θ of 45.62±0.05°.

Another embodiment of the present invention is a secondary battery in which, at the initial stage of charge and discharge cycles, a resistance component R(0.1 s) with a high response speed measured by a current-rest-method is lower in the n+1-th discharge (n is a natural number larger than 1) than in the n-th discharge and the n+1-th discharge capacity is higher than the n-th discharge capacity.

Another embodiment of the present invention is a secondary battery in which, in charge and discharge cycles, a resistance component R(0.1 s) with a high response speed has a minimum value in any of the second to tenth discharge and discharge capacity is the highest in any of the second to tenth discharge. The resistance component R(0.1 s) with a high response speed is a value obtained by performing a first step of performing constant current discharge at a current value of 100 mA/g for 5 minutes and a second step of performing a 2-minute break in which charge and discharge are not performed, and dividing, by the current value, a difference between voltage after 0.1 seconds after start of the second step and the final voltage in the first step.

In any of the above structures, it is preferable that a positive electrode active material of the positive electrode have a layered rock-salt crystal structure.

In any of the above structures, it is preferable that greater than or equal to 90 at % of a transition metal M of a positive electrode active material of the positive electrode be cobalt.

Another embodiment of the present invention is an electronic device including the above-described secondary battery, a display portion, and a sensor.

According to one embodiment of the present invention, a positive electrode active material or a composite oxide which can be used in a lithium-ion secondary battery and in which a charge and discharge capacity decrease due to charge and discharge cycles is suppressed can be provided. A positive electrode active material or a composite oxide having a crystal structure that is unlikely to be broken by repeated charge and discharge can be provided. A positive electrode active material or a composite oxide with high charge and discharge capacity can be provided. A highly safe or highly reliable secondary battery can be provided.

One embodiment of the present invention can provide a positive electrode active material, a power storage device, or a manufacturing method thereof.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

In the accompanying drawings:

FIGS. 1A to 1C illustrate methods for forming a positive electrode active material;

FIG. 2 illustrates a method for forming a positive electrode active material;

FIGS. 3A to 3C illustrate methods for forming a positive electrode active material;

FIG. 4A is a cross-sectional view of a positive electrode active material, and FIGS. 4B1, 4B2, 4C1, and 4C2 are cross-sectional views of part of the positive electrode active material;

FIGS. 5A1, 5A2, 5A3, and 5B show results of calculating magnesium distribution and a crystal plane;

FIGS. 6A and 6B are cross-sectional views of a positive electrode active material and FIGS. 6C1 and 6C2 are cross-sectional views of part of the positive electrode active material;

FIG. 7 is a cross-sectional view of a positive electrode active material;

FIG. 8 is a cross-sectional view of a positive electrode active material;

FIG. 9 illustrates a charge depth and crystal structures of a positive electrode active material;

FIG. 10 shows XRD patterns calculated from crystal structures;

FIG. 11 shows a charge depth and crystal structures of a reference positive electrode active material;

FIG. 12 shows XRD patterns calculated from crystal structures;

FIGS. 13A and 13B show XRD patterns calculated from crystal structures;

FIGS. 14A to 14C show lattice constants calculated using XRD;

FIGS. 15A to 15C show lattice constants calculated using XRD;

FIG. 16 is an example of a TEM image showing crystal orientations substantially aligned with each other;

FIG. 17A is an example of a STEM image showing crystal orientations substantially aligned with each other, FIG. 17B shows an FFT pattern of a region of a rock-salt crystal RS, and FIG. 17C shows an FFT pattern of a region of a layered rock-salt crystal LRS;

FIGS. 18A and 18B are cross-sectional views of an active material layer containing a graphene compound as a conductive material;

FIGS. 19A and 19B illustrate examples of a secondary battery;

FIGS. 20A to 20C illustrate an example of a secondary battery;

FIGS. 21A and 21B illustrate an example of a secondary battery;

FIGS. 22A to 22C illustrate a coin-type secondary battery;

FIGS. 23A to 23D illustrate a cylindrical secondary battery;

FIGS. 24A and 24B illustrate an example of a secondary battery;

FIGS. 25A to 25D illustrate examples of a secondary battery;

FIGS. 26A and 26B illustrate examples of a secondary battery;

FIG. 27 illustrates an example of a secondary battery;

FIGS. 28A to 28C illustrate a laminated secondary battery;

FIGS. 29A and 29B illustrate a laminated secondary battery;

FIG. 30 is an external view of a secondary battery;

FIG. 31 is an external view of a secondary battery;

FIGS. 32A to 32C illustrate a method for fabricating a secondary battery;

FIGS. 33A to 33H illustrate examples of electronic devices;

FIGS. 34A to 34C illustrate an example of an electronic device;

FIG. 35 illustrates examples of electronic devices;

FIGS. 36A to 36D illustrate examples of electronic devices;

FIGS. 37A to 37C illustrate examples of electronic devices;

FIGS. 38A to 38C illustrate examples of vehicles;

FIGS. 39A to 39F are surface SEM images of positive electrode active materials;

FIGS. 40A to 40H are surface SEM images of positive electrode active materials;

FIGS. 41A, 41B, and 41D are cross-sectional STEM images of a positive electrode active material, and FIGS. 41C and 41E show FFT patterns thereof;

FIG. 42A is a cross-sectional STEM image of a positive electrode active material, and FIGS. 42B1, 42B2, 42C1, 42C2, 42D1, and 42D2 are EDX mapping images thereof;

FIGS. 43A1, 43A2, 43A3, 43B1, 43B2, 43B3, 43C1, 43C2-1, 43C3-1, 43C2-2, and 43C3-2 are cross-sectional STEM images of a positive electrode active material, and FIGS. 43A4, 43A5, 43A6, 43B4, 43B5, 43B6, 43C4-1, 43C5-1, 43C6-1, 43C4-2, 43C5-2, and 43C6-2 are EDX mapping images thereof;

FIGS. 44A1, 44A2, 44A3, 44B1, 44B2, 44B3, 44C1, 44C2-1, 44C3-1, 44C2-2, and 44C3-2 are cross-sectional STEM images of a positive electrode active material, and FIGS. 44A4, 44A5, 44A6, 44B4, 44B5, 44B6, 44C4-1, 44C5-1, 44C6-1, 44C4-2, 44C5-2, and 44C6-2 are EDX mapping images thereof;

FIGS. 45A and 45B are measurement results of particle size distribution in a positive electrode active material;

FIGS. 46A to 46C are surface SEM images of positive electrode active materials;

FIGS. 47A to 47C are graphs showing distribution of grayscale values of positive electrode active materials;

FIGS. 48A to 48C are luminance histograms of positive electrode active materials;

FIGS. 49A to 49D are graphs showing cycle performance of secondary batteries;

FIGS. 50A to 50D are graphs showing cycle performance of secondary batteries;

FIGS. 51A to 51D are graphs showing cycle performance of secondary batteries;

FIGS. 52A to 52D are graphs showing cycle performance of secondary batteries;

FIGS. 53A and 53B are graphs showing cycle performance of secondary batteries;

FIG. 54A is a photograph of an LCO pellet and FIGS. 54B and 54C are surface SEM images of a positive electrode active material;

FIG. 55A is a surface SEM image of a positive electrode active material and FIG. 55B is a cross-sectional STEM image thereof;

FIGS. 56A1 and 56B1 are cross-sectional HAADF-STEM images of a positive electrode active material and FIGS. 56A2, 56A3, 56A4, 56B2, 56B3, and 56B4 are EDX mapping images thereof;

FIG. 57 shows a dQ/dVvsV curve of a secondary battery;

FIG. 58 shows a dQ/dVvsV curve of a secondary battery;

FIG. 59 shows a dQ/dVvsV curve of a secondary battery;

FIG. 60 shows XRD patterns of a positive electrode;

FIGS. 61A and 61B show enlarged portions of XRD patterns of FIG. 60;

FIG. 62 shows XRD patterns of a positive electrode;

FIGS. 63A and 63B show enlarged portions of XRD patterns of FIG. 62;

FIG. 64 shows XRD patterns of a positive electrode;

FIGS. 65A and 65B show enlarged portions of XRD patterns of FIG. 64;

FIG. 66 shows XRD patterns of a positive electrode;

FIGS. 67A and 67B show enlarged portions of XRD patterns of FIG. 66;

FIG. 68 shows XRD patterns of a positive electrode;

FIGS. 69A and 69B show enlarged portions of XRD patterns of FIG. 68;

FIG. 70 shows XRD patterns of a positive electrode;

FIGS. 71A and 71B show enlarged portions of XRD patterns of FIG. 70;

FIG. 72 shows XRD patterns of a positive electrode;

FIGS. 73A and 73B show enlarged portions of XRD patterns of FIG. 72;

FIG. 74 shows XRD patterns of a positive electrode;

FIGS. 75A and 75B show enlarged portions of XRD patterns of FIG. 74;

FIG. 76 shows XRD patterns of a positive electrode;

FIGS. 77A and 77B show enlarged portions of XRD patterns of FIG. 76;

FIG. 78 shows diagrams relating to powder resistivity measurement;

FIG. 79 is a graph showing discharge curves obtained in measurement by a current-rest-method;

FIG. 80 illustrates an analysis method for measurement by a current-rest-method;

FIGS. 81A and 81B show analysis results of measurement by a current-rest-method; and

FIG. 82 shows analysis results of measurement by a current-rest-method.

### DETAILED DESCRIPTION OF THE INVENTION

Hereinafter, examples of embodiments of the present invention will be described with reference to the drawings and the like. Note that the present invention should not be construed as being limited to the examples of embodiments given below. Embodiments of the invention can be changed unless it deviates from the spirit of the present invention.

In this specification and the like, the Miller index is used for the expression of crystal planes and crystal orientations. An individual plane that shows a crystal plane is denoted by “( )”. In the crystallography, a bar is placed over a number in the expression of crystal planes, crystal orientations, and space groups; in this specification and the like, because of format limitations, crystal planes, crystal orientations, and space groups are sometimes expressed by placing a minus sign (−) in front of a number instead of placing a bar over the number.

In this specification and the like, a theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification, a charge depth is a value indicating the degree of charge, i.e., the amount of lithium extracted from a positive electrode active material, relative to the theoretical capacity of a positive electrode active material. For example, in the case of a positive electrode active material having a layered rock-salt structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no lithium has been extracted from the positive electrode; a charge depth of 0.5 indicates a state where lithium corresponding to 137 mAh/g has been extracted from the positive electrode active material; and a charge depth of 0.8 indicates a state where lithium corresponding to 219.2 mAh/g has been extracted from the positive electrode active material, relative to the theoretical capacity of 274 mAh/g. In the case where an expression LiₐCoO₂ (0≤a≤1) is used, LiₐCoO₂ (0≤a≤1) is LiCoO₂ where a is 1 when the charge depth is 0; LiₐCoO₂ (0≤a≤1) is Li_{0.5}CoO₂ where a is 0.5 when the charge depth is 0.5; and LiₐCoO₂ (0≤a≤1) is Li_{0.2}CoO₂ where a is 0.2 when the charge depth is 0.8.

In this specification and the like, an approximate value of a given value A refers to a value greater than or equal to 0.9×A and less than or equal to 1.1×A.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charge and discharge and excellent cycle performance, are not affected by the material of the negative electrode. An example where the secondary battery of one embodiment of the present invention including a counter electrode of lithium is charged and discharged at a charge voltage of approximately 4.7 V, which is higher than a typical charge voltage, will be described; however, charge and discharge may be performed at a lower voltage. Charge and discharge at a lower voltage will result in cycle performance better than that described in this specification and the like.

In this specification and the like, a charge voltage and a discharge voltage are voltages in the case of using a counter electrode of lithium, unless otherwise specified. Note that even when the same positive electrode is used, the charge and discharge voltages of a secondary battery vary depending on the material used for the negative electrode. For example, the potential of graphite is approximately 0.1 V (vs Li/Li⁺); hence, the charge and discharge voltages in the case of using a negative electrode of graphite are lower than those in the case of using a counter electrode of lithium by approximately 0.1 V. In this specification, even in the case where the charge voltage of a secondary battery is, for example, 4.7 V or more, the plateau region of the discharge voltage does not need to be 4.7 V or more.

### Embodiment 1

In this embodiment, a method for forming a positive electrode active material which is one embodiment of the present invention is described.

### <<Formation Method 1 of Positive Electrode Active Material>>

### <Step S11>

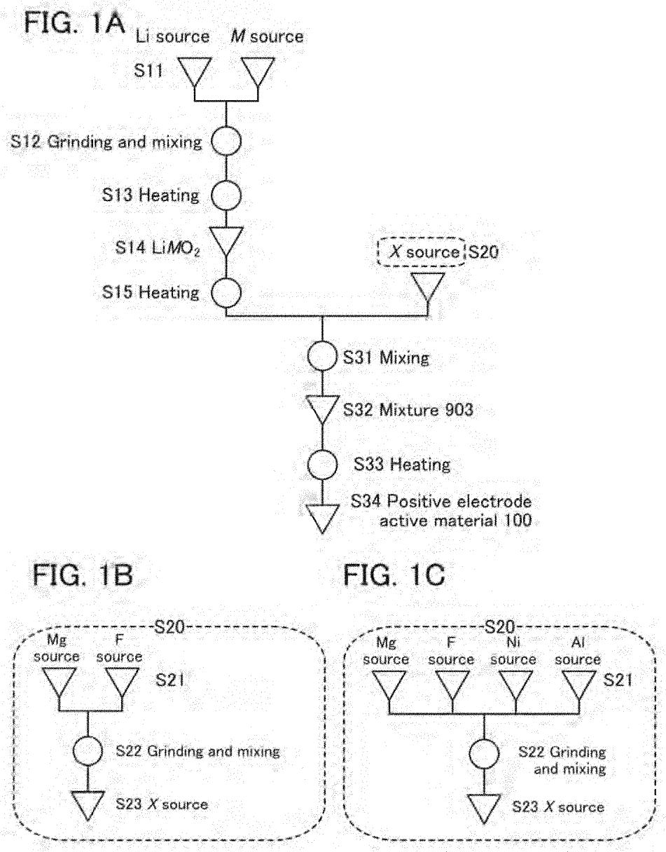

In Step S11 shown in FIG. 1A, a lithium source (Li source) and a transition metal M source (M source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal M can be selected from the elements belonging to Groups 4 to 13 of the periodic table and for example, at least one of manganese, cobalt, and nickel is used. As the transition metal M, cobalt alone; nickel alone; cobalt and manganese; cobalt and nickel; or cobalt, manganese, and nickel can be used. When the transition metal M is cobalt alone, the positive electrode active material to be obtained contains lithium cobalt oxide (LCO); when the transition metal M is cobalt, manganese, and nickel, the positive electrode active material to be obtained contains lithium nickel cobalt manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal M source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the transition metal source preferably has high crystallinity and for example, the transition metal source preferably includes single crystal particles. The crystallinity of the transition metal source can be evaluated with a transmission electron microscope (TEM) image, a scanning transmission electron microscope (STEM) image, a high-angle annular dark-field scanning transmission electron microscope (HAADF-STEM) image, or an annular bright-field scanning transmission electron microscope (ABF-STEM) image or by X-ray diffraction (XRD), electron diffraction, neutron diffraction, or the like. Note that the above methods for evaluating crystallinity can also be employed to evaluate the crystallinity of materials other than the transition metal source.

In the case of using two or more transition metal sources, the two or more transition metal sources are preferably prepared to have proportions (mixing ratio) such that a layered rock-salt crystal structure would be obtained.

### <Step S12>

Next, in Step S12 shown in FIG. 1A, the lithium source and the transition metal source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity of higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 1A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is preferably longer than or equal to 1 hour and shorter than or equal to 100 hours, further preferably longer than or equal to 2 hours and shorter than or equal to 20 hours.

A temperature raising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter into the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and after that, the exit of the atmosphere and the entry of the outside atmosphere are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A sagger (which may be referred to as a container or a crucible) used at the time of the heating is preferably made of aluminum oxide. An aluminum oxide sagger does not release impurities. In this embodiment, a sagger made of aluminum oxide with a purity of 99.9% is used. The heating is preferably performed with the sagger covered with a lid, in which case volatilization of a material can be prevented.

The heated material is ground as needed and may be made to pass through a sieve. Before collection of the heated material, the material may be moved from the crucible to a mortar. As the mortar, an aluminum oxide mortar can be suitably used. An aluminum oxide mortar does not release impurities. Specifically, a mortar made of aluminum oxide with a purity of higher than or equal to 90%, preferably higher than or equal to 99% is used. Note that heating conditions equivalent to those in Step S13 can be employed in a later-described heating step other than Step S13.

### <Step S14>

Through the above steps, a composite oxide including the transition metal (LiMO₂) can be obtained in Step S14 shown in FIG. 1A. The composite oxide needs to have a crystal structure of a lithium composite oxide represented by LiMO₂, but the composition is not strictly limited to Li:M:O=1:1:2. When the transition metal is cobalt, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, in Step S15 shown in FIG. 1A, the above composite oxide is heated. The heating in Step S15 is the first heating performed on the composite oxide and thus, this heating is sometimes referred to as the initial heating. Through the initial heating, the surface of the composite oxide becomes smooth. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

The initial heating is heating performed after a composite oxide is obtained. The present inventors have found that the initial heating for making the surface smooth can reduce degradation after charge and discharge. The initial heating for making the surface smooth does not need a lithium compound source.

Alternatively, the initial heating for making the surface smooth does not need an added element source.

Alternatively, the initial heating for making the surface smooth does not need a flux.

The initial heating is performed before Step S20 described below and is sometimes referred to as preheating or pretreatment.

The lithium source and/or transition metal source prepared in Step S11 and the like might contain impurities. The initial heating can reduce impurities in the composite oxide obtained in Step S14.

The heating conditions in this step can be freely set as long as the heating makes the surface of the above composite oxide smooth. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours.

The heating in Step S13 might cause a temperature difference between the surface and an inner portion of the composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth, or “surface improvement is achieved”, through Step S15. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift in a crystal or the like which is caused in the composite oxide to make the surface of the composite oxide smooth.

In a secondary battery including a composite oxide with a smooth surface as a positive electrode active material, degradation by charge and discharge is suppressed and a crack in the positive electrode active material can be prevented.

It can be said that when surface unevenness information in one cross section of a composite oxide is quantified with measurement data, a smooth surface of the composite oxide has a surface roughness of less than or equal to 10 nm. The one cross section is, for example, a cross section obtained in observation using a scanning transmission electron microscope (STEM).

Note that a pre-synthesized composite oxide containing lithium, a transition metal, and oxygen may be used in Step S14. In this case, Steps S11 to S13 can be skipped. When Step S15 is performed on the pre-synthesized composite oxide, a composite oxide with a smooth surface can be obtained.

The initial heating might decrease lithium in the composite oxide. An added element described for Step S20 below might easily enter the composite oxide owing to the decrease in lithium.

### <Step S20>

An added element X may be added to the composite oxide having a smooth surface as long as a layered rock-salt crystal structure can be obtained. When the added element X is added to the composite oxide having a smooth surface, the added element can be uniformly added. It is thus preferable that the initial heating precede the addition of the added element. The step of adding the added element is described with reference to FIGS. 1B and 1C.

### <Step S21>

In Step S21 shown in FIG. 1B, added element sources to be added to the composite oxide are prepared. A lithium source may be prepared in addition to the added element sources.

As the added element, one or more elements selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the added element, bromine and/or beryllium can be used. Note that the elements given earlier are more suitable since bromine and beryllium are elements having toxicity to living things.

When magnesium is selected as the added element, the added element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the added element, the added element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating process described later owing to its relatively low melting point of 848° C.

Magnesium fluoride can be used as both the fluorine source and the magnesium source. Lithium fluoride can be used as both a lithium source and the fluorine source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might deteriorate because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, the expression “an approximate value of a given value” means greater than 0.9 times and smaller than 1.1 times the given value.

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charge and discharge with a large charge depth rapidly lowers the discharge capacity. In the case where magnesium is added at greater than 0.1 at % and less than or equal to 3 at %, both the initial discharge characteristics and charge and discharge cycle performance are excellent even when charge and discharge with a large charge depth are repeated. By contrast, in the case where magnesium is added at greater than 3 at %, both the initial discharge capacity and the charge and discharge cycle performance tend to gradually degrade.

### <Step S22>

Next, in Step S22 shown in FIG. 1B, the magnesium source and the fluorine source are ground and mixed. Any of the conditions for the grinding and mixing that are described for Step S12 can be selected to perform Step S22.

A heating step may be performed after Step S22 as needed. For the heating step, any of the heating conditions described for Step S13 can be selected. The heating time is preferably longer than or equal to 2 hours and the heating temperature is preferably higher than or equal to 800° C. and lower than or equal to 1100° C.

### <Step S23>

Next, in Step S23 shown in FIG. 1B, the materials ground and mixed in the above step are collected to give the added element source (X source). Note that the added element source in Step S23 contains a plurality of starting materials and can be referred to as a mixture.

As for the particle diameter of the mixture, its D50 (median diameter) is preferably greater than or equal to 600 nm and less than or equal to 20 μm, further preferably greater than or equal to 1 μm and less than or equal to 10 μm. Also when one kind of material is used as the added element source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the added element) is easily attached to the surface of a composite oxide particle uniformly in a later step of mixing with the composite oxide. The mixture is preferably attached uniformly to the surface of the composite oxide particle, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, an O3′ type structure and an O3″ type structure, which are described later, might be unlikely to be obtained in a charged state. Note that although fluorine is used in the above description, chlorine may be used instead of fluorine, and a general term “halogen” for these elements can replace “fluorine”.

### <Step S21>

A process different from that in FIG. 1B is described with reference to FIG. 1C. In Step S21 shown in FIG. 1C, four kinds of added element sources to be added to the composite oxide are prepared. In other words, FIG. 1C is different from FIG. 1B in the kinds of the added element sources. A lithium source may be prepared together with the added element sources.

As the four kinds of added element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 1B. As the nickel source, nickel oxide, nickel hydroxide, or the like can be used. As the aluminum source, aluminum oxide, aluminum hydroxide, or the like can be used.

<Steps S22 and S23>

Step S22 and Step S23 shown in FIG. 1C are similar to the steps described with reference to FIG. 1B.

### <Step S31>

Next, in Step S31 shown in FIG. 1A, the composite oxide and the added element source (X source) are mixed. The atomic ratio of the transition metal Min the composite oxide containing lithium, the transition metal, and oxygen to magnesium Mg in the X source (M:Mg) is preferably 100:y (0.1≤y≤6), further preferably 100:y (0.3≤y≤3).

The mixing in Step S31 is preferably performed under milder conditions than the mixing in Step S12, in order not to damage the composite oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 1A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal source in Step S11, i.e., at the stage of the starting materials of the composite oxide. Then, the heating in Step S13 is performed, so that LiMO₂ to which magnesium and fluorine are added can be obtained. In that case, there is no need to separately perform Steps S11 to S14 and Steps S21 to S23, so that the method is simplified and enables increased productivity.

Alternatively, lithium cobalt oxide to which magnesium and fluorine are added in advance may be used. When lithium cobalt oxide to which magnesium and fluorine are added is used, Steps S11 to S32 and Step S20 can be skipped, so that the method is simplified and enables increased productivity.

Alternatively, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 1A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the added element source proceeds. The temperature at which the reaction proceeds is the temperature at which interdiffusion of the elements included in LiMO₂ and the added element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the added element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the decomposition temperature of the composite oxide (LiMO₂), e.g., higher than or equal to 742° C. and lower than or equal to 950° C., which allows distribution of the added element such as magnesium in the surface portion and formation of a positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiMO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the added element (e.g., fluorine) in the surface portion leads to a smooth positive electrode active material with little unevenness. Thus, it is preferable that the particles not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid.

A supplementary explanation of the heating time is provided. The heating time depends on conditions such as the heating temperature and the particle size and composition of LiMO₂ in Step S14. The heating may be preferably performed at a lower temperature or for a shorter time in the case where the particle size is small than in the case where the particle size is large.

In the case where the composite oxide (LiMO₂) in Step S14 in FIG. 1A has a median diameter (D50) of approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the time for lowering the temperature after the heating is preferably longer than or equal to 10 hours and shorter than or equal to 50 hours, for example.

In the case where the composite oxide (LiMO₂) in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 1A, in which crushing is performed as needed; thus, a positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

Next, as one embodiment of the present invention, a method different from the formation method 1 of a positive electrode active material is described.

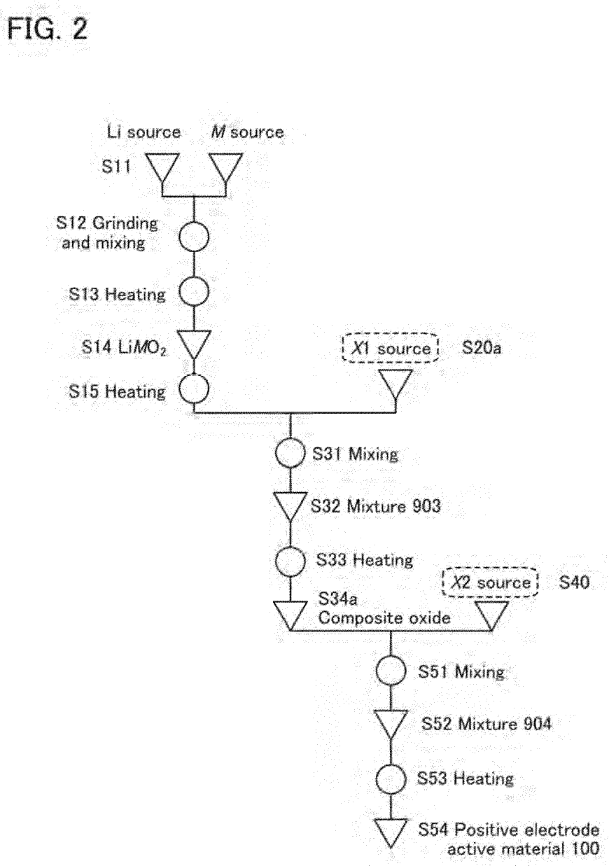

Steps S11 to S15 in FIG. 2 are performed as in FIG. 1A to prepare a composite oxide (LiMO₂) having a smooth surface.

### <Step S20a>

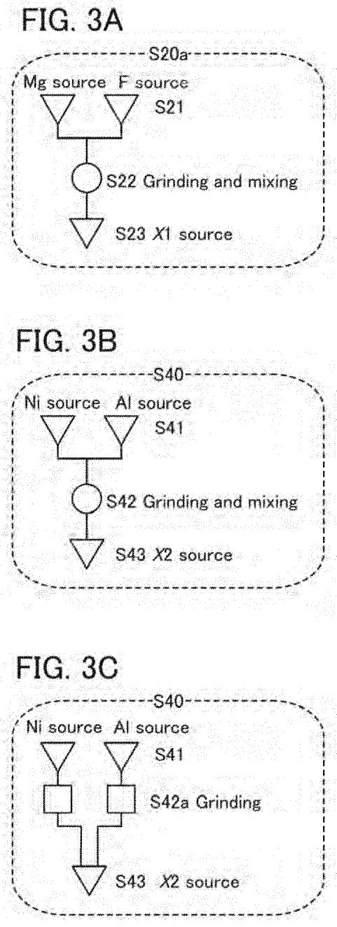

As already described above, the added element X may be added to the composite oxide as long as a layered rock-salt crystal structure can be obtained. The formation method 2 has two or more steps of adding the added element, as described below with reference to FIGS. 3A to 3C.

### <Step S21>

In Step S21 shown in FIG. 3A, a first added element source is prepared. As the first added element source, any of the examples of the added element X described for Step S21 with reference to FIG. 1B can be used. For example, one or more elements selected from magnesium, fluorine, and calcium can be suitably used as the added element X1. FIG. 3A shows an example of using a magnesium source (Mg source) and a fluorine source (F source) as the added element X1.

Steps S21 to S23 shown in FIG. 3A can be performed under conditions similar to those of Steps S21 to S23 shown in FIG. 1B, whereby an added element source (X1 source) can be obtained in Step S23.

Steps S31 to S33 shown in FIG. 2 can be performed in a manner similar to that of Steps S31 to S33 shown in FIG. 1A.

### <Step S34a>

Next, the material heated in Step S33 is collected to give a composite oxide containing the added element X1. This composite oxide is called a second composite oxide to be distinguished from the composite oxide in Step S14.

### <Step S40>

In Step S40 shown in FIG. 2, a second added element source is added. FIGS. 3B and 3C are referred to in the following description.

### <Step S41>

In Step S41 shown in FIG. 3B, the second added element source is prepared.

As the second added element source, any of the examples of the added element X described for Step S21 with reference to FIG. 1B can be used. For example, one or more elements selected from nickel, titanium, boron, zirconium, and aluminum can be suitably used as the added element X2. FIG. 3B shows an example of using nickel and aluminum as the added element X2.

Steps S41 to S43 shown in FIG. 3B can be performed under conditions similar to those of Steps S21 to S23 shown in FIG. 1B, whereby an added element source (X2 source) can be obtained in Step S43.

FIG. 3C shows a modification example of the steps which are described with reference to FIG. 3B. A nickel source (Ni source) and an aluminum source (Al source) are prepared in Step S41 shown in FIG. 3C and are separately ground in Step S42a. Accordingly, a plurality of second added element sources (X2 sources) are prepared in Step S43. FIG. 3C is different from FIG. 3B in separately grinding the added elements in Step S42a.

### <Steps S51 to S53>

Next, Steps S51 to S53 shown in FIG. 2 can be performed under conditions similar to those of Steps S31 to S34 shown in FIG. 1A. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 2 and FIGS. 3A to 3C, in the formation method 2, introduction of the added element to the composite oxide is separated into introduction of the added element X1 and that of the added element X2. When the elements are separately introduced, the added elements can have different profiles in the depth direction. For example, the added element X1 can have a profile such that the concentration is higher in the surface portion than in the inner portion, and the added element X2 can have a profile such that the concentration is higher in the inner portion than in the surface portion.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the added element to the composite oxide, the adding step is preferably performed after the initial heating. The adding step may be separated into two or more steps. Such an order of steps is preferred in order to maintain the smoothness of the surface achieved by the initial heating. When a composite oxide contains cobalt as a transition metal, the composite oxide can be read as a composite oxide containing cobalt.

This embodiment can be implemented in combination with any of the other embodiments.

### Embodiment 2

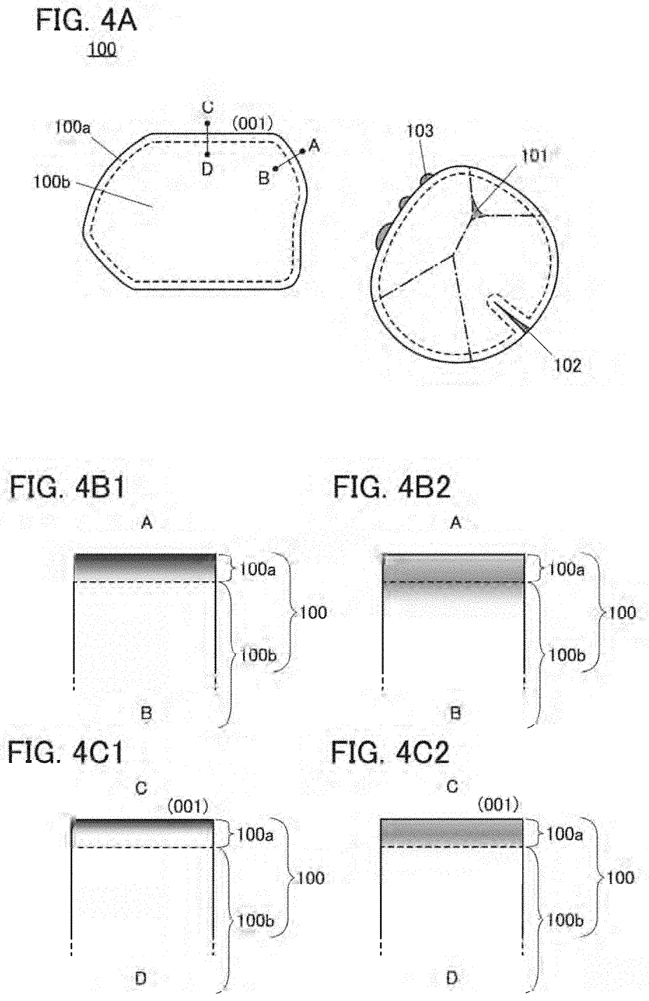

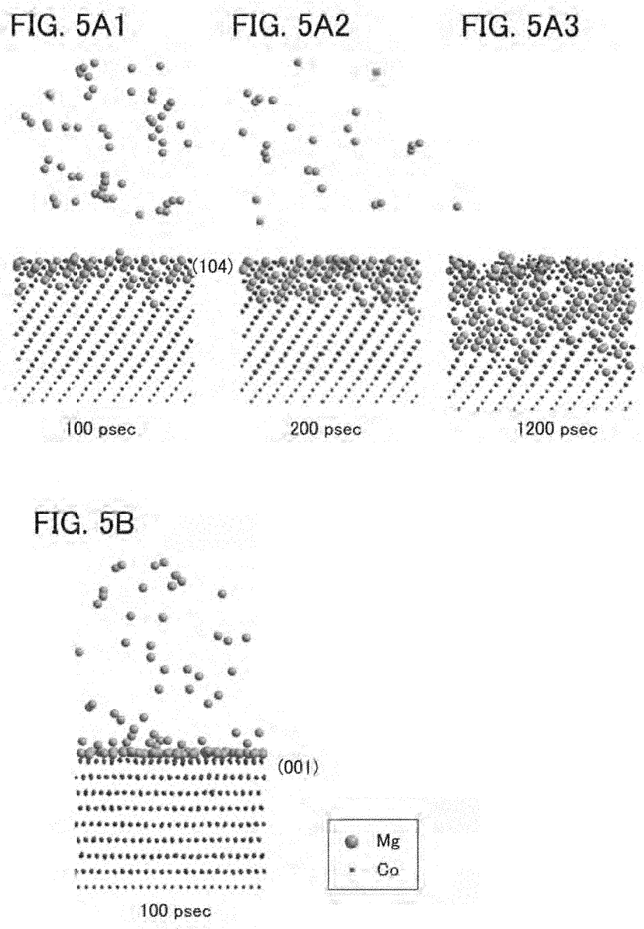

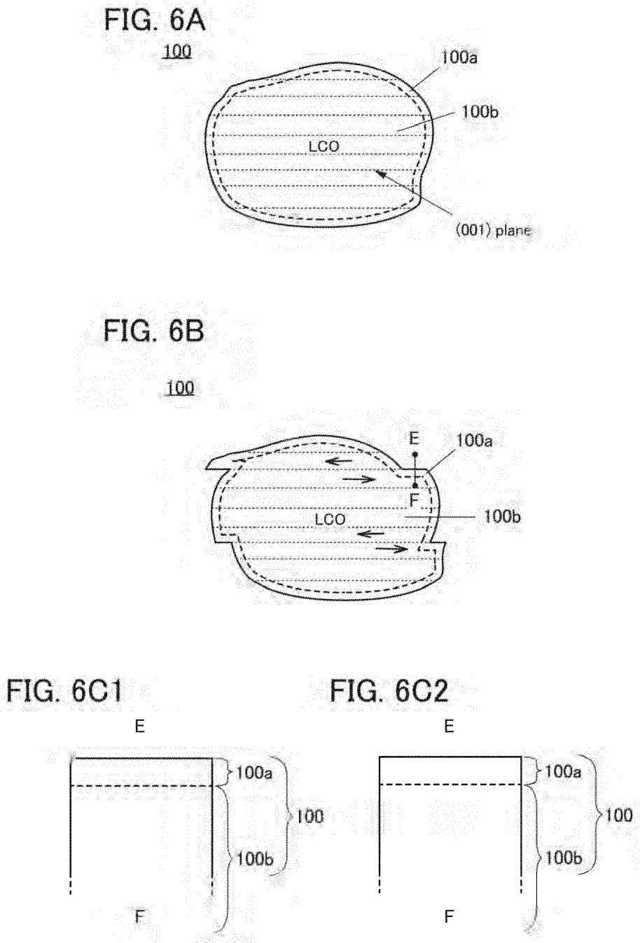

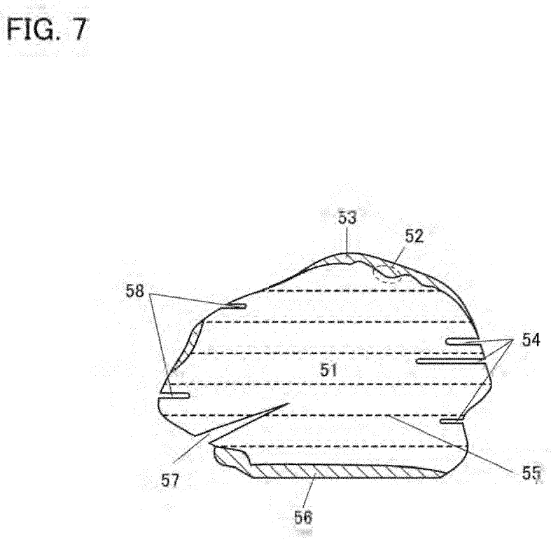

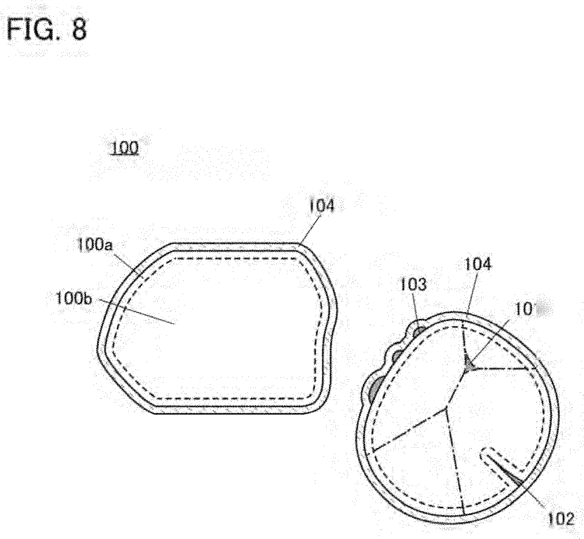

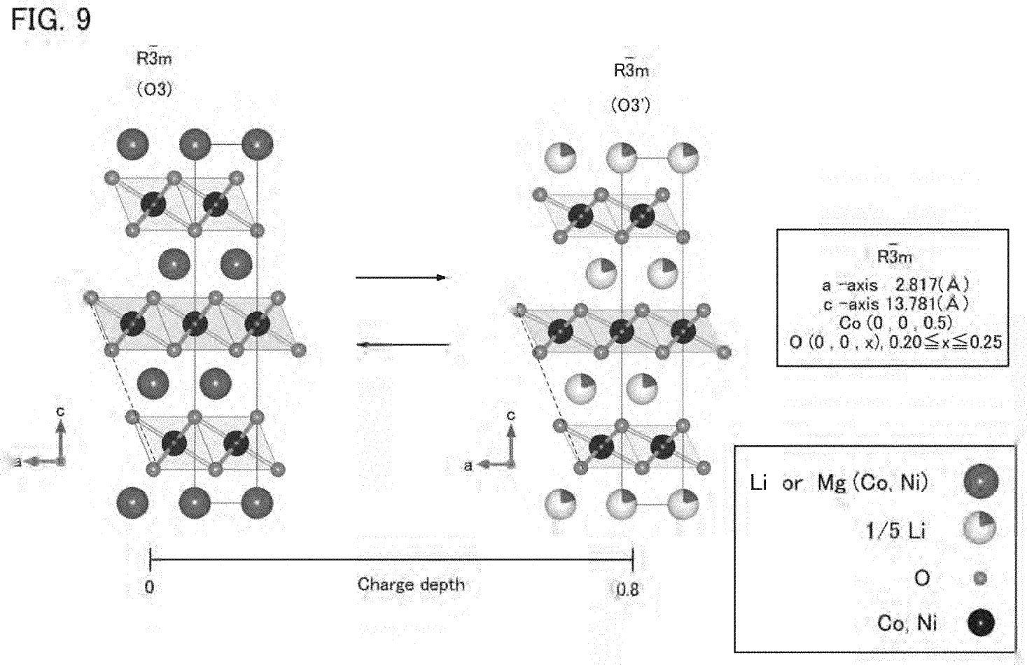

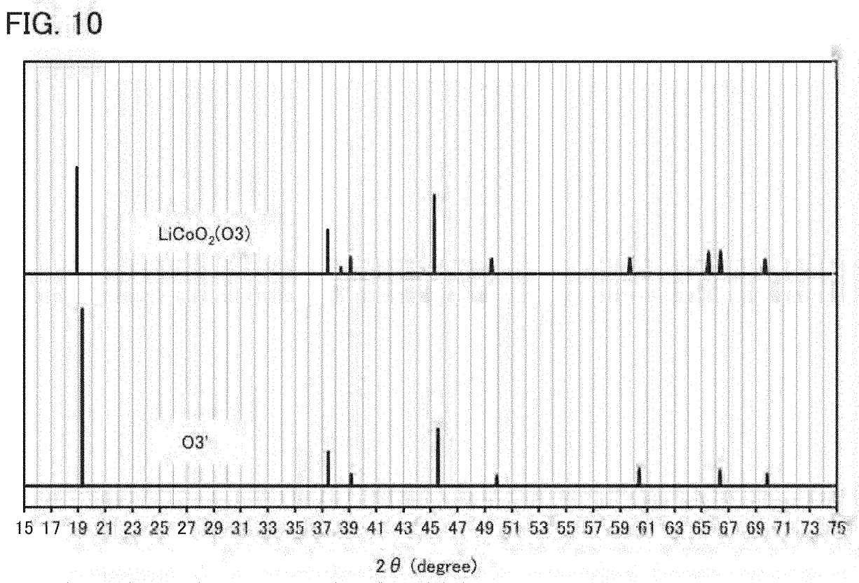

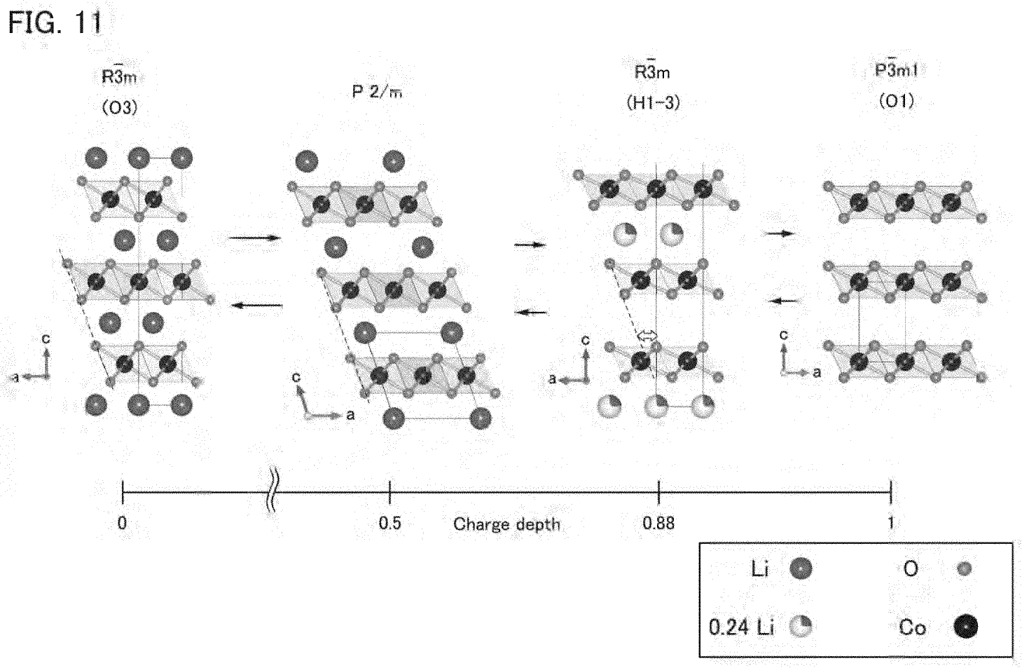

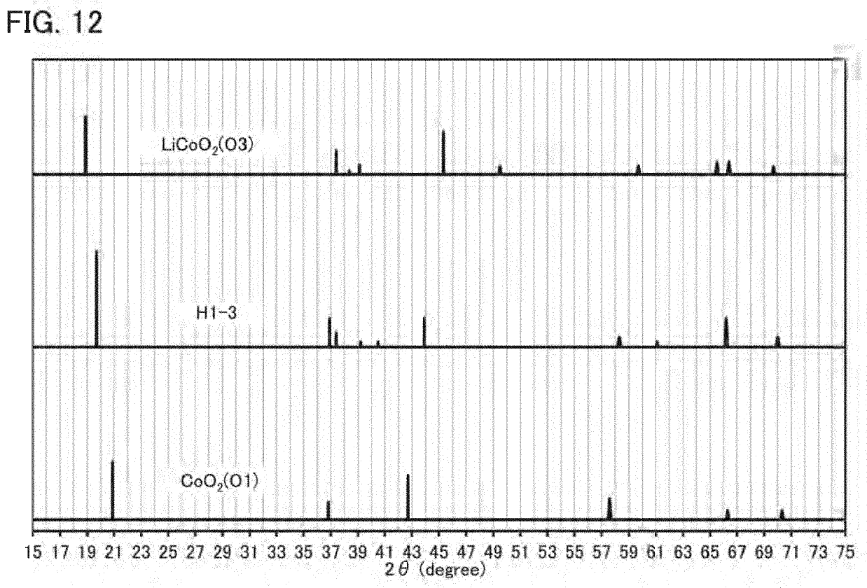

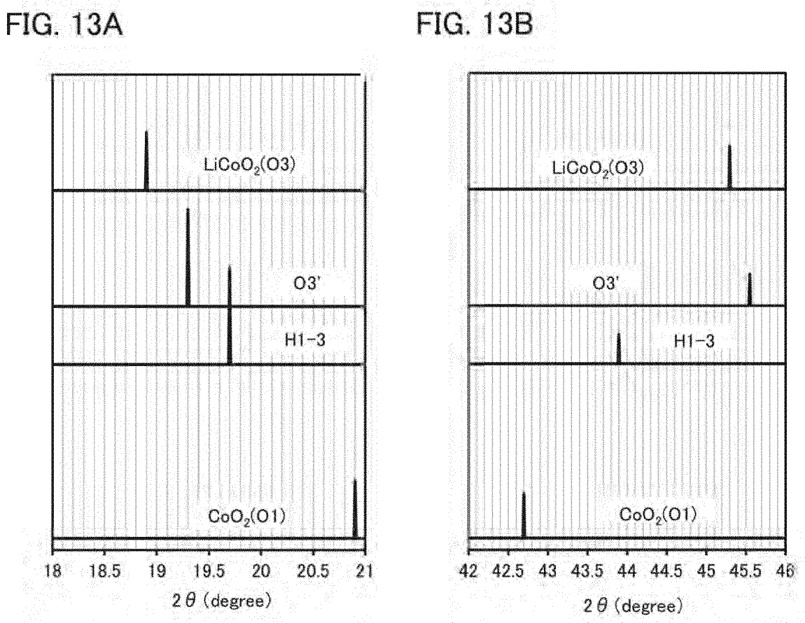

In this embodiment, a positive electrode active material of one embodiment of the present invention is described with reference to FIGS. 4A, 4B1, 4B2, 4C1, and 4C2, FIGS. 5A1, 5A2, 5A3, and 5B, FIGS. 6A, 6B, 6C1, and 6C2, FIG. 7, FIG. 8, FIG. 9, FIG. 10, FIG. 11, FIG. 12, FIGS. 13A and 13B, FIGS. 14A to 14C, and FIGS. 15A to 15C.

FIG. 4A is a cross-sectional view of the positive electrode active material 100 of one embodiment of the present invention. FIGS. 4B1 and 4B2 show enlarged views of a portion near the line A-B in FIG. 4A. FIGS. 4C1 and 4C2 show enlarged views of a portion near the line C-D in FIG. 4A.

As illustrated in FIGS. 4A, 4B1, 4B2, 4C1, and 4C2, the positive electrode active material 100 includes a surface portion 100a and an inner portion 100b. In each drawing, the dashed line denotes a boundary between the surface portion 100a and the inner portion 100b. In FIG. 4A, the dashed-dotted line denotes part of a crystal grain boundary 101.

In this specification and the like, the surface portion 100a refers to a region that is approximately 10 nm in depth from the surface toward the inner portion of the positive electrode active material. A plane generated by a crack may also be considered as the surface. The surface portion 100a may also be referred to as the vicinity of a surface, a region in the vicinity of a surface, a shell, or the like. The inner portion 100b refers to a region deeper than the surface portion 100a of the positive electrode active material. The inner portion 100b may also be referred to as an inner region, a core, or the like.

The surface portion 100a preferably has a higher concentration of an added element, which is described later, than the inner portion 100b. The added element preferably has a concentration gradient. In the case where a plurality of kinds of added elements are included, the added elements preferably exhibit concentration peaks at different depths from a surface.

For example, the added element X preferably has a concentration gradient as shown in FIG. 4B1 by gradation, in which the concentration increases from the inner portion 100b toward the surface. As examples of the added element X which preferably has such a concentration gradient, magnesium, fluorine, titanium, silicon, phosphorus, boron, calcium, and the like can be given.

Another added element Y preferably has a concentration gradient as shown in FIG. 4B2 by gradation and exhibits a concentration peak at a deeper region than the added element X The concentration peak may be located in the surface portion 100a or located deeper than the surface portion 100a. The concentration peak is preferably located in a region other than an outermost surface layer. For example, the concentration peak is preferably located in a region that is 5 nm to 30 nm in depth from the surface toward the inner portion. As examples of the element Y which preferably has such a concentration gradient, aluminum and manganese can be given.

It is preferable that the crystal structure continuously change from the inner portion 100b toward the surface owing to the above-described concentration gradient of the added element.

### <Contained Element>

The positive electrode active material 100 contains lithium, the transition metal M, oxygen, and an added element. The positive electrode active material 100 can be regarded as a composite oxide represented by LiMO₂ to which an added element is added. Note that the positive electrode active material of one embodiment of the present invention needs to have a crystal structure of a lithium composite oxide represented by LiMO₂, but the composition is not strictly limited to Li:M:O=1:1:2. In some cases, a positive electrode active material to which an added element is added is referred to as a composite oxide.

As the transition metal M contained in the positive electrode active material 100, a metal that can form, together with lithium, a composite oxide having a layered rock-salt structure belonging to the space group R-3m is preferably used. For example, at least one of manganese, cobalt, and nickel can be used. That is, as the transition metal M contained in the positive electrode active material 100, cobalt or nickel alone may be used, cobalt and manganese or nickel may be used, or cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. A composite oxide having a layered rock-salt structure has a two-dimensional diffusion path for lithium ions and is thus suitable for an insertion/extraction reaction of lithium ions.

Specifically, using cobalt at greater than or equal to 75 at %, preferably greater than or equal to 90 at %, further preferably greater than or equal to 95 at % as the transition metal M contained in the positive electrode active material 100 brings many advantages such as relatively easy synthesis, easy handling, and excellent cycle performance. Moreover, when nickel is contained as the transition metal Min addition to cobalt in the above range, a shift in a layered structure formed of octahedrons of cobalt and oxygen is sometimes inhibited. This is preferable because the inhibition of the shift enables higher stability of the crystal structure particularly in a high-temperature charged state in some cases.

Note that manganese is not necessarily contained as the transition metal M. When the positive electrode active material 100 is substantially free from manganese, the above advantages, including relatively easy synthesis, easy handling, and excellent cycle performance, are sometimes enhanced. The weight of manganese contained in the positive electrode active material 100 is preferably less than or equal to 600 ppm, further preferably less than or equal to 100 ppm, for example.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and charge and discharge capacity per weight might be increased.

Note that nickel is not necessarily contained as the transition metal M.

As the added element contained in the positive electrode active material 100, at least one of magnesium, fluorine, aluminum, titanium, zirconium, vanadium, iron, chromium, niobium, cobalt, arsenic, zinc, silicon, sulfur, phosphorus, and boron is preferably used. Such added elements further stabilize the crystal structure of the positive electrode active material 100 in some cases as described later. The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the added element may be rephrased as a mixture, a constituent of a material, an impurity element, or the like.

Note that as the added element, magnesium, fluorine, aluminum, titanium, zirconium, vanadium, iron, chromium, niobium, cobalt, arsenic, zinc, silicon, sulfur, phosphorus, or boron is not necessarily contained.

In order to prevent breakage of a layered structure formed of octahedrons of the transition metal M and oxygen even when lithium is extracted from the positive electrode active material 100 of one embodiment of the present invention owing to charge, the surface portion 100a having a high added-element concentration, i.e., the outer portion of the particle, is reinforced.

The added-element concentration gradient is preferably similar throughout the surface portion 100a of the positive electrode active material 100. In other words, it is preferable that the reinforcement derived from the high added-element concentration uniformly occurs in the surface portion 100a. When the surface portion 100a partly has reinforcement, stress might be concentrated on parts that do not have reinforcement. The concentration of stress on part of a particle might cause defects such as cracks from that part, leading to cracking of the positive electrode active material and a decrease in charge and discharge capacity.

Note that in this specification and the like, uniformity refers to a phenomenon in which, in a solid made of a plurality of elements (e.g., A, B, and C), a certain element (e.g., A) is distributed with similar nature in specific regions. Note that it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

Note that the added elements do not necessarily have similar concentration gradients throughout the surface portion 100a of the positive electrode active material 100. For example, FIG. 4C1 shows an example of distribution of the added element X in the portion near the line C-D in FIG. 4A and FIG. 4C2 shows an example of distribution of the element Y in the portion near the line C-D.

Here, the portion near the line C-D has a layered rock-salt crystal structure belonging to R-3m and the surface of the portion has a (001) orientation. The distribution of the added element at the surface having a (001) orientation may be different from that at other surfaces. For example, at least one of the added element X and the added element Y may be distributed shallower from the surface having a (001) orientation and the surface portion 100a thereof than from a surface having an orientation other than a (001) orientation. Alternatively, the surface having a (001) orientation and the surface portion 100a thereof may have a lower concentration of at least one of the added element X and the added element Y than a surface having an orientation other than a (001) orientation. Further alternatively, at the surface having a (001) orientation and the surface portion 100a thereof, the concentration of at least one of the added element X and the added element Y may be below the lower detection limit.

In a layered rock-salt crystal structure belonging to R-3m, cations are arranged parallel to a (001) plane. In other words, an MO₂ layer formed of octahedrons of the transition metal M and oxygen and a lithium layer are alternately stacked parallel to a (001) plane. Accordingly, a diffusion path of lithium ions also exists parallel to a (001) plane.

The MO₂ layer formed of octahedrons of the transition metal M and oxygen is relatively stable and thus, the surface of the positive electrode active material 100 is more stable when having a (001) orientation. A diffusion path of lithium ions is not exposed at a (001) plane.

By contrast, a diffusion path of lithium ions is exposed at a surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important to distribute the added element at the surface having an orientation other than a (001) orientation and the surface portion 100a thereof as shown in FIG. 4B1 or 4B2. By contrast, in the surface having a (001) orientation and the surface portion 100a thereof, the concentration of the added element may be low as described above or the added element may be absent.

In the formation method as described in the above embodiment, in which high-purity LiMO₂ is formed, the added element is mixed afterwards, and heating is performed, the added element spreads mainly via a diffusion path of lithium ions and thus, distribution of the added element at the surface having an orientation other than a (001) orientation and the surface portion 100a thereof can easily fall within a preferred range.

Calculation results of distribution of the added element in the case where high-purity LiMO₂ is formed, the added element is mixed, and heating is performed are described with reference to FIGS. 5A1, 5A2, 5A3, and 5B.

FIG. 5A1 shows calculation results for a surface having a (104) orientation and the surface portion 100a thereof. The classical molecular dynamics method was used for the calculation. LiCoO₂ (LCO) was put in the lower portion of the system, whereas LiF and MgF₂ were put in the upper portion of the system. The ensemble was NVT, the density of the initial structure was 1.8 g/cm³, the temperature of the system was 2000 K, the elapsed time was 100 psec, the potential was optimized with an LCO crystal structure, combination with the universal force field (UFF) was used for other atoms, the number of atoms in the system was 10000, and electric charges in the system were neutral. To simplify the drawing, only Co atoms and Mg atoms are shown.

Similarly, FIG. 5A2 shows results of calculation in which the elapsed time was 200 psec, and FIG. 5A3 shows results of calculation in which the elapsed time was 1200 psec.

Mg is diffused in the following process.

(1) Li atoms (not shown) are extracted from LCO owing to heat.
(2) Mg atoms enter the Li layer of LCO and are diffused into the inner portion.
(3) Li atoms originating from LiF enter the Li layer of LCO and compensate for the extraction of the Li atoms in (1).

FIG. 5A1, in which 100 psec elapsed, clearly shows diffusion of Mg atoms into LCO. The Mg atoms are diffused along the arranged cobalt atoms, and in FIG. 5A3 in which 1200 psec elapsed, almost all the Mg atoms that have been provided in the upper portion of the system are taken into LCO.

FIG. 5B shows results of calculation which is the same as the calculation in FIG. 5A1 except that a (001) orientation was employed. In FIG. 5B, Mg atoms stay at the surface of LCO.

As described above, by the formation method described in the above embodiment, in which high-purity LiMO₂ is formed, the added element is then mixed, and heating is performed, the distribution of the added element can be preferable at a surface having an orientation other than a (001) orientation and the surface portion 100a thereof as compared to the distribution of the added element in a surface having a (001) orientation. Moreover, in the formation method involving the initial heating, lithium atoms in the surface portion are expected to be extracted from LiMO₂ owing to the initial heating and thus, atoms of the added element such as magnesium atoms can be probably distributed easily in the surface portion at a high concentration.

The positive electrode active material 100 preferably has a smooth surface with little unevenness; however, it is not necessary that the whole surface of the positive electrode active material 100 be in such a state. In a composite oxide with a layered rock-salt crystal structure belonging to R-3m, slipping easily occurs at a plane parallel to a (001) plane, e.g., a plane where lithium atoms are arranged. In the case where a (001) plane is horizontal as shown in FIG. 6A, a pressing step or other steps sometimes causes slipping in a horizontal direction as denoted by arrows in FIG. 6B, resulting in deformation.

In this case, at a surface newly formed as a result of slipping and the surface portion 100a thereof, the added element does not exist or the concentration of the added element is below the lower detection limit in some cases. The line E-F in FIG. 6B denotes sections of examples of the surface newly formed as a result of slipping and its surface portion 100a. FIGS. 6C1 and 6C2 show enlarged views of the vicinity of the line E-F. In FIGS. 6C1 and 6C2, unlike in FIGS. 4B1, 4B2, 4C1, and 4C2, there is neither gradation of the added element X nor that of the added element Y.

However, because slipping easily occurs parallel to a (001) plane, the newly formed surface and the surface portion 100a thereof have a (001) orientation. Since a diffusion path of lithium ions is not exposed at a (001) plane and the surface having a (001) plane is relatively stable, substantially no problem is caused even when the added element does not exist or the concentration of the added element is below the lower detection limit in the surface having a (001) plane.

Note that as described above, in a composite oxide whose composition is LiMO₂ and which has a layered rock-salt crystal structure belonging to R-3m, atoms of the transition metal M are arranged parallel to a (001) plane. In a HAADF-STEM image, the luminance of the transition metal M, which has the largest atom number in LiMO₂, is the highest. Thus, in a HAADF-STEM image, arrangement of atoms with a high luminance may be regarded as arrangement of atoms of the transition metal M. Repetition of such arrangement with a high luminance may be referred to as crystal fringes or lattice fringes. Such crystal fringes or lattice fringes may be deemed to be parallel to a (001) plane in the case of a layered rock-salt crystal structure belonging to R-3m.

The positive electrode active material 100 has a depression, a crack, a concave, a V-shaped cross section, or the like in some cases. These are examples of defects, and when charge and discharge are repeated, elution of the transition metal M, breakage of a crystal structure, cracking of the positive electrode active material 100, extraction of oxygen, or the like might be derived from these defects. However, when there is a filling portion 102 (see FIG. 8) that fills such defects, elution of the transition metal M or the like can be inhibited. Thus, the positive electrode active material 100 can have high reliability and excellent cycle performance.

The positive electrode active material 100 may include a projection 103 (see FIG. 8), which is a region where the added element is unevenly distributed.

As described above, an excessive amount of the added element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the added element is insufficient, the added element is not distributed throughout the surface portion 100a, which might diminish the effect of inhibiting degradation of a crystal structure. The added element is required to be contained in the positive electrode active material 100 at an appropriate concentration; however, the adjustment of the concentration is not easy.

For this reason, in the positive electrode active material 100, when the region where the added element is unevenly distributed is included, some excess atoms of the added element are removed from the inner portion 100b, so that the added element concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charge and discharge at a high rate such as charge and discharge at 2 C or more.

In the positive electrode active material 100 including the region where the added element is unevenly distributed, addition of excess impurities to some extent in the formation process is acceptable. This is preferable because the margin of production can be increased.

In this specification and the like, uneven distribution refers to a state where a concentration of a certain element in a certain region is different from that in other regions, and may be rephrased as segregation, precipitation, unevenness, deviation, a mixture of a high-concentration portion and a low-concentration portion, or the like.

Magnesium, which is an example of the added element X, is divalent and is more stable in lithium sites than in transition metal sites in a layered rock-salt crystal structure; thus, magnesium is likely to enter the lithium sites. An appropriate concentration of magnesium in the lithium sites of the surface portion 100a facilitates maintenance of the layered rock-salt crystal structure. Magnesium can inhibit extraction of oxygen around magnesium when the charge depth is large. Magnesium is also expected to increase the density of the positive electrode active material. An appropriate concentration of magnesium does not have an adverse effect on insertion or extraction of lithium in charge and discharge, and is thus preferable. However, excess magnesium might adversely affect insertion and extraction of lithium. Thus, as will be described later, the concentration of the transition metal M is preferably higher than that of magnesium in the surface portion 100a, for example.

Aluminum, which is an example of the added element Y, is trivalent and can exist at a transition metal site in a layered rock-salt crystal structure. Aluminum can inhibit elution of surrounding cobalt. The bonding strength of aluminum with oxygen is high, thereby inhibiting extraction of oxygen around aluminum. Hence, aluminum contained as the added element enables the positive electrode active material 100 to have the crystal structure that is unlikely to be broken by repeated charge and discharge.

When fluorine, which is a monovalent anion, is substituted for part of oxygen in the surface portion 100a, the lithium extraction energy is lowered. This is because the oxidation-reduction potential of cobalt ions associated with lithium extraction differs depending on whether fluorine exists. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs in these cases. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

An oxide of titanium is known to have superhydrophilicity. Accordingly, the positive electrode active material 100 including an oxide of titanium at the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charge and discharge.

A short circuit of a secondary battery might cause not only malfunction in charging operation and/or discharging operation of the secondary battery but also heat generation and firing. In order to obtain a safe secondary battery, a short-circuit current is preferably inhibited even at a high charge voltage. In the positive electrode active material 100 of one embodiment of the present invention, a short-circuit current is inhibited even at a high charge voltage; thus, a secondary battery having high charge and discharge capacity and a high level of safety can be obtained.

The concentration gradient of the added element can be evaluated using energy dispersive X-ray spectroscopy (EDX), electron probe microanalysis (EPMA), or the like. In the EDX measurement, the measurement in which a region is measured while scanning the region and evaluated two-dimensionally is referred to as EDX surface analysis. The measurement by line scan, which is performed to evaluate the atomic concentration distribution in a positive electrode active material particle, is referred to as linear analysis. Furthermore, extracting data of a linear region from EDX surface analysis is referred to as linear analysis in some cases. The measurement of a region without scanning is referred to as point analysis.

By EDX surface analysis (e.g., element mapping), the concentrations of the added element in the surface portion 100a, the inner portion 100b, the vicinity of the crystal grain boundary 101, and the like of the positive electrode active material 100 can be quantitatively analyzed. By EDX linear analysis, the concentration distribution and the highest concentration of the added element can be analyzed. An analysis method in which a sample is sliced, such as STEM-EDX, is preferred because the method makes it possible to analyze the concentration distribution in the depth direction from the surface toward the center in a specific region of a particle regardless of the distribution in the front-back direction.

When the positive electrode active material 100 containing magnesium as the added element is subjected to the EDX linear analysis, a peak of the magnesium concentration in the surface portion 100a is preferably exhibited by a region that is 3 nm in depth, further preferably 1 nm in depth, still further preferably 0.5 nm in depth from the surface toward the center of the positive electrode active material 100.

When the positive electrode active material 100 contains magnesium and fluorine as the added elements, the distribution of fluorine preferably overlaps with the distribution of magnesium. Thus, in the EDX linear analysis, a peak of the fluorine concentration in the surface portion 100a is preferably exhibited by a region that is 3 nm in depth, further preferably 1 nm in depth, still further preferably 0.5 nm in depth from the surface toward the center of the positive electrode active material 100.

Note that the concentration distribution may differ between the added elements. For example, in the case where the positive electrode active material 100 contains aluminum as the added element, the distribution of aluminum is preferably slightly different from that of magnesium and that of fluorine as described above. For example, in the EDX linear analysis, the peak of the magnesium concentration is preferably closer to the surface than the peak of the aluminum concentration is in the surface portion 100a. For example, the peak of the aluminum concentration is preferably exhibited by a region that is greater than or equal to 0.5 nm and less than or equal to 50 nm in depth, further preferably greater than or equal to 5 nm and less than or equal to 30 nm in depth from the surface toward the center of the positive electrode active material 100. Alternatively, the peak of the aluminum concentration is preferably exhibited by a region that is greater than or equal to 0.5 nm and less than or equal to 30 nm in depth from the surface toward the center of the positive electrode active material 100. Further alternatively, the peak of the aluminum concentration is preferably exhibited by a region that is greater than or equal to 5 nm and less than or equal to 50 nm in depth from the surface toward the center of the positive electrode active material 100.

When the positive electrode active material 100 is subjected to linear analysis or surface analysis, the atomic ratio of an added element I to the transition metal M(I/M) in the surface portion 100a is preferably greater than or equal to 0.05 and less than or equal to 1.00. When the added element is titanium, the atomic ratio of titanium to the transition metal M(Ti/M) is preferably greater than or equal to 0.05 and less than or equal to 0.4, further preferably greater than or equal to 0.1 and less than or equal to 0.3. When the added element is magnesium, the atomic ratio of magnesium to the transition metal M(Mg/M) is preferably greater than or equal to 0.4 and less than or equal to 1.5, further preferably greater than or equal to 0.45 and less than or equal to 1.00. When the added element is fluorine, the atomic ratio of fluorine to the transition metal M (F/M) is preferably greater than or equal to 0.05 and less than or equal to 1.5, further preferably greater than or equal to 0.3 and less than or equal to 1.00.

According to results of the EDX linear analysis, where a surface of the positive electrode active material 100 is can be estimated as follows. A point where the detected amount of an element which uniformly exists in the inner portion 100b of the positive electrode active material 100, e.g., oxygen or the transition metal M such as cobalt, is ½ of the detected amount thereof in the inner portion 100b is assumed as the surface.

Since the positive electrode active material 100 is a composite oxide, the detected amount of oxygen is preferably used to estimate where the surface is.

Specifically, an average value Oₐᵥₑ of the oxygen concentration of a region of the inner portion 100b where the detected amount of oxygen is stable is calculated first. At this time, in the case where oxygen O_{background} which is probably led from chemical adsorption or the background is detected in a region that is obviously outside the surface, O_{background} is subtracted from the measurement value to obtain the average value Oₐᵥₑ of the oxygen concentration. The measurement point where the measurement value which is closest to ½ of the average value O_{we}, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

When the positive electrode active material 100 is subjected to linear analysis or surface analysis, the atomic ratio of the added element I to the transition metal M (I/M) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

For example, when the added element is magnesium and the transition metal M is cobalt, the atomic ratio of magnesium to cobalt (Mg/Co) is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

Note that when the positive electrode active material 100 undergoes charge and discharge under conditions with a large charge depth, including charge at 4.5 V or more, or at a high temperature (45° C. or higher), a progressive defect (also referred to as a pit) might be generated in the positive electrode active material. In addition, a defect such as a crevice (also referred to as a crack) might be generated by expansion and contraction of the positive electrode active material due to charge and discharge. FIG. 7 shows a schematic cross-sectional view of a positive electrode active material 51. Although pits of the positive electrode active material 51 are illustrated as holes denoted by reference numerals 54 and 58, their opening shape is not circular but a wide groove-like shape. A source of a pit can be a point defect. Presumably, the crystal structure of LCO in the vicinity of a portion where a pit is formed is broken and differs from a layered rock-salt crystal structure. The breakage of the crystal structure might inhibit diffusion and release of lithium ions that are carrier ions; thus, a pit is probably a cause of degradation of cycle performance. A crack of the positive electrode active material 51 is denoted by a reference numeral 57. A reference numeral 55 denotes a crystal plane parallel to arrangement of cations, a reference numeral 52 denotes a depression, and reference numerals 53 and 56 denote regions where the added element exists.

Typical positive electrode active materials of lithium ion secondary batteries are lithium cobalt oxide (LCO) and nickel-manganese-lithium cobalt oxide (NMC), which can also be regarded as an alloy containing a plurality of metal elements (cobalt, nickel, and the like). At least one of a plurality of positive electrode active material particles has a defect and the defect might change before and after charge and discharge. When used in a secondary battery, a positive electrode active material might undergo a phenomenon such as chemical or electrochemical erosion or degradation due to environmental substances (e.g., electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charge and discharge of the secondary battery.

Progress of a defect in a positive electrode active material to form a hole can be referred to as pitting corrosion, and the hole generated by this phenomenon is also referred to as a pit in this specification.

In this specification, a crack and a pit are different from each other. Immediately after formation of a positive electrode active material, a crack can exist but a pit does not exist. A pit can also be regarded as a hole formed by extraction of some layers of cobalt and oxygen due to charge and discharge under conditions with a large charge depth, such as high-voltage conditions at 4.5 V or more, or at a high temperature (45° C. or higher), i.e., a portion from which cobalt has been eluted. A crack refers to a surface newly generated by application of physical pressure or a crevice generated owing to the crystal grain boundary 101. A crack might be caused by expansion and contraction of a positive electrode active material due to charge and discharge. A pit might be generated from a void inside a positive electrode active material and/or a crack.

The positive electrode active material 100 may include a coating film in at least part of its surface. FIG. 8 shows an example of the positive electrode active material 100 including a coating film 104.

The coating film 104 is preferably formed by deposition of a decomposition product of an electrolyte solution due to charge and discharge, for example. A coating film originating from an electrolyte solution, which is formed on the surface of the positive electrode active material 100, is expected to improve charge and discharge cycle performance particularly when charge with a large charge depth is repeated. This is because an increase in impedance of the surface of the positive electrode active material is inhibited or elution of the transition metal M is inhibited, for example. The coating film 104 preferably contains carbon, oxygen, and fluorine, for example. The coating film can have high quality easily when the electrolyte solution includes LiBOB and/or suberonitrile (SUN), for example. Accordingly, the coating film 104 preferably contains at least one of boron, nitrogen, sulfur, and fluorine to possibly have high quality. The coating film 104 does not necessarily cover the positive electrode active material 100 entirely.

### <Crystal Structure>

A material with a layered rock-salt crystal structure, such as lithium cobalt oxide (LiCoO₂), is known to have a high discharge capacity and excel as a positive electrode active material of a secondary battery. Examples of a material with a layered rock-salt crystal structure include a composite oxide represented by LiMO₂.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charge and discharge with a large charge depth are performed on LiNiO₂, the crystal structure might be broken because of the distortion. The influence of the Jahn-Teller effect is suggested to be small in LiCoO₂; hence, LiCoO₂ is preferable because the tolerance when the charge depth is large is higher in some cases.

Crystal structures of positive electrode active materials are described with reference to FIG. 9, FIG. 10, FIG. 11, FIG. 12, and FIGS. 13A and 13B. In FIG. 9, FIG. 10, FIG. 11, FIG. 12, and FIGS. 13A and 13B, the case where cobalt is used as the transition metal M contained in the positive electrode active material is described.

### <Conventional Positive Electrode Active Material>

A positive electrode active material shown in FIG. 11 is lithium cobalt oxide (LiCoO₂) to which fluorine and magnesium are not added in a formation method described later. As described in Non-Patent Documents 1 and 2 and the like, the crystal structure of the lithium cobalt oxide shown in FIG. 11 changes with the charge depth.

As shown in FIG. 11, in lithium cobalt oxide with a charge depth of 0 (which is in a discharged state, or at an SOC (state of charge) of 100%), there is a region having a crystal structure belonging to the space group R-3m, lithium occupies octahedral sites, and a unit cell includes three CoO₂ layers. Thus, this crystal structure is referred to as an O3 type structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (03) are alternately stacked. Thus, this crystal structure is referred to as an H1-3 type structure in some cases. Note that the number of cobalt atoms per unit cell in the actual H1-3 type structure is twice that in other structures. However, in this specification, FIG. 11, and other drawings, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type structure is represented by a unit cell including one cobalt atom and two oxygen atoms. Meanwhile, the O3′ type structure and the O3″ type structure of embodiments of the present invention are preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of goodness of fit (GOF) is smaller in Rietveld analysis of XRD patterns, for example.

When charge at a high voltage of 4.6 V or more with reference to the redox potential of a lithium metal or charge with a large charge depth of 0.8 or more and discharge are repeated, the crystal structure of lithium cobalt oxide changes (i.e., an unbalanced phase change occurs) repeatedly between the H1-3 type structure and the structure belonging to R-3m (03) in a discharged state.

However, there is a large shift in the CoO₂ layers between these two crystal structures. As denoted by the dotted lines and the arrow in FIG. 11, the CoO₂ layer in the H1-3 type structure largely shifts from that in the structure belonging to R-3m (03). Such a dynamic structural change can adversely affect the stability of the crystal structure.

A difference in volume is also large. The H1-3 type structure and the O3 type structure in a discharged state that contain the same number of cobalt atoms have a difference in volume of 3.0% or more.

In addition, a structure in which CoO₂ layers are arranged continuously, such as the structure belonging to P-3m1 (O1), included in the H1-3 type structure is highly likely to be unstable.

Accordingly, the repeated charge and discharge with a large charge depth gradually break the crystal structure of lithium cobalt oxide. The broken crystal structure triggers deterioration of the cycle performance. This is probably because the broken crystal structure has a smaller number of sites where lithium can exist stably and makes it difficult to insert and extract lithium.

### <Positive Electrode Active Material of One Embodiment of the Present Invention>

### <<Crystal Structure>>

In the positive electrode active material 100 of one embodiment of the present invention, the shift in CoO₂ layers can be small in repeated charge and discharge with a large charge depth. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a state with a large charge depth. Thus, in the positive electrode active material of one embodiment of the present invention, a short circuit is unlikely to occur while the state with a large charge depth is maintained, in some cases. This is preferable because the safety is further improved.

The positive electrode active material of one embodiment of the present invention has a small crystal-structure change and a small volume difference per the same number of atoms of the transition metal M between a sufficiently discharged state and a state with a large charge depth.

FIG. 9 shows a crystal structure of the inner portion 100b of the positive electrode active material 100 in the case where the charge depth is 0 and a crystal structure thereof in the case where the charge depth is as large as approximately 0.8. The inner portion 100b, accounting for the majority of the volume of the positive electrode active material 100, largely contributes to charge and discharge and is accordingly a portion where a shift in CoO₂ layers and a volume change matter most.

The positive electrode active material 100 is a composite oxide containing lithium, cobalt as the transition metal M, and oxygen. In addition to the above elements, the inner portion 100b preferably contains magnesium as the added element and further preferably contains nickel as the transition metal M as well as cobalt. The surface portion 100a preferably contains fluorine as the added element and further preferably contains aluminum and/or nickel as the added element. The surface portion 100a is described later in detail.

The crystal structure with a charge depth of 0 (in a discharged state) in FIG. 9 is the structure belonging to R-3m (03) in FIG. 11. Meanwhile, the inner portion 100b of the positive electrode active material 100 with a charge depth in a sufficiently charged state includes a crystal whose structure is different from the H1-3 type structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type structure in this specification and the like. In both the O3 type structure and the O3′ type structure, a slight amount of magnesium preferably exists between the CoO₂ layers, i.e., in lithium sites. In addition, a slight amount of fluorine preferably exists at random in oxygen sites.

Note that in the O3′ type structure, a light element such as lithium sometimes occupies a site coordinated to four oxygen atoms.

Although a chance of the existence of lithium in all lithium sites is one in five in the O3′ type structure in FIG. 9, the positive electrode active material 100 of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

The O3′ type structure can be regarded as a crystal structure that contains lithium between layers randomly and is similar to a CdCl₂ crystal structure. The crystal structure similar to the CdCl₂ crystal structure is close to a crystal structure of lithium nickel oxide (Li_{0.06}NiO₂) that is charged until the charge depth reaches 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when the charge depth is large, i.e., when a large amount of lithium is extracted, is smaller than that in a conventional positive electrode active material. As denoted by the dotted lines in FIG. 9, for example, the CoO₂ layers hardly shift between the crystal structures.

Specifically, the crystal structure of the positive electrode active material 100 of one embodiment of the present invention is highly stable even when a charge depth is large. For example, at a charge voltage that makes a conventional positive electrode active material have the H1-3 type structure, for example, at a voltage of approximately 4.6 V with reference to the potential of a lithium metal, the crystal structure belonging to R-3m (03) can be maintained. Moreover, in a higher charge voltage range, for example, at voltages of greater than or equal to 4.65 V and less than or equal to 4.7 V with reference to the potential of a lithium metal, the O3′ type structure can be obtained. At a much higher charge voltage, the H1-3 type structure is eventually observed in some cases. In addition, the positive electrode active material 100 of one embodiment of the present invention might have the O3′ type structure even at a lower charge voltage (e.g., a charge voltage of greater than or equal to 4.5 V and less than 4.6 V with reference to the potential of a lithium metal).

Thus, in the positive electrode active material 100 of one embodiment of the present invention, the crystal structure is unlikely to be broken even when charge and discharge with a large charge depth are repeated.

The space group of a crystal structure is identified by XRD, electron diffraction, neutron diffraction, or the like. Thus, in this specification and the like, belonging to a space group or being a space group can be rephrased as being identified as a space group.

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material 100 of one embodiment of the present invention can maintain the crystal structure belonging to R-3m (03) and moreover, can have the O3′ type structure at higher voltages, e.g., a voltage of the secondary battery of greater than 4.5 V and less than or equal to 4.6 V. In addition, the positive electrode active material 100 of one embodiment of the present invention can have the O3′ type structure at lower charge voltages, e.g., at a voltage of the secondary battery of greater than or equal to 4.2 V and less than 4.3 V, in some cases.

Note that in the unit cell of the O3′ type structure, the coordinates of cobalt and oxygen can be represented by Co (0, 0, 0.5) and O (0, 0, x) within the range of 0.20≤x≤0.25. The unit cell typically has lattice constants a=2.817 (Å) and c=13.781 (Å). Note that 1 Å=10⁻¹⁰ m.

A slight amount of the added element such as magnesium randomly existing between the CoO₂ layers, i.e., in lithium sites, can suppress a shift in the CoO₂ layers when the charge depth is large. Thus, magnesium between the CoO₂ layers makes it easier to obtain the O3′ type structure. Therefore, magnesium is preferably distributed throughout a particle of the positive electrode active material 100 of one embodiment of the present invention. To distribute magnesium throughout the particle, heat treatment is preferably performed in the formation process of the positive electrode active material 100 of one embodiment of the present invention.

However, heat treatment at an excessively high temperature may cause cation mixing, which increases the possibility of entry of the added element such as magnesium into the cobalt sites. Magnesium in the cobalt sites does not have the effect of maintaining the structure belonging to R-3m when the charge depth is large. Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

Furthermore, the above-described initial heating can improve distribution of the added element such as magnesium or aluminum. Thus, in some cases, the H1-3 type structure is not formed but a crystal structure in which a shift in the CoO₂ layers is suppressed can be maintained even at higher charge voltages, e.g., a charge voltage of greater than or equal to 4.6 V and less than or equal to 4.8 V, and with a charge depth of greater than or equal to 0.8 and less than 0.9. This crystal structure has the same symmetry as the O3′ type structure but is different from the O3′ type structure in the lattice constant. Therefore, this structure is referred to as the O3″ type structure in this specification and the like. The O3″ type structure has a layered structure. The O3″ type structure can also be regarded as being similar to the CdCl₂ crystal structure.

When the magnesium concentration is higher than a desired value, the effect of stabilizing a crystal structure becomes small in some cases. This is probably because magnesium enters the cobalt sites in addition to the lithium sites. Moreover, an undesired magnesium compound (e.g., an oxide or a fluoride) which does not enter the lithium site or the cobalt site might be unevenly distributed at the surface of the positive electrode active material or the like to serve as a resistance component. The number of magnesium atoms in the positive electrode active material of one embodiment of the present invention is preferably greater than or equal to 0.001 and less than or equal to 0.1 times, further preferably greater than 0.01 times and less than 0.04 times, still further preferably approximately 0.02 times the number of atoms of the transition metal M Alternatively, the number of magnesium atoms in the positive electrode active material of one embodiment of the present invention is preferably greater than or equal to 0.001 times and less than 0.04 times or greater than or equal to 0.01 times and less than or equal to 0.1 times the number of atoms of the transition metal M The magnesium concentration described here may be a value obtained by element analysis on the whole particles of the positive electrode active material using a glow discharge mass spectrometer (GD-MS), an inductively coupled plasma mass spectrometer (ICP-MS), or the like, or may be a value based on the ratio of the raw materials mixed in the process of forming the positive electrode active material, for example.

Aluminum and the transition metal M typified by nickel preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the charge and discharge capacity of the positive electrode active material decreases in some cases. As an example, one reason is that the amount of lithium that contributes to charge and discharge decreases when magnesium enters the lithium sites. Another possible reason is that excess magnesium generates a magnesium compound that does not contribute to charge and discharge. When the positive electrode active material of one embodiment of the present invention contains nickel as a metal Z in addition to magnesium, the charge and discharge capacity per weight and per volume can be increased in some cases. When the positive electrode active material of one embodiment of the present invention contains aluminum as the metal Z in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms in the positive electrode active material 100 of one embodiment of the present invention is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The nickel concentration described here may be a value obtained by element analysis on the whole particles of the positive electrode active material using GD-MS, ICP-MS, or the like, or may be a value based on the ratio of the raw materials mixed in the process of forming the positive electrode active material, for example.

Nickel contained at any of the above concentrations easily forms a solid solution uniformly throughout the positive electrode active material 100 and thus particularly contributes to stabilization of the crystal structure of the inner portion 100b. When divalent nickel exists in the inner portion 100b, a slight amount of the added element having a valence of two and randomly existing in lithium sites, such as magnesium, might be able to exist more stably in the vicinity of the divalent nickel. Thus, even when charge and discharge with a large charge depth are performed, elution of magnesium might be inhibited. Accordingly, charge and discharge cycle performance might be improved. Such a combination of the effect of nickel in the inner portion 100b and the effect of magnesium, aluminum, titanium, fluorine, or the like in the surface portion 100a extremely effectively stabilizes the crystal structure when the charge depth is large.

The number of aluminum atoms in the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms in the positive electrode active material of one embodiment of the present invention is preferably greater than or equal to 0.05% and less than or equal to 2%, or greater than or equal to 0.1% and less than or equal to 4% of the number of cobalt atoms. The aluminum concentration described here may be a value obtained by element analysis on the whole particles of the positive electrode active material using GD-MS, ICP-MS, or the like, or may be a value based on the ratio of the raw materials mixed in the process of forming the positive electrode active material, for example.

It is preferable that the positive electrode active material of one embodiment of the present invention further contain phosphorus as the added element. The positive electrode active material of one embodiment of the present invention further preferably includes a compound containing phosphorus and oxygen.

When the positive electrode active material of one embodiment of the present invention includes a compound containing phosphorus, a short circuit can be inhibited while a state with a large charge depth is maintained, in some cases.

When the positive electrode active material of one embodiment of the present invention contains phosphorus, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution may inhibit corrosion of a current collector and/or separation of the coating film 104 or may inhibit a reduction in adhesion properties due to gelling and/or insolubilization of PVDF.

When containing phosphorus in addition to magnesium, the positive electrode active material of one embodiment of the present invention is extremely stable in a state with a large charge depth. When phosphorus is contained, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to and 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

The positive electrode active material sometimes has a crack. When a region in contact with a crack, e.g., the filling portion 102, includes phosphorus, more specifically, a compound containing phosphorus and oxygen or the like, crack development is inhibited in some cases.

### <<Surface Portion>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle. Alternatively, it is preferable that the magnesium concentration in the surface portion 100a be higher than the magnesium concentration in the inner portion 100b. For example, the magnesium concentration in the surface portion 100a measured by XPS or the like is preferably higher than the average magnesium concentration in the whole particles measured by ICP-MS or the like. Alternatively, the magnesium concentration in the surface portion 100a measured by EDX surface analysis or the like is preferably higher than the magnesium concentration in the inner portion 100b.

In the case where the positive electrode active material 100 of one embodiment of the present invention contains the added element, for example, one or more metals selected from aluminum, manganese, iron, and chromium, the concentration of the added element in the surface portion 100a is preferably higher than the average concentration of the added element in the whole particle. Alternatively, the concentration of the metal in the surface portion 100a is preferably higher than that in the inner portion 100b. For example, the concentration of the added element other than cobalt in the surface portion 100a measured by XPS or the like is preferably higher than the average concentration of the element in the whole particles measured by ICP-MS or the like. Alternatively, the concentration of the added element other than cobalt in the surface portion 100a measured by EDX surface analysis or the like is preferably higher than the concentration of the added element other than cobalt in the inner portion 100b.

The surface portion 100a is in a state where bonds are cut unlike the inner portion 100b whose crystal structure is maintained, and lithium is extracted from the surface during charge; thus, the lithium concentration in the surface portion 100a tends to be lower than that in the inner portion. Therefore, the surface portion 100a tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of fluorine in the surface portion 100a of the positive electrode active material 100 of one embodiment of the present invention is preferably higher than the average concentration in the whole particle. Alternatively, the fluorine concentration in the surface portion 100a is preferably higher than that in the inner portion 100b. When fluorine exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the added elements such as magnesium and fluorine are preferably higher than those in the inner portion 100b. The surface portion 100a having such a composition preferably has a crystal structure stable at room temperature (25° C.). Accordingly, the surface portion 100a may have a crystal structure different from that of the inner portion 100b. For example, at least part of the surface portion 100a of the positive electrode active material 100 of one embodiment of the present invention may have a rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ crystal are presumed to form a cubic close-packed structure.

Note that in this specification and the like, a structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a TEM image or the like, a spot may appear in a position different from a theoretical position. For example, anions may be regarded as forming a cubic close-packed structure when a difference in orientation from a theoretical position is 5° or less or 2.5° or less.

When a layered rock-salt crystal and a rock-salt crystal are in contact with each other, there is a crystal plane at which orientations of cubic close-packed structures formed of anions are aligned with each other.

The description can also be made as follows. An anion on the (111) plane of a cubic crystal structure has a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, in the layered rock-salt crystal, the O3′ crystal, the O3″ crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a transmission electron microscope (TEM) image, a scanning transmission electron microscope (STEM) image, a high-angle annular dark field scanning TEM (HAADF-STEM) image, an annular bright-field scanning transmission electron microscope (ABF-STEM) image, an electron diffraction pattern, and an FFT pattern of a TEM image or the like. X-ray diffraction (XRD), neutron diffraction, and the like can also be used for judging.

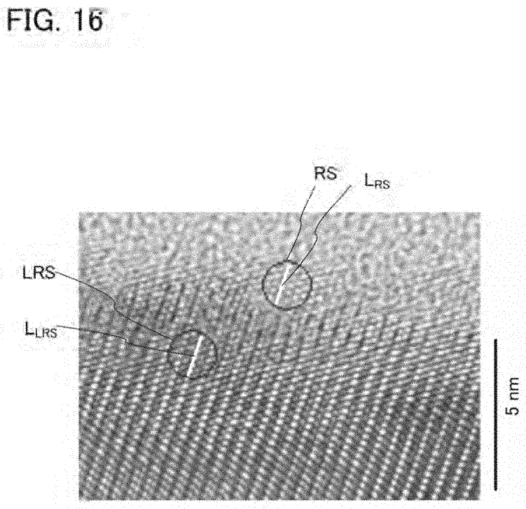

FIG. 16 shows an example of a TEM image in which orientations of a layered rock-salt crystal LRS and a rock-salt crystal RS are substantially aligned with each other.

In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 16) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the added elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

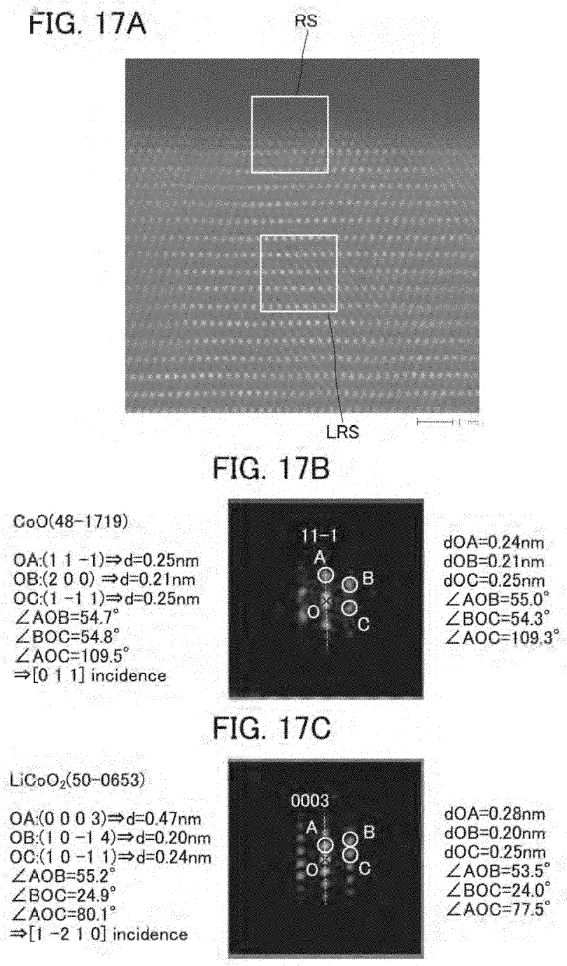

FIG. 17A shows an example of a STEM image in which orientations of the layered rock-salt crystal L_{RS} and the rock-salt crystal RS are substantially aligned with each other. FIG. 17B shows an FFT pattern of a region of the rock-salt crystal RS, and FIG. 17C shows an FFT pattern of a region of the layered rock-salt crystal L_{RS}. In FIG. 17B and FIG. 17C, the composition, the JCPDS card number, and d values and angles to be calculated are shown on the left. The measured values are shown on the right. A spot denoted by O is zero-order diffraction.

A spot denoted by A in FIG. 17B is derived from 11-1 reflection of a cubic structure. A spot denoted by A in FIG. 17C is derived from 0003 reflection of a layered rock-salt structure. It is found from FIG. 17B and FIG. 17C that the direction of the 11-1 reflection of the cubic structure and the direction of the 0003 reflection of the layered rock-salt structure are substantially aligned with each other. That is, a straight line that passes through AO in FIG. 17B is substantially parallel to a straight line that passes through AO in FIG. 17C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in an FFT pattern and electron diffraction, the <0003> orientation of the layered rock-salt crystal and the <11-1> orientation of the rock-salt crystal may be substantially aligned with each other. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 17C is derived from 1014 reflection of the layered rock-salt structure. This is sometimes observed at a position where the difference in orientation from the reciprocal lattice point derived from the 0003 reflection of the layered rock-salt structure (A in FIG. 17C) is greater than or equal to 52° and less than or equal to 56° (i.e., ∠AOB is 52° to 56°) and d is greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 17B is derived from 200 reflection of the cubic structure. A diffraction spot is sometimes observed at a position where the difference in orientation from the reciprocal lattice point derived from the 11-1 reflection of the cubic structure (A in FIG. 17B) is greater than or equal to 54° and less than or equal to 56° (i.e., ∠AOB is 54° to 56°). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The added element X is preferably positioned in the surface portion 100a of the positive electrode active material 100 of one embodiment of the present invention. For example, the positive electrode active material 100 of one embodiment of the present invention may be covered with the coating film 104 containing the added element X

### <<Grain Boundary>>

It is further preferable that the added element contained in the positive electrode active material 100 of one embodiment of the present invention have the above-described distribution and be partly unevenly distributed at the crystal grain boundary 101 and the vicinity thereof as shown in FIG. 4A.

Specifically, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the magnesium concentration at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary 101 refers to a region of approximately 10 nm from the grain boundary. The crystal grain boundary 101 refers to a plane where atomic arrangement is changed and which can be observed with an electron microscope. Specifically, the crystal grain boundary 101 refers to a portion where the angle formed by repetition of bright lines and dark lines in an electron microscope image exceeds 5° or a portion where a crystal structure cannot be observed in an electron microscope image.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

### <Analysis Method>

Whether or not a given positive electrode active material is the positive electrode active material 100 of one embodiment of the present invention, which has the O3′ type structure or the O3″ type structure when the charge depth is large, can be judged by analyzing a positive electrode including the positive electrode active material with a large charge depth by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a state with a large charge depth and a discharged state. A material in which 50 wt % or more of the crystal structure largely changes between a state with a large charge depth and a discharged state is not preferable because the material cannot withstand charge and discharge with a large charge depth. It should be noted that the intended crystal structure is not obtained in some cases only by addition of the added element. For example, in a state with a large charge depth, lithium cobalt oxide containing magnesium and fluorine has the O3′ type structure and the O3″ type structure at 60 wt % or more in some cases, and has the H1-3 type structure at 50 wt % or more in other cases. In some cases, lithium cobalt oxide containing magnesium and fluorine may have the O3′ type structure and the O3″ type structure at almost 100 wt % in charge at a predetermined voltage, and charge at a voltage higher than the predetermined voltage may cause the H1-3 type structure. Thus, to determine whether or not a positive electrode active material is the positive electrode active material 100 of one embodiment of the present invention, the crystal structure should be analyzed by XRD and other methods.

However, the crystal structure of a positive electrode active material in a state with a large charge depth or a discharged state may be changed with exposure to the air. For example, the O3′ type structure and the O3″ type structure change into the H1-3 type structure in some cases. For that reason, all samples are preferably handled in an inert atmosphere such as an argon atmosphere.

### <<Charging Method>>

High-voltage charge for determining whether or not a composite oxide is the positive electrode active material 100 of one embodiment of the present invention can be performed on a CR2032 coin cell (with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is subjected to constant current charge to a freely selected voltage (e.g., 4.5 V, 4.55 V, 4.6 V, 4.65 V, 4.7 V, 4.75 V, or 4.8 V) and at a current value of 10 mA/g (0.05 C where 1 C is 200 mA/g). To observe a phase change of the positive electrode active material, charge with such a small current value is preferably performed. The temperature is set to 25° C. or 45° C. After the charge is performed in this manner, the coin cell is disassembled in a glove box with an argon atmosphere to take out the positive electrode, whereby the positive electrode active material with a large charge depth can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to the analysis within 1 hour after the completion of charge, further preferably 30 minutes after the completion of charge.

In the case where the crystal structure in a charged state after charge and discharge are performed multiple times is analyzed, the conditions of the charge and discharge which are performed multiple times may be different from the above-described charge conditions. For example, the charge can be performed in the following manner: constant current charge to a freely selected voltage (e.g., 4.6 V, 4.65 V, 4.7 V, 4.75 V, or 4.8 V) at a current value of 100 mA/g (0.5 C where 1 C is 200 mA/g) is performed and then, constant voltage charge is performed until the current value becomes 10 mA/g (0.05 C where 1 C is 200 mA/g). The discharge can be constant current discharge at 2.5 V and 0.5 C.

Also in the case where the crystal structure in a discharged state after charge and discharge are performed multiple times is analyzed, constant current discharge can be performed at 2.5 V and a current value of 100 mA/g (0.5 C where 1 C is 200 mA/g), for example.

### <<XRD>>

The apparatus and conditions adopted in the XRD measurement are not particularly limited. The measurement can be performed with the apparatus and conditions as described below, for example.

XRD apparatus: D8 ADVANCE produced by Bruker AXS
X-ray source: CuKα₁ radiation

### Output: 40 kV, 40 mA

Slit system: Div. Slit, 0.5°

### Detector: LynxEye

Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

FIG. 10, FIG. 12, and FIGS. 13A and 13B show ideal powder XRD patterns with CuKα₁ radiation that are calculated from models of the O3′ type structure and the H1-3 type structure. For comparison, ideal XRD patterns calculated from the crystal structure of LiCoO₂ (O3) with a charge depth of 0 and the crystal structure of CoO₂ (O1) with a charge depth of 1 are also shown. FIGS. 13A and 13B each show both the XRD pattern of the O3′ type structure and that of the H1-3 type structure; FIG. 13A is an enlarged diagram showing a range of 2θ of greater than or equal to 18° and less than or equal to 21° and FIG. 13B is an enlarged diagram showing a range of 2θ of greater than or equal to 42° and less than or equal to 46°. Note that the patterns of LiCoO₂ (O3) and CoO₂ (O1) were made from crystal structure data obtained from the Inorganic Crystal Structure Database (ICSD) (see Non-Patent Document 4) with Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The pattern of the H1-3 type structure was similarly made from the crystal structure data disclosed in Non-Patent Document 3. The O3′ type structure was estimated from the XRD pattern of the positive electrode active material of one embodiment of the present invention, the crystal structure was fitted with TOPAS Version 3 (crystal structure analysis software produced by Bruker Corporation), and the XRD pattern of the O3′ type structure was made in a similar manner to other structures.

As shown in FIG. 10 and FIGS. 13A and 13B, the O3′ type structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, the O3′ type structure exhibits sharp diffraction peaks at 2θ of 19.30±0.10° (greater than or equal to 19.20° and less than or equal to) 19.40° and 2θ of 45.55±0.05° (greater than or equal to 45.50° and less than or equal to) 45.60°. By contrast, as shown in FIG. 12 and FIGS. 13A and 13B, the H1-3 type structure and CoO₂ (P-3m1, O1) do not exhibit peaks at these positions. Thus, the peaks at 2θ of 19.30±0.20° and 2θ of 45.55±0.10° in a state with a large charge depth can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure with a large charge depth. More specifically, it can be said that a difference in the positions of two or more, preferably three or more of the main diffraction peaks between the crystal structures is 2θ=0.7 or less, preferably 2θ=0.5 or less.

Although not shown, the O3″ type structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°). The H1-3 type structure and CoO₂ (P-3m1, O1) do not exhibit peaks at these positions. Thus, the peaks at 2θ of 19.47±0.10° and 2θ of 45.62±0.05° in a state with a larger charge depth can be the features of the positive electrode active material 100 of one embodiment of the present invention, formation of which involves the initial heating. The state with a larger charge depth refers to a charged state at a charge voltage of greater than or equal to 4.8 V and/or a state where the charge depth is greater than 0.8 and less than or equal to 0.88 or specifically, greater than or equal to 0.83 and less than or equal to 0.85.

Although the positive electrode active material 100 of one embodiment of the present invention has the O3′ or O3″ type structure when the charge depth is large, not all the particles necessarily have the O3′ or O3″ type structure. Some of the particles may have another crystal structure or be amorphous. Note that when the XRD patterns are subjected to the Rietveld analysis, the O3′ and O3″ type structures preferably account for greater than or equal to 50%, further preferably greater than or equal to 60%, still further preferably greater than or equal to 66% of the positive electrode active material. The positive electrode active material in which the O3′ and O3″ type structures account for greater than or equal to 50%, preferably greater than or equal to 60%, further preferably greater than or equal to 66% can have sufficiently good cycle performance.

Furthermore, even after 100 or more cycles of charge and discharge after the measurement starts, the O3′ and O3″ type structures preferably account for greater than or equal to 35%, further preferably greater than or equal to 40%, still further preferably greater than or equal to 43%, in the Rietveld analysis.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions and/or the 2θ value. In the case of the above-described measurement conditions, the peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity contributes to stability of the crystal structure after charge.

The crystallite size of the O3′ type structure of the positive electrode active material particle is decreased to approximately one-tenth that of LiCoO₂ (O3) in a discharged state. Thus, the peak of the O3′ type structure can be clearly observed when the charge depth is large even under the same XRD measurement conditions as those of a positive electrode before charge and discharge. By contrast, simple LiCoO₂ has a small crystallite size and exhibits a broad and small peak although it can partly have a structure similar to the O3′ type structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

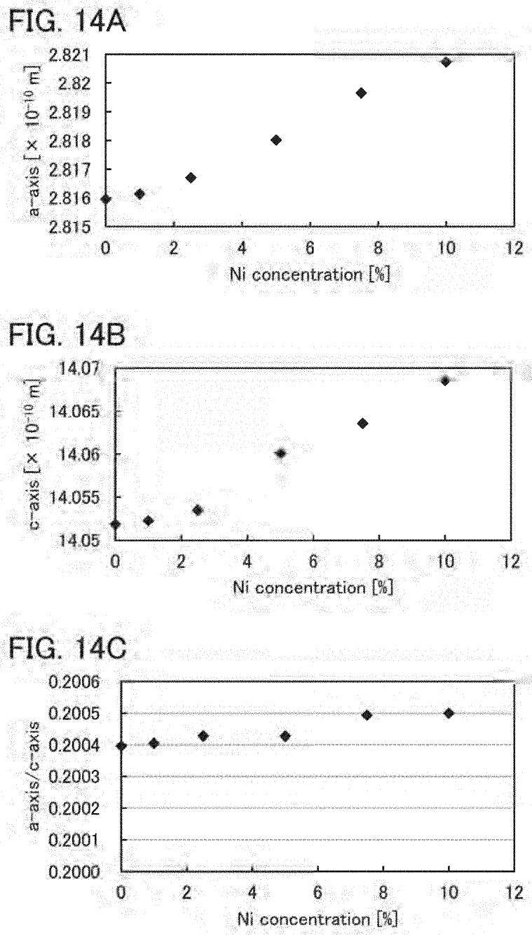

FIGS. 14A to 14C show the calculation results of the lattice constants of the a-axis and the c-axis by XRD in the case where the positive electrode active material of one embodiment of the present invention has a layered rock-salt crystal structure and contains cobalt and nickel. FIG. 14A shows the results of the a-axis, and FIG. 14B shows the results of the c-axis. Note that the XRD patterns of a powder after the synthesis of the positive electrode active material before incorporation into a positive electrode were used for the calculation. The nickel concentration on the horizontal axis represents a nickel concentration with the sum of cobalt atoms and nickel atoms regarded as 100%. The positive electrode active material was formed in accordance with the formation method in FIG. 2 except that the aluminum source was not used.

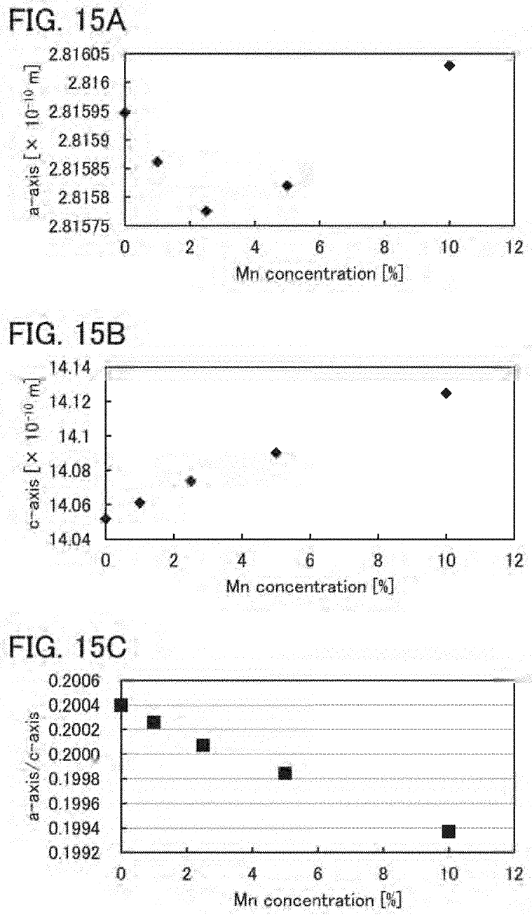

FIGS. 15A to 15C show the estimation results of the lattice constants of the a-axis and the c-axis by XRD in the case where the positive electrode active material of one embodiment of the present invention has a layered rock-salt crystal structure and contains cobalt and manganese. FIG. 15A shows the results of the a-axis, and FIG. 15B shows the results of the c-axis. Note that the lattice constants shown in FIGS. 15A to 15C were obtained by XRD measurement of a powder after the synthesis of the positive electrode active material before incorporation into a positive electrode. The manganese concentration on the horizontal axis represents a manganese concentration with the sum of cobalt atoms and manganese atoms regarded as 100%. The positive electrode active material was formed in accordance with the formation method shown in FIG. 2 except that a manganese source was used instead of the nickel source and the aluminum source was not used.

FIG. 14C shows values obtained by dividing the lattice constants of the a-axis by the lattice constants of the c-axis (a-axis/c-axis) in the positive electrode active material, whose results of the lattice constants are shown in FIGS. 14A and 14B. FIG. 15C shows values obtained by dividing the lattice constants of the a-axis by the lattice constants of the c-axis (a-axis/c-axis) in the positive electrode active material, whose results of the lattice constants are shown in FIGS. 15A and 15B.

As shown in FIG. 14C, the value of a-axis/c-axis tends to significantly change between nickel concentrations of 5% and 7.5%, and the distortion of the a-axis becomes large at a nickel concentration of 7.5%. This distortion may be the Jahn-Teller distortion. It is suggested that an excellent positive electrode active material with small Jahn-Teller distortion can be obtained at a nickel concentration of lower than 7.5%.

FIG. 15A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charge and discharge are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charge and discharge are not performed may be the state of a powder before the formation of a positive electrode of a secondary battery.

Alternatively, in the layered rock-salt crystal structure of the positive electrode active material in the discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material in the discharged state or the state where charge and discharge are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a, the crystal grain boundary 101, or the like can be analyzed by electron diffraction of a cross section of the positive electrode active material 100, for example.

<<Charge Curve and dQ/dVvsV Curve>>

The positive electrode active material 100 of one embodiment of the present invention sometimes shows a characteristic voltage change when the charge depth is increased. A voltage change can be read from a dQ/dVvsV curve, which can be obtained by differentiating capacitance (Q) in a charge curve with voltage (V) (dQ/dV). For example, there should be an unbalanced phase change and a significant change in the crystal structure between before and after a peak in a dQ/dVvsV curve. Note that in this specification and the like, an unbalanced phase change refers to a phenomenon that causes a nonlinear change in physical quantity.

The positive electrode active material 100 of one embodiment of the present invention sometimes shows a broad peak at around 4.55 V in a dQ/dVvsV curve. The peak at around 4.55 V reflects a change in voltage at the time of the phase change from the O3 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dVvsV curve of a charge curve is a first peak, the first peak preferably has a full width at half maximum of greater than or equal to 0.10 V to be sufficiently broad. In this specification and the like, the full width at half maximum of the first peak refers to the difference between HWHM₁ and HWHM₂, where HWHM₁ is an average value of the first peak and a first minimum value (the minimum dQ/dV value appearing at greater than or equal to 4.3 V and less than or equal to 4.5 V) and HWHM₂ is an average value of the first peak and a second minimum value (the minimum dQ/dV value appearing at greater than or equal to 4.6 V and less than or equal to 4.8 V).

The charge at the time of obtaining a dQ/dVvsV curve can be, for example, constant current charge to 4.9 V at 10 mA/g (0.05 C where 1 C is 200 mA/g). In obtaining a dQ/dV value of the initial charge, the above charge is preferably started after discharge to 2.5 V at 0.5 C before measurement.

Data acquisition at the time of charge can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value for 500 class intervals can be used for the voltage on the horizontal axis of a dQ/dVvsV graph.

In the case where a dQ/dVvsV curve after charge and discharge are performed multiple times is analyzed, the conditions of the charge and discharge performed multiple times may be different from the above-described charge conditions. For example, the charge can be performed in the following manner: constant current charge is performed at a freely selected voltage (e.g., 4.6 V, 4.65 V, 4.7 V, 4.75 V, or 4.8 V) and 0.5 C (1 C is 200 mA/g) and then, constant voltage charge is performed until the current value becomes 0.05 C. The discharge can be constant current discharge at 2.5 V and 0.5 C.

Note that the O3 type structure at the time of the phase change from the O3 type structure to the O3′ type structure at around 4.55 V has a charge depth of approximately 0.7. The O3 type structure with a charge depth of approximately 0.7 has the same symmetry as the O3 type structure with a charge depth of 0 illustrated in FIG. 11 but is slightly different from the O3 type structure with a charge depth of 0 in the distance between the CoO₂ layers. In this specification and the like, when O3 type structures with different charge depths are distinguished from each other, the O3 type structure with a charge depth of 0 is referred to as O3 (2θ=18.85) and the O3 type structure with a charge depth of approximately 0.7 is referred to as O3 (2θ=18.57). This is because the position of the peak appearing at 2θ of approximately 19° in XRD measurement corresponds to the distance between the CoO₂ layers.

<<Discharge Curve and dQ/dVvsV Curve>>

When the positive electrode active material 100 of one embodiment of the present invention is discharged at a low rate such as 0.2 C or less after high-voltage charge, a characteristic voltage change appears just before the end of discharge, in some cases. This change can be clearly observed when a dQ/dVvsV curve calculated from the discharge curve has at least one peak within the range of 3.5 V to a voltage lower than approximately 3.9 V at which a peak appears.

### <<Current-Rest-Method>>

The distribution of the added element included in the surface portion of the positive electrode active material 100 of one embodiment of the present invention, such as magnesium, sometimes slightly changes during repeated charge and discharge. For example, in some cases, the distribution of the added element becomes more favorable, so that the electronic conduction resistance decreases. Thus, in some cases, the electric resistance, i.e., a resistance component R(0.1 s) with a high response speed measured by a current-rest-method, decreases at the initial stage of the charge and discharge cycles.

For example, when the n-th (n is a natural number larger than 1) charge and the n+1-th charge are compared, the resistance component R(0.1 s) with a high response speed measured by a current-rest-method is lower in the n+1-th charge than in the n-th charge. Accordingly, the n+1-th discharge capacity is higher than the n-th discharge capacity in some cases. Also in the case of a positive electrode active material that does not contain any added element, the second charge capacity can be higher than the initial charge capacity (i.e., n=1); thus, n is preferably greater than or equal to 2 and less than or equal to 10, for example. However, n is not limited to the above for the initial stage of the charge and discharge cycles. The stage where the charge and discharge capacity is substantially the same as the rated capacity or is greater than or equal to 97% of the rated capacity can be regarded as the initial stage of the charge and discharge cycles.

### <<XPS>>

A region that is approximately 2 nm to 8 nm (normally, less than or equal to 5 nm) in depth from a surface can be analyzed by X-ray photoelectron spectroscopy (XPS); thus, the concentrations of elements in approximately half the depth of the surface portion 100a can be quantitatively analyzed. The bonding states of the elements can be analyzed by narrow scanning. Note that the quantitative accuracy of XPS is approximately ±1 at % in many cases. The lower detection limit is approximately 1 at % but depends on the element.

When the positive electrode active material 100 of one embodiment of the present invention is subjected to XPS analysis, the number of atoms of the added element is preferably greater than or equal to 1.6 times and less than or equal to 6.0 times, further preferably greater than or equal to 1.8 times and less than 4.0 times the number of atoms of the transition metal M. When the added element is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum Kα radiation can be used as an X-ray source, for example. An extraction angle is, for example, 45°. For example, the measurement can be performed using the following apparatus and conditions.

Measurement device: Quantera II produced by PHI, Inc.
X-ray source: monochromatic Al Kα (1486.6 eV)
Detection area: 100 μm ϕ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the added elements that preferably exist in the surface portion 100a in a large amount, such as magnesium and aluminum, measured by XPS or the like are preferably higher than the concentrations measured by inductively coupled plasma mass spectrometry (ICP-MS), glow discharge mass spectrometry (GD-MS), or the like.

When a cross section of the positive electrode active material 100 is exposed by processing and analyzed by TEM-EDX, the concentrations of magnesium and aluminum in the surface portion 100a are preferably higher than those in the inner portion 100b. For example, in the TEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. A focused ion beam (FIB) can be used for the processing, for example.

In the X-ray photoelectron spectroscopy (XPS) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals M, not be unevenly distributed in the surface portion 100a but be distributed throughout the particle of the positive electrode active material 100. Note that one embodiment of the present invention is not limited thereto in the case where the above-described region where the added element is unevenly distributed exists.

### <<ESR>>

As described above, the positive electrode active material of one embodiment of the present invention preferably contains cobalt and nickel as the transition metal M and magnesium as the added element. It is preferable that Ni³⁺ be substituted for part of Co³⁺ and Mg²⁺ be substituted for part of Li⁺ accordingly. Accompanying the substitution of Mg′ for Li⁺, the Ni′ might be reduced to be Ni′. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably greater than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Quantitative analysis of elements can be conducted by electron probe microanalysis (EPMA). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the added element existing in the surface portion might be lower than the concentration obtained in XPS. The concentration of the added element existing in the surface portion might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the added element increases from the inner portion toward the surface portion. Specifically, each of magnesium, fluorine, titanium, and silicon preferably has a concentration gradient in which the concentration increases from the inner portion toward the surface as shown in FIG. 4B1. The concentration of aluminum preferably has a peak in a region deeper than the region where the concentration of any of the above elements has a peak, as shown in FIG. 4B2. The aluminum concentration peak may be located in the surface portion or located deeper than the surface portion.

Note that the surface and the surface portion of the positive electrode active material of one embodiment of the present invention do not contain a carbonate, a hydroxy group, or the like which is chemically adsorbed after formation of the positive electrode active material. Furthermore, an electrolyte solution, a binder, a conductive material, and a compound originating from any of these that are attached to the surface of the positive electrode active material are not contained either. Thus, in quantitative analysis of the elements contained in the positive electrode active material, correction may be performed to exclude carbon, hydrogen, excess oxygen, excess fluorine, and the like that might be detected in surface analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be eluted to a solvent or the like used in the washing at this time, the added element is not easily eluted even in that case; thus, the atomic ratio of the added element is not affected.

### <<Surface Roughness and Specific Surface Area>>

The positive electrode active material 100 of one embodiment of the present invention preferably has a smooth surface with little unevenness. A smooth surface with little unevenness indicates favorable distribution of the added element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (a=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Documents 5 to 7 can be used.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area A is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.1.

Alternatively, the level of the surface smoothness of the positive electrode active material 100 can be quantified from its cross-sectional SEM image by a method as described below.

First, a surface SEM image of the positive electrode active material 100 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value obtained by the quantification is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

This embodiment can be implemented in combination with any of the other embodiments.

### Embodiment 3

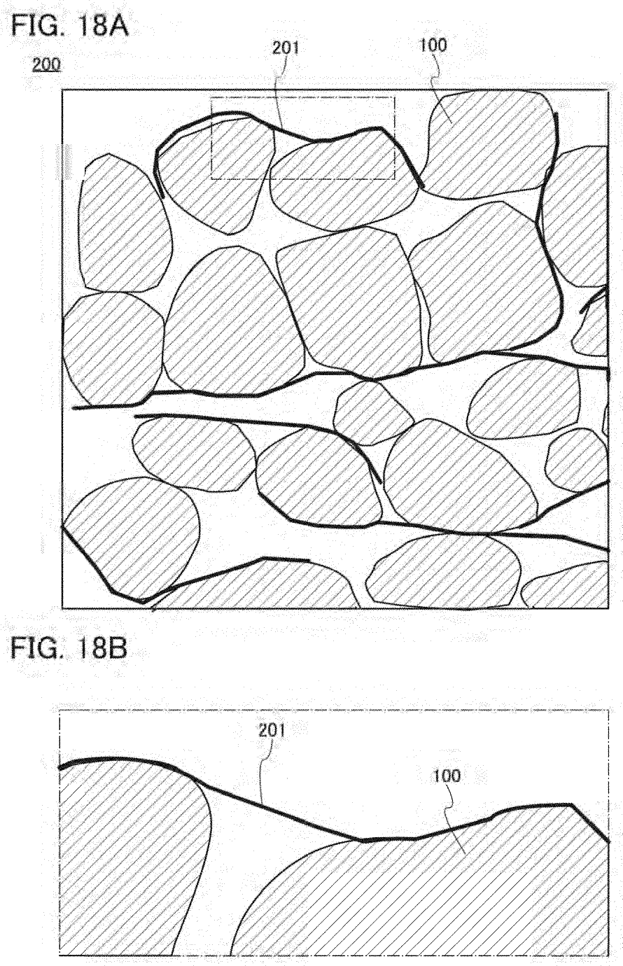

In this embodiment, examples of a secondary battery of one embodiment of the present invention are described with reference to FIGS. 18A and 18B, FIGS. 19A and 19B, FIGS. 20A to 20C, and FIGS. 21A and 21B.

### <Structure Example 1 of Secondary Battery>

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material (which may also be referred to as a conductive additive) and a binder. As the positive electrode active material, the positive electrode active material formed by the formation method described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M=Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide is measured, it is preferable to satisfy the following at the time of discharge: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an inductively coupled plasma mass spectrometer (ICP-MS). The proportion of oxygen in the whole particles of a lithium-manganese composite oxide can be measured by, for example, energy dispersive X-ray spectroscopy (EDX). Alternatively, the proportion of oxygen can be measured by ICP-MS combined with fusion gas analysis and valence evaluation of X-ray absorption fine structure (XAFS) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing graphene or a graphene compound as a conductive material is described below.

FIG. 18A is a longitudinal cross-sectional view of the active material layer 200. The active material layer 200 includes particles of the positive electrode active material 100, graphene or a graphene compound 201 serving as the conductive material, and a binder (not illustrated).

The graphene compound 201 in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 at % and the oxygen concentration is higher than or equal to 2 at % and lower than or equal to 15 at %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, a graphene compound is preferably used as the conductive material, in which case the area where the active material and the conductive material are in contact with each other can be increased. The graphene compound preferably covers 80% or more of the area of the active material. Note that a graphene compound preferably clings to at least part of an active material particle. Alternatively, a graphene compound preferably overlays at least part of an active material particle. Alternatively, the shape of a graphene compound preferably conforms to at least part of the shape of an active material particle. The shape of an active material particle means, for example, unevenness of a single active material particle or unevenness formed by a plurality of active material particles. A graphene compound preferably surrounds at least part of an active material particle. A graphene compound may have a hole.

In the case where active material particles with a small diameter (e.g., 1 μm or less) are used, the specific surface area of the active material particles is large and thus more conductive paths for the active material particles are needed. In such a case, it is particularly preferred that a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

The longitudinal cross section of the active material layer 200 in FIG. 18B shows substantially uniform dispersion of the sheet-like graphene or the graphene compound 201 in the active material layer 200. The graphene or the graphene compound 201 is schematically shown by the thick line in FIG. 18B but is actually a thin film having a thickness corresponding to the thickness of a single layer or a multi-layer of carbon molecules. A plurality of sheets of graphene or the plurality of graphene compounds 201 are formed to partly coat or adhere to the surfaces of the plurality of particles of the positive electrode active material 100, so that the plurality of sheets of graphene or the plurality of graphene compounds 201 make surface contact with the particles of the positive electrode active material 100.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the charge and discharge capacity of the secondary battery can be increased.

Here, it is preferable to perform reduction after a layer to be the active material layer 200 is formed in such a manner that graphene oxide is used as the graphene or the graphene compound 201 and mixed with an active material. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene or the graphene compound 201 are capable of making low-resistance surface contact; accordingly, the electrical conduction between the particles of the positive electrode active material 100 and the graphene or the graphene compound 201 can be improved with a small amount of the graphene and the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating film to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (ₓ<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### [Positive Electrode Current Collector]

The positive electrode current collector can be formed using a material that has high conductivity, such as a metal like stainless steel, gold, platinum, aluminum, or titanium, or an alloy thereof. It is preferred that a material used for the positive electrode current collector not be eluted at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, Sn₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a secondary battery from exploding and/or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC and LiBOB are particularly preferable because they facilitate formation of a favorable coating film.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and/or a spacer is/are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge and discharge at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Structure Example 2 of Secondary Battery>

A structure of a secondary battery including a solid electrolyte layer is described below as another structure example of a secondary battery.

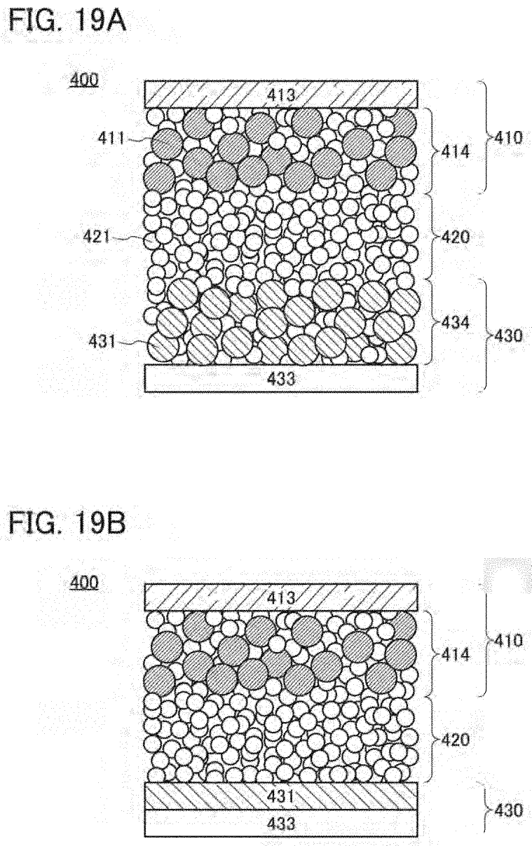

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when a lithium metal is used for the negative electrode 430, it is possible that the negative electrode 430 does not include the solid electrolyte 421 as illustrated in FIG. 19B. The use of a lithium metal for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S_{3.44}LiI, 63Li₂S.36SiS₂.1Li₃PO₄, 57Li₂S.38SiS_{2.5}Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₋ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO_{4.50}Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

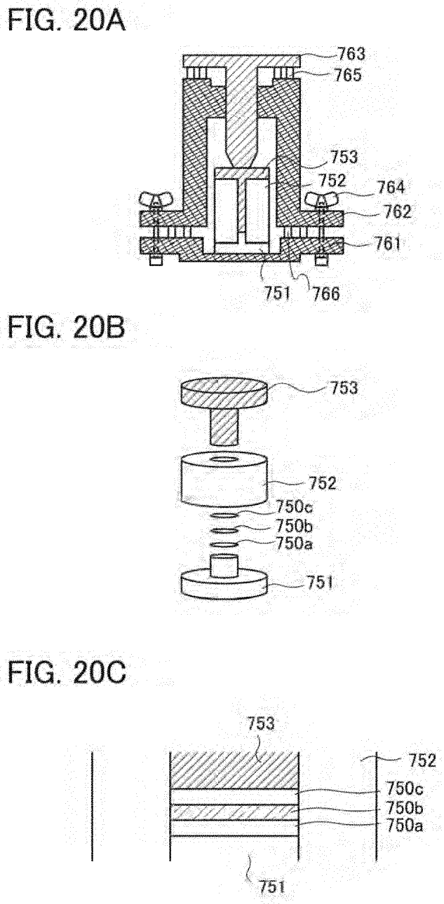

FIGS. 20A to 20C show an example of a cell for evaluating materials of an all-solid-state battery.

FIG. 20A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 20C. Note that the same portions in FIGS. 20A to 20C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package and/or a resin package can be used. The exterior body is sealed preferably in a closed atmosphere where the outside air is blocked, for example, in a glove box.

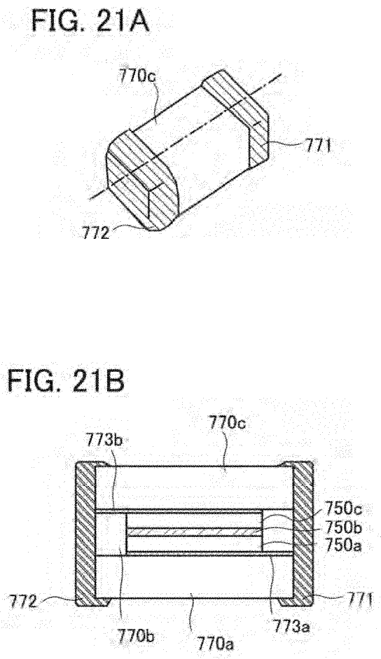

FIG. 21A is a perspective view of a secondary battery of one embodiment of the present invention that has an exterior body and a shape different from those in FIGS. 20A to 20C. The secondary battery in FIG. 21A includes external electrodes 771 and 772 and is sealed with an exterior body including a plurality of package components.

FIG. 21B illustrates an example of a cross section along the dashed-dotted line in FIG. 21A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and/or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 4

In this embodiment, examples of the shape of a secondary battery including the positive electrode described in the above embodiment are described. For the materials used for the secondary battery described in this embodiment, refer to the description of the above embodiment.

### <Coin-Type Secondary Battery>

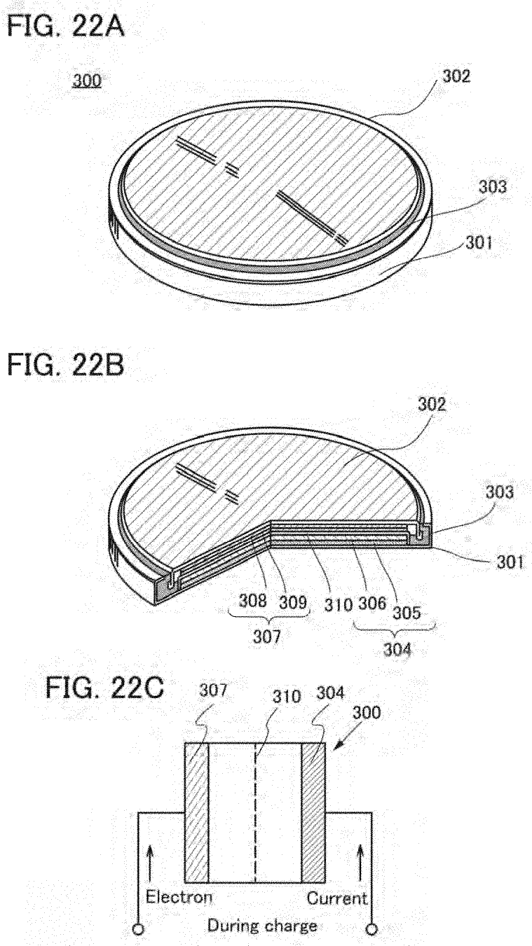

First, an example of a coin-type secondary battery is described. FIG. 22A is an external view of a coin-type (single-layer flat-type) secondary battery, and FIG. 22B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, and/or an alloy of such a metal and another metal (e.g., stainless steel) can be used. The positive electrode can 301 and the negative electrode can 302 are preferably covered with nickel and/or aluminum, for example, in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as illustrated in FIG. 22B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In this manner, the coin-type secondary battery 300 is fabricated.

When the positive electrode active material described in the above embodiment is used in the positive electrode 304, the coin-type secondary battery 300 can have high charge and discharge capacity and excellent cycle performance.

Here, a current flow in charging a secondary battery is described with reference to FIG. 22C. When a secondary battery including lithium is regarded as a closed circuit, lithium ions transfer and a current flows in the same direction. Note that in the secondary battery including lithium, an anode and a cathode change places in charge and discharge, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode”, which are related to an oxidation reaction and a reduction reaction, might cause confusion because the anode and the cathode change places at the time of charge and discharge. Therefore, the terms “anode” and “cathode” are not used in this specification. If the term “anode” or “cathode” is used, whether it is at the time of charge and discharge is noted, as well as whether the term corresponds to a positive (plus) electrode or a negative (minus) electrode.

A charger is connected to the two terminals in FIG. 22C, and the secondary battery 300 is charged. As the charge of the secondary battery 300 proceeds, a potential difference between the electrodes increases.

### <Cylindrical Secondary Battery>

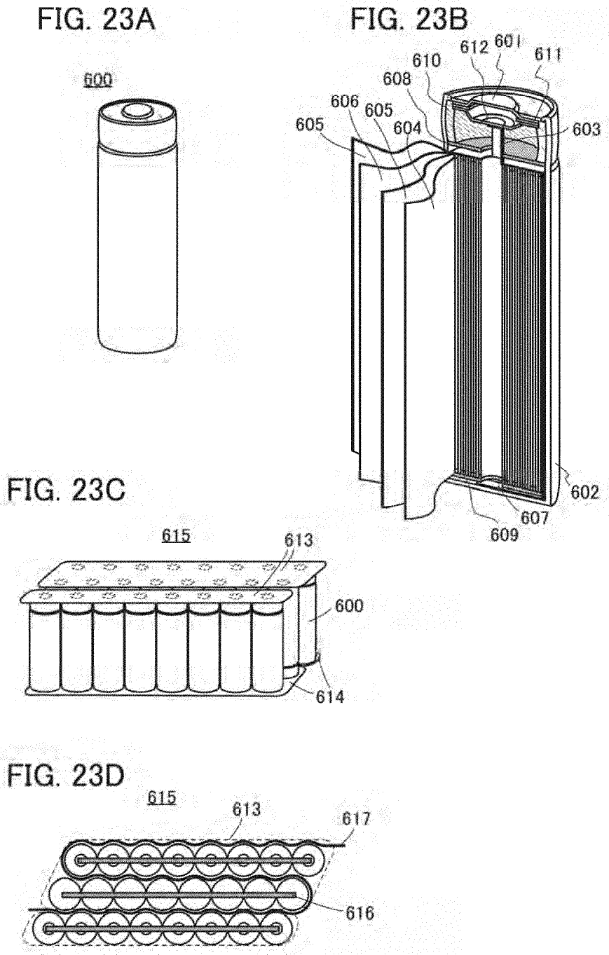

Next, an example of a cylindrical secondary battery is described with reference to FIGS. 23A to 23D. FIG. 23A is an external view of a cylindrical secondary battery 600. FIG. 23B is a schematic cross-sectional view of the cylindrical secondary battery 600. As illustrated in FIG. 23B, the cylindrical secondary battery 600 includes a positive electrode cap (battery lid) 601 on the top surface and a battery can (outer can) 602 on the side and bottom surfaces. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, and/or an alloy of such a metal and another metal (e.g., stainless steel) can be used. The battery can 602 is preferably covered with nickel and/or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As illustrated in FIG. 23C, a plurality of secondary batteries 600 may be sandwiched between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 23D is a top view of the module 615. The conductive plate 613 is shown by the dotted line for clarity of the drawing. As illustrated in FIG. 23D, the module 615 may include a conductive wire 616 that electrically connects the plurality of secondary batteries 600 to each other. The conductive plate can be provided over the conductive wire 616 to overlap each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 can have high charge and discharge capacity and excellent cycle performance.

### <Structure Example of Secondary Battery>

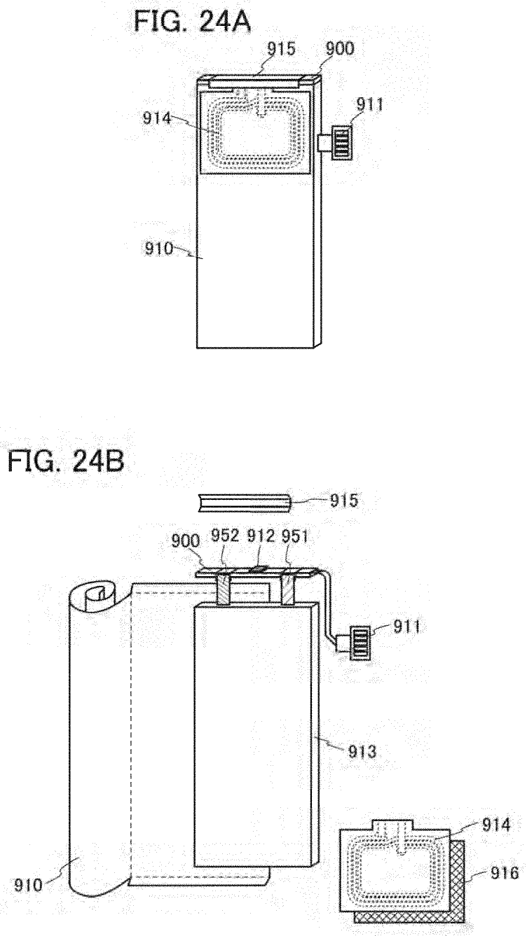

Other structure examples of secondary batteries are described with reference to FIGS. 24A and 24B, FIGS. 25A to 25D, FIGS. 26A and 26B, FIG. 27, and FIGS. 28A to 28C.

FIGS. 24A and 24B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 24B, the secondary battery 913 is connected to a terminal 951 and a terminal 952. The circuit board 900 is fixed by a sealant 915.

The circuit board 900 includes a terminal 911 and a circuit 912. The terminal 911 is connected to the terminals 951 and 952, the antenna 914, and the circuit 912. Note that a plurality of terminals 911 may be provided to serve separately as a control signal input terminal, a power supply terminal, and the like.

The circuit 912 may be provided on the rear surface of the circuit board 900. Note that the shape of the antenna 914 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used. Alternatively, the antenna 914 may be a flat-plate conductor. The flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the secondary battery 913 and the antenna 914. The layer 916 has a function of blocking an electromagnetic field from the secondary battery 913, for example. As the layer 916, for example, a magnetic body can be used.

Note that the structure of the battery pack is not limited to that shown in FIGS. 24A and 24B.

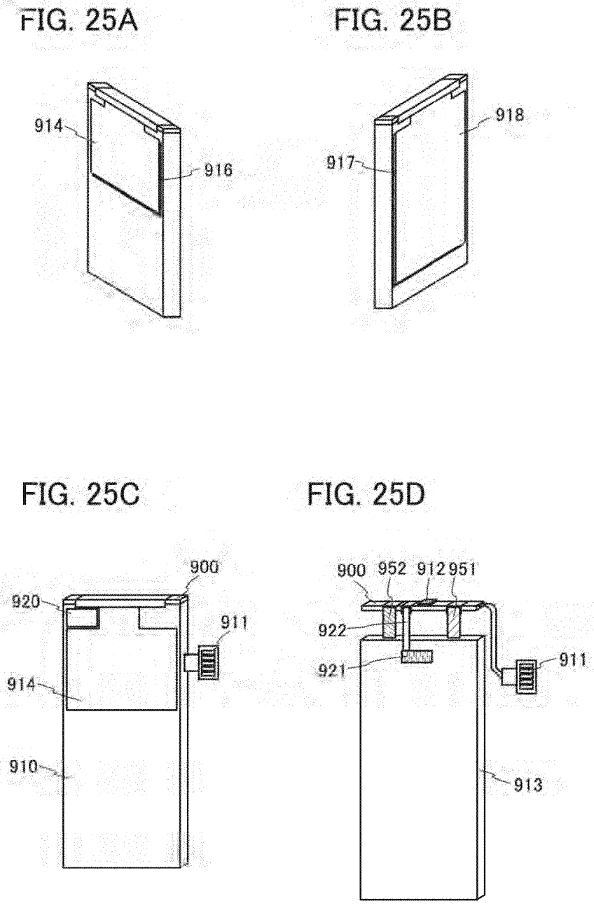

For example, as shown in FIGS. 25A and 25B, two opposite surfaces of the secondary battery 913 in FIGS. 24A and 24B may be provided with respective antennas. FIG. 25A is an external view illustrating one of the two surfaces, and FIG. 25B is an external view illustrating the other of the two surfaces. For portions identical to those in FIGS. 24A and 24B, refer to the description of the secondary battery illustrated in FIGS. 24A and 24B as appropriate.

As illustrated in FIG. 25A, the antenna 914 is provided on one of the opposite surfaces of the secondary battery 913 with the layer 916 located therebetween. As illustrated in FIG. 25B, an antenna 918 is provided on the other of the opposite surfaces of the secondary battery 913 with a layer 917 located therebetween. The layer 917 has a function of blocking an electromagnetic field from the secondary battery 913, for example. As the layer 917, for example, a magnetic body can be used.

With the above structure, both of the antennas 914 and 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as near field communication (NFC), can be employed.

Alternatively, as illustrated in FIG. 25C, the secondary battery 913 in FIGS. 24A and 24B may be provided with a display device 920. The display device 920 is electrically connected to the terminal 911. Note that the label 910 is not necessarily provided in a portion where the display device 920 is provided. For portions identical to those in FIGS. 24A and 24B, refer to the description of the secondary battery illustrated in FIGS. 24A and 24B as appropriate.

The display device 920 can display, for example, an image showing whether charge is being carried out, an image showing the amount of stored power, or the like. As the display device 920, electronic paper, a liquid crystal display device, or an electroluminescent (EL) display device can be used, for instance. For example, the use of electronic paper can reduce power consumption of the display device 920.

Alternatively, as illustrated in FIG. 25D, the secondary battery 913 in FIGS. 24A and 24B may be provided with a sensor 921. The sensor 921 is electrically connected to the terminal 911 via a terminal 922. For portions identical to those in FIGS. 24A and 24B, refer to the description of the secondary battery illustrated in FIGS. 24A and 24B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment where the secondary battery is placed (e.g., temperature) can be acquired and stored in a memory inside the circuit 912.

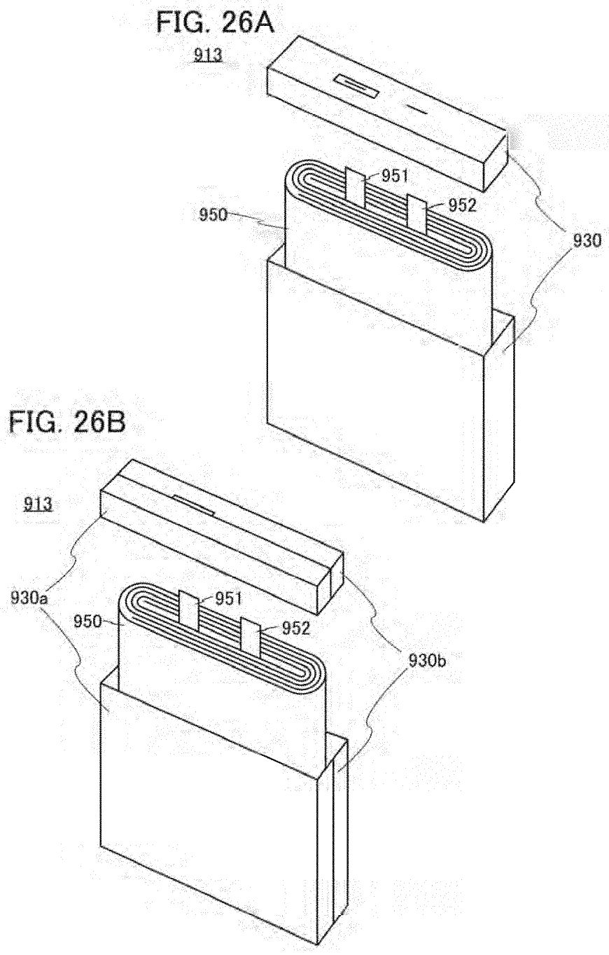

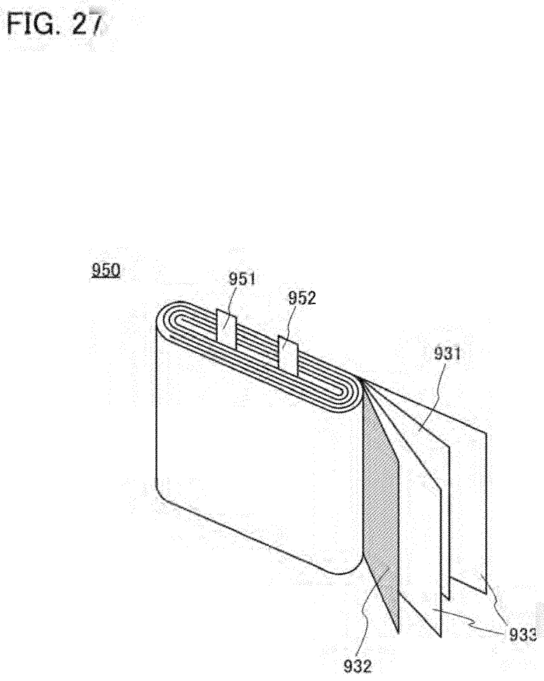

Another structure example of the secondary battery 913 is described with reference to FIGS. 26A and 26B and FIG. 27.

The secondary battery 913 illustrated in FIG. 26A includes a wound body 950 provided with the terminals 951 and 952 inside a housing 930. The wound body 950 is immersed in an electrolyte solution inside the housing 930. The terminal 952 is in contact with the housing 930. An insulator or the like prevents contact between the terminal 951 and the housing 930. Note that in FIG. 26A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 26B, the housing 930 in FIG. 26A may be formed using a plurality of materials. For example, in the secondary battery 913 in FIG. 26B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna such as the antenna 914 may be provided inside the housing 930a. For the housing 930b, a metal material can be used, for example.

FIG. 27 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

The negative electrode 931 is connected to the terminal 911 in FIGS. 24A and 24B via one of the terminals 951 and 952. The positive electrode 932 is connected to the terminal 911 in FIGS. 24A and 24B via the other of the terminals 951 and 952.

When the positive electrode active material described in the above embodiment is used in the positive electrode 932, the secondary battery 913 can have high charge and discharge capacity and excellent cycle performance.

### <Laminated Secondary Battery>

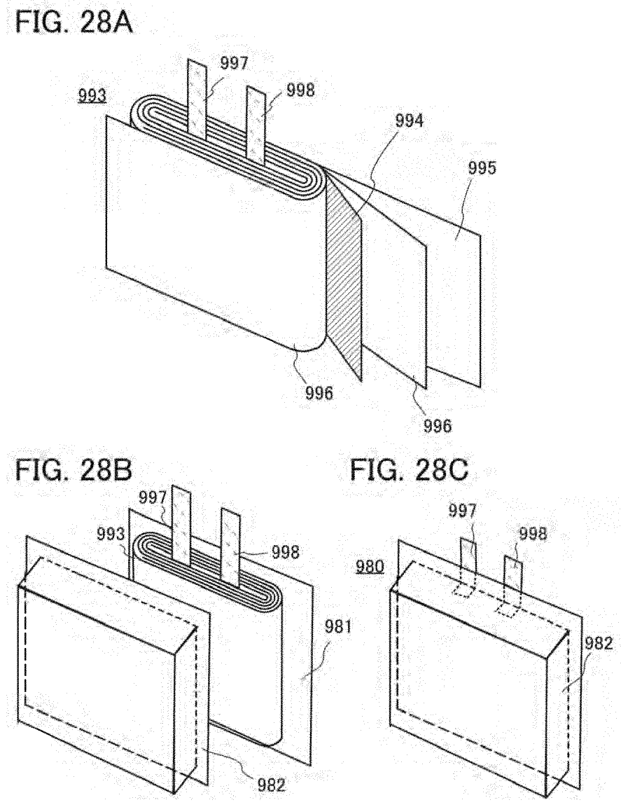

Next, examples of a laminated secondary battery are described with reference to FIGS. 28A to 28C, FIGS. 29A and 29B, FIG. 30, FIG. 31, and FIG. 32A. When a laminated secondary battery has flexibility and is used in an electronic device at least part of which is flexible, the secondary battery can be bent accordingly as the electronic device is bent.

A laminated secondary battery 980 is described with reference to FIGS. 28A to 28C. The laminated secondary battery 980 includes a wound body 993 illustrated in FIG. 28A. The wound body 993 includes a negative electrode 994, a positive electrode 995, and separators 996. The wound body 993 is, like the wound body 950 illustrated in FIG. 27, obtained by winding a sheet of a stack in which the negative electrode 994 and the positive electrode 995 overlap with the separator 996 therebetween.

Note that the number of stacks each including the negative electrode 994, the positive electrode 995, and the separator 996 can be determined as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 28B, the wound body 993 is placed in a space formed by bonding a film 981 and a film 982 having a depression by thermocompression bonding or the like, whereby the secondary battery 980 can be formed as illustrated in FIG. 28C. Note that the film 981 and the film 982 serve as an exterior body. The wound body 993 includes the lead electrode 997 and the lead electrode 998, and is immersed in an electrolyte solution inside a space surrounded by the film 981 and the film 982 having a depression.

For the film 981 and the film 982 having a depression, a metal material such as aluminum and/or a resin material can be used, for example. With the use of a resin material for the film 981 and the film 982 having a depression, the film 981 and the film 982 having a depression can be changed in their forms when external force is applied; thus, a flexible storage battery can be fabricated.

Although FIGS. 28B and 28C illustrate an example in which a space is formed by the two films, the wound body 993 may be placed in a space formed by bending one film.

When the positive electrode active material described in the above embodiment is used in the positive electrode 995, the secondary battery 980 can have high charge and discharge capacity and excellent cycle performance.

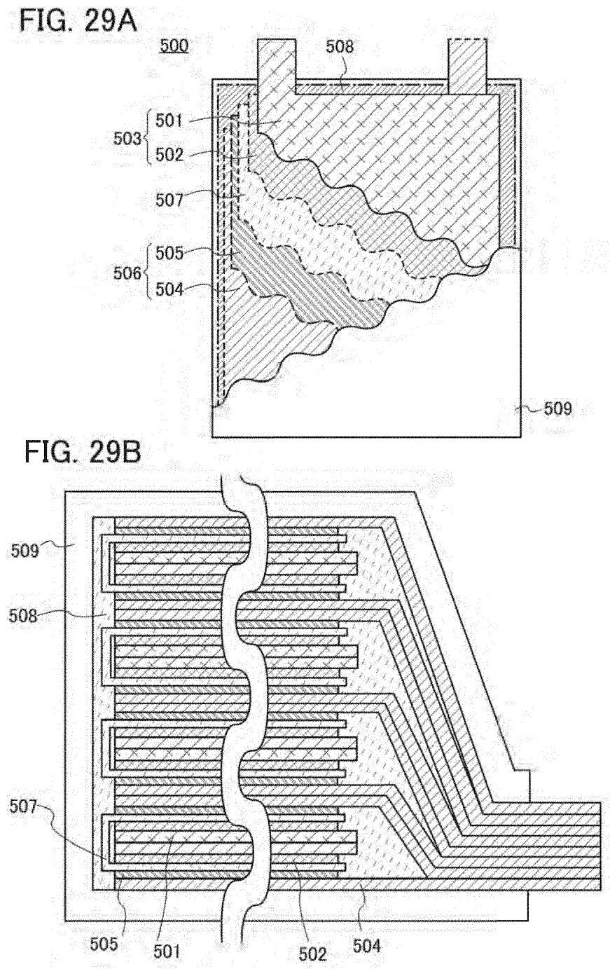

FIGS. 28A to 28C illustrate an example of the secondary battery 980 including a wound body in a space formed by films serving as an exterior body; alternatively, as illustrated in FIGS. 29A and 29B, a secondary battery may include a plurality of strip-shaped positive electrodes, a plurality of strip-shaped separators, and a plurality of strip-shaped negative electrodes in a space formed by films serving as an exterior body, for example.

A laminated secondary battery 500 illustrated in FIG. 29A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The inside of the exterior body 509 is filled with the electrolyte solution 508. The electrolyte solution described in Embodiment 3 can be used as the electrolyte solution 508.

In the laminated secondary battery 500 illustrated in FIG. 29A, the positive electrode current collector 501 and the negative electrode current collector 504 also serve as terminals for obtaining electrical contact with the outside. For this reason, the positive electrode current collector 501 and the negative electrode current collector 504 may be arranged to be partly exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 in the laminated secondary battery 500, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body can be used, for example.

FIG. 29B illustrates an example of a cross-sectional structure of the laminated secondary battery 500. Although FIG. 29A illustrates an example in which two current collectors are included for simplicity, an actual battery includes a plurality of electrode layers as illustrated in FIG. 29B.

In FIG. 29B, the number of electrode layers is 16, for example. The laminated secondary battery 500 has flexibility even though including 16 electrode layers. FIG. 29B illustrates a structure including eight layers of negative electrode current collectors 504 and eight layers of positive electrode current collectors 501, i.e., 16 layers in total. Note that FIG. 29B illustrates a cross section of the lead portion of the negative electrode, and the eight negative electrode current collectors 504 are bonded to each other by ultrasonic welding. It is needless to say that the number of electrode layers is not limited to 16 and may be greater than 16 or less than 16. With a large number of electrode layers, the secondary battery can have high charge and discharge capacity. By contrast, with a small number of electrode layers, the secondary battery can have a small thickness and high flexibility.

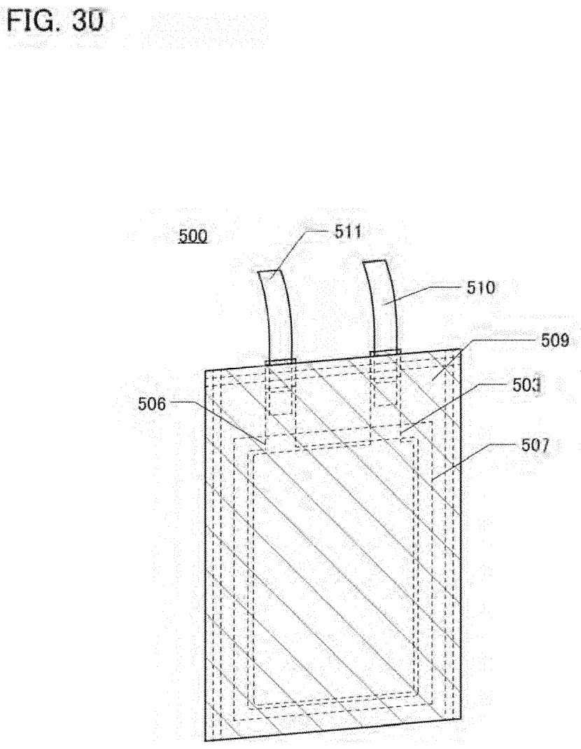

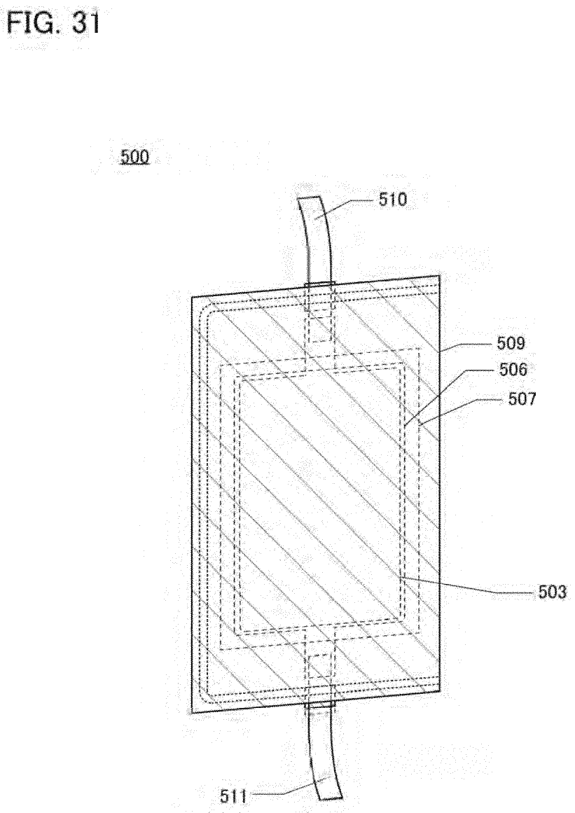

FIG. 30 and FIG. 31 illustrate examples of an external view of the laminated secondary battery 500. FIG. 30 and FIG. 31 illustrate the positive electrode 503, the negative electrode 506, the separator 507, the exterior body 509, a positive electrode lead electrode 510, and a negative electrode lead electrode 511.

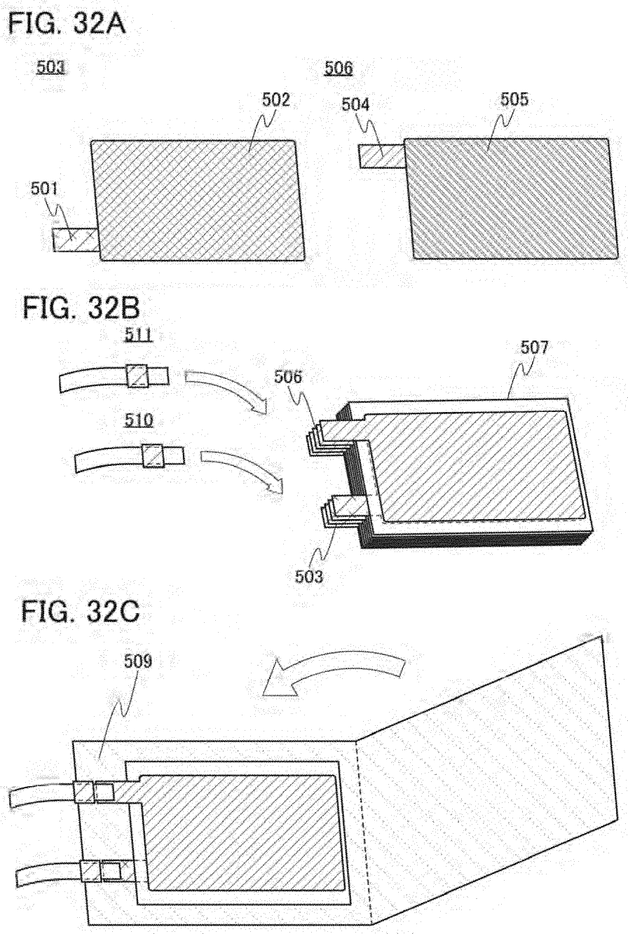

FIG. 32A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those in the example illustrated in FIG. 32A.

### <Method for Fabricating Laminated Secondary Battery>

Here, an example of a method for fabricating the laminated secondary battery whose external view is illustrated in FIG. 30 is described with reference to FIGS. 32B and 32C.

First, the negative electrode 506, the separator 507, and the positive electrode 503 are stacked. FIG. 32B illustrates the stacked negative electrodes 506, separators 507, and positive electrodes 503. The secondary battery described here as an example includes five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

Then, the negative electrodes 506, the separators 507, and the positive electrodes 503 are placed over the exterior body 509.

Subsequently, the exterior body 509 is folded along the dashed line as illustrated in FIG. 32C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be fabricated.

When the positive electrode active material described in the above embodiment is used in the positive electrode 503, the secondary battery 500 can have high charge and discharge capacity and excellent cycle performance.

In an all-solid-state battery, the contact state of the inside interface can be kept favorable by applying a predetermined pressure in the direction of stacking positive electrodes and negative electrodes. By applying a predetermined pressure in the direction of stacking the positive electrodes and the negative electrodes, the amount of expansion of the all-solid-state battery in the stacking direction due to charge and discharge can be suppressed, and the reliability of the all-solid-state battery can be improved.

This embodiment can be implemented in appropriate combination with any of the other embodiments.

### Embodiment 5

In this embodiment, examples of electronic devices each including the secondary battery of one embodiment of the present invention are described.

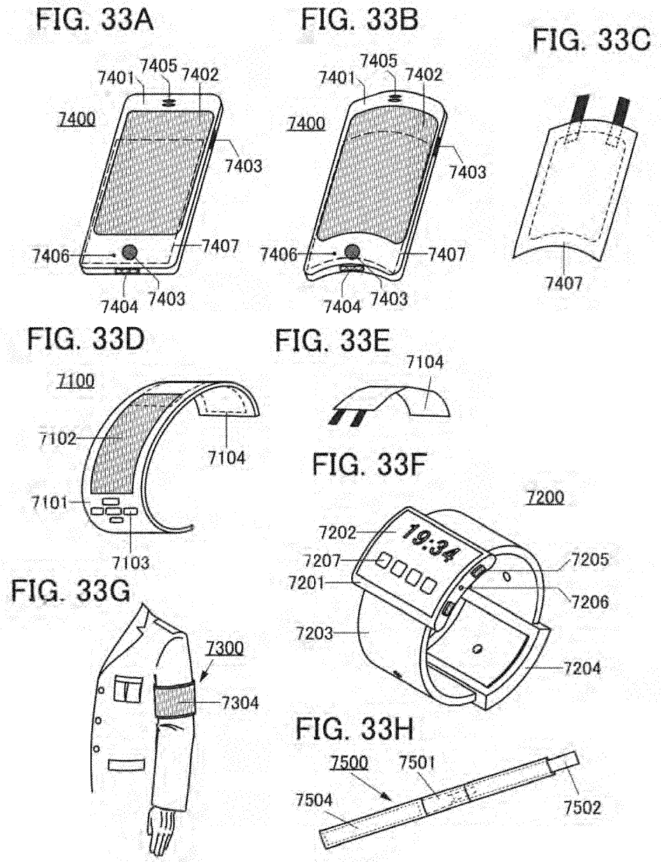

FIGS. 33A to 33G show examples of electronic devices including the bendable secondary battery described in the above embodiment. Examples of electronic devices including a bendable secondary battery include television sets (also referred to as televisions or television receivers), monitors of computers and the like, digital cameras, digital video cameras, digital photo frames, mobile phones (also referred to as cellular phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 33A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 33B illustrates the mobile phone 7400 in a state of being bent. When the whole mobile phone 7400 is bent by the external force, the secondary battery 7407 included in the mobile phone 7400 is also bent. FIG. 33C illustrates the secondary battery 7407 that is being bent at that time. The secondary battery 7407 is a thin storage battery. The secondary battery 7407 is fixed in a state of being bent. The secondary battery 7407 includes a lead electrode electrically connected to a current collector. The current collector is, for example, copper foil and is partly alloyed with gallium; thus, adhesion between the current collector and an active material layer in contact with the current collector is improved and the secondary battery 7407 can have high reliability even in a state of being bent.

FIG. 33D illustrates an example of a bangle-type display device. A portable display device 7100 includes a housing 7101, a display portion 7102, operation buttons 7103, and a secondary battery 7104. FIG. 33E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm. When the radius of curvature of the main surface of the secondary battery 7104 ranges from 40 mm to 150 mm, the reliability can be kept high. By using the secondary battery of one embodiment of the present invention as the secondary battery 7104, a lightweight long-life portable display device can be provided.

FIG. 33F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 33E that is in the state of being curved can be provided in the housing 7201. Alternatively, the secondary battery 7104 in FIG. 33E can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 33G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

By using the secondary battery of one embodiment of the present invention as the secondary battery included in the display device 7300, a lightweight long-life display device can be provided.

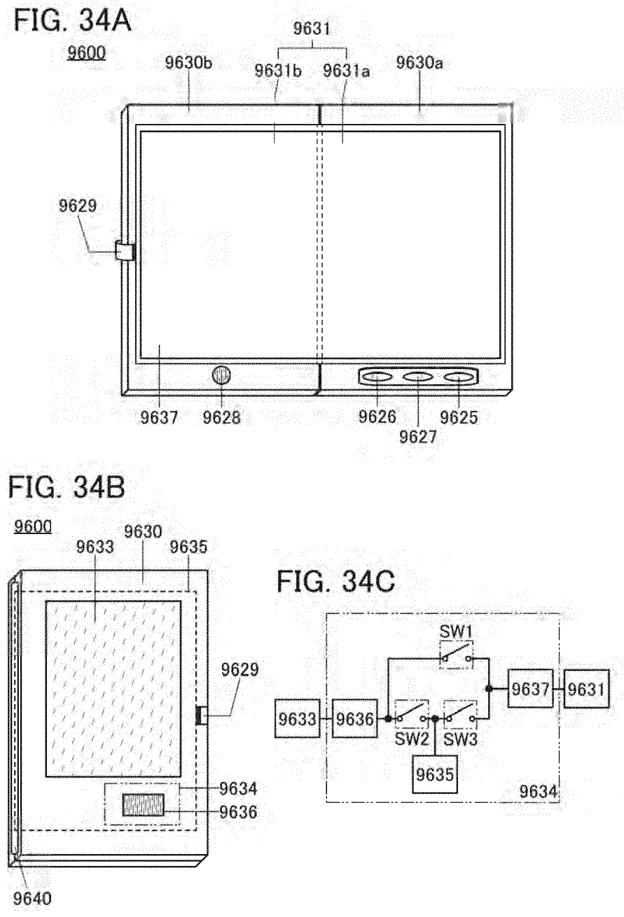

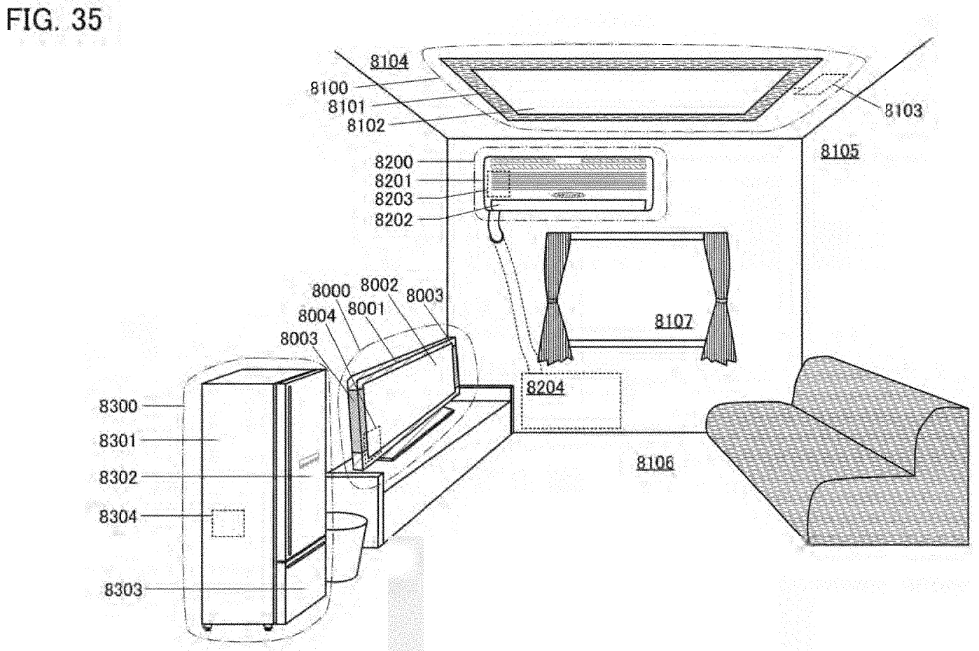

Examples of electronic devices each including the secondary battery with excellent cycle performance described in the above embodiment are described with reference to FIG. 33H, FIGS. 34A to 34C, and FIG. 35.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high charge and discharge capacity are desired in consideration of handling ease for users.

FIG. 33H is a perspective view of a device called a vaporizer (electronic cigarette). In FIG. 33H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 33H includes an external terminal for connection to a charger. When the electronic cigarette 7500 is held by a user, the secondary battery 7504 is at the tip of the device; thus, it is preferred that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

Next, FIGS. 34A and 34B illustrate an example of a tablet terminal that can be folded in half. A tablet terminal 9600 illustrated in FIGS. 34A and 34B includes a housing 9630a, a housing 9630b, a movable portion 9640 connecting the housings 9630a and 9630b, a display portion 9631 including a display portion 9631a and a display portion 9631b, switches 9625 to 9627, a fastener 9629, and an operation switch 9628. The use of a flexible panel for the display portion 9631 achieves a tablet terminal with a larger display portion. FIG. 34A illustrates the tablet terminal 9600 that is opened, and FIG. 34B illustrates the tablet terminal 9600 that is closed.

The tablet terminal 9600 includes a power storage unit 9635 inside the housings 9630a and 9630b. The power storage unit 9635 is provided across the housings 9630a and 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text and an image is displayed on the display portion 9631b on the housing 9630b side.

It is also possible that a keyboard is displayed on the display portion 9631b on the housing 9630b side, and data such as text or an image is displayed on the display portion 9631a on the housing 9630a side. Furthermore, a switching button for showing/hiding a keyboard on a touch panel may be displayed on the display portion 9631 so that the keyboard is displayed on the display portion 9631 by touching the button with a finger, a stylus, or the like.

In addition, touch input can be performed concurrently in a touch panel region in the display portion 9631a on the housing 9630a side and a touch panel region in the display portion 9631b on the housing 9630b side.

The switches 9625 to 9627 may function not only as an interface for operating the tablet terminal 9600 but also as an interface that can switch various functions. For example, at least one of the switches 9625 to 9627 may have a function of switching on/off of the tablet terminal 9600. For another example, at least one of the switches 9625 to 9627 may have a function of switching display between a portrait mode and a landscape mode and a function of switching display between monochrome display and color display. For another example, at least one of the switches 9625 to 9627 may have a function of adjusting the luminance of the display portion 9631. The luminance of the display portion 9631 can be optimized in accordance with the amount of external light in use of the tablet terminal 9600, which is detected by an optical sensor incorporated in the tablet terminal 9600. Note that in addition to the optical sensor, the tablet terminal may incorporate another sensing device such as a sensor for measuring inclination, like a gyroscope sensor or an acceleration sensor.

The display portion 9631a on the housing 9630a side and the display portion 9631b on the housing 9630b side have substantially the same display area in FIG. 34A; however, there is no particular limitation on the display areas of the display portions 9631a and 9631b, and the display portions may have different areas or different display quality. For example, one of the display portions 9631a and 9631b may display higher-definition images than the other.

The tablet terminal 9600 is folded in half in FIG. 34B. The tablet terminal 9600 includes a housing 9630, a solar cell 9633, and a charge/discharge control circuit 9634 including a DC-DC converter 9636. The secondary battery of one embodiment of the present invention is used as the power storage unit 9635.

As described above, the tablet terminal 9600 can be folded in half such that the housings 9630a and 9630b overlap with each other when not in use. Accordingly, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 capable of being used for a long time over a long period can be provided.

The tablet terminal 9600 illustrated in FIGS. 34A and 34B can also have a function of displaying various kinds of data (e.g., a still image, a moving image, and a text image), a function of displaying a calendar, a date, the time, or the like on the display portion, a touch input function of operating or editing data displayed on the display portion by touch input, a function of controlling processing by various kinds of software (programs), and the like.

The solar cell 9633, which is attached on the surface of the tablet terminal 9600, supplies electric power to the touch panel, the display portion, a video signal processing portion, and the like. Note that the solar cell 9633 can be provided on one or both surfaces of the housing 9630, and the power storage unit 9635 can be charged efficiently. The use of a lithium-ion battery as the power storage unit 9635 brings an advantage such as a reduction in size.

The structure and operation of the charge/discharge control circuit 9634 illustrated in FIG. 34B are described with reference to a block diagram in FIG. 34C. FIG. 34C illustrates the solar cell 9633, the power storage unit 9635, the DC-DC converter 9636, a converter 9637, switches SW1 to SW3, and the display portion 9631. The power storage unit 9635, the DC-DC converter 9636, the converter 9637, and the switches SW1 to SW3 correspond to the charge/discharge control circuit 9634 in FIG. 34B.

First, an operation example in which electric power is generated by the solar cell 9633 using external light is described. The voltage of electric power generated by the solar cell is raised or lowered by the DC-DC converter 9636 to a voltage for charging the power storage unit 9635. When the display portion 9631 operates with the electric power from the solar cell 9633, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives electric power wirelessly (without contact), or with a combination of such a module with another charging unit.

FIG. 35 illustrates other examples of electronic devices. In FIG. 35, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can operate with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 35, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 35 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can operate with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated as an example in FIG. 35, the secondary battery of one embodiment of the present invention can be used in an installation lighting device provided in, for example, a wall 8105, a floor 8106, a window 8107, or the like other than the ceiling 8104. Alternatively, the secondary battery can be used in a tabletop lighting device or the like.

As the light source 8102, an artificial light source that emits light artificially by using electric power can be used. Specific examples of the artificial light source include an incandescent lamp, a discharge lamp such as a fluorescent lamp, and light-emitting elements such as an LED and an organic EL element.

In FIG. 35, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 35 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can operate with the use of the secondary batteries 8203 of one embodiment of the present invention as uninterruptible power supplies even when electric power cannot be supplied from a commercial power supply due to power failure or the like.

Note that although the split-type air conditioner including the indoor unit and the outdoor unit is illustrated as an example in FIG. 35, the secondary battery of one embodiment of the present invention can also be used in an air conditioner in which the functions of an indoor unit and an outdoor unit are integrated in one housing.

In FIG. 35, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided inside the housing 8301 in FIG. 35. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can operate with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of such an electronic device can be prevented by using the secondary battery of one embodiment of the present invention as an auxiliary power supply for supplying electric power which cannot be supplied enough by a commercial power supply.

In addition, by storing electric power in the secondary battery in a time period during which electronic devices are not used, particularly a time period during which the proportion of the amount of electric power that is actually used to the total amount of electric power that can be supplied from a commercial power supply (such a proportion is referred to as an electricity usage rate) is low, the electricity usage rate can be reduced in a time period other than the above. For example, in the case of the electric refrigerator-freezer 8300, electric power is stored in the secondary battery 8304 in night time when the temperature is low and the refrigerator door 8302 and the freezer door 8303 are not often opened or closed. On the other hand, in daytime when the temperature is high and the refrigerator door 8302 and the freezer door 8303 are frequently opened and closed, the secondary battery 8304 is used as an auxiliary power supply; thus, the electricity usage rate in daytime can be reduced.

According to one embodiment of the present invention, the secondary battery can have excellent cycle performance and improved reliability. Moreover, according to one embodiment of the present invention, a secondary battery with high charge and discharge capacity can be obtained; hence, the secondary battery itself can be made more compact and lightweight as a result of improved characteristics of the secondary battery. Thus, the use of the secondary battery of one embodiment of the present invention enables the electronic device described in this embodiment to be more lightweight and have a longer lifetime.

This embodiment can be implemented in appropriate combination with any of the other embodiments.

### Embodiment 6

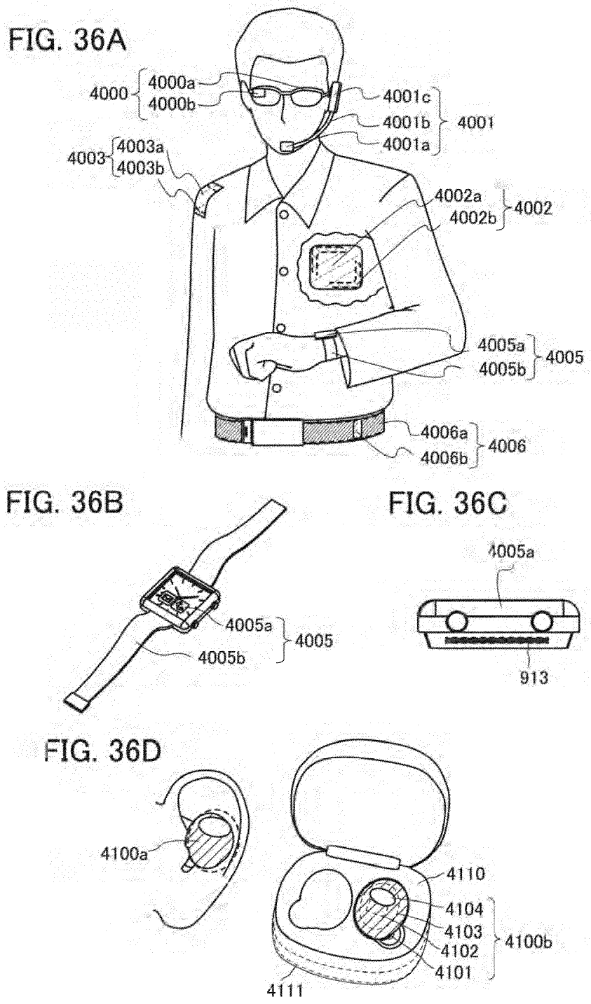

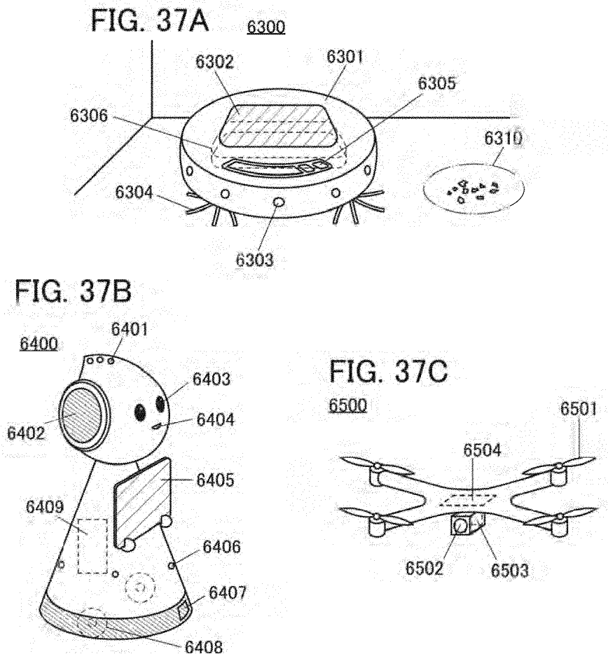

In this embodiment, examples of electronic devices each including the secondary battery described in the above embodiment are described with reference to FIGS. 36A to 36D and FIGS. 37A to 37C.

FIG. 36A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 36A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 36B is a perspective view of the watch-type device 4005 that is detached from an arm.

FIG. 36C is a side view. FIG. 36C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 36D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4100. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 37A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 37B illustrates an example of a robot. A robot 6400 illustrated in FIG. 37B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 37C illustrates an example of a flying object. A flying object 6500 illustrated in FIG. 37C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 7

In this embodiment, examples of vehicles each including the secondary battery of one embodiment of the present invention are described.

The use of secondary batteries in vehicles enables production of next-generation clean energy vehicles such as hybrid vehicles (HV), electric vehicles (EV), and plug-in hybrid vehicles (PHV).

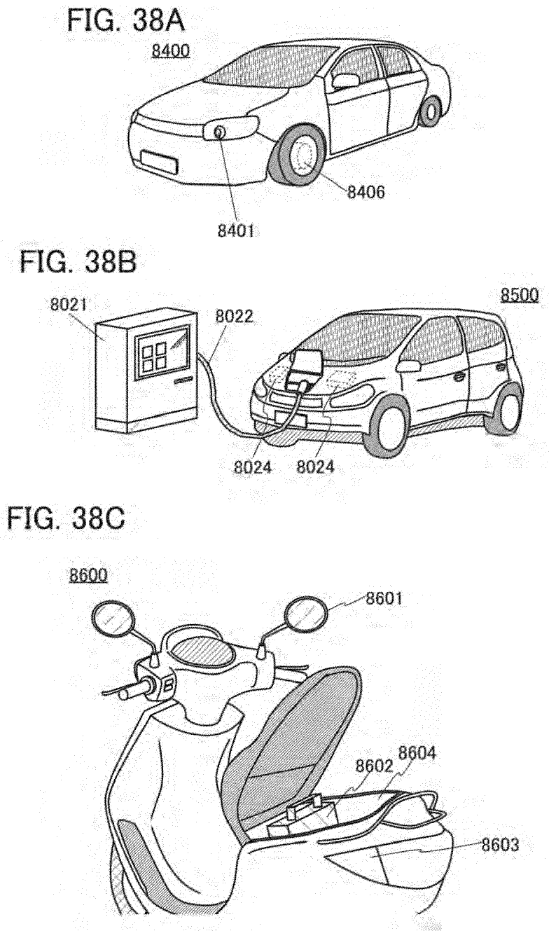

FIGS. 38A to 38C each illustrate an example of a vehicle including the secondary battery of one embodiment of the present invention. An automobile 8400 illustrated in FIG. 38A is an electric vehicle that runs on the power of an electric motor. Alternatively, the automobile 8400 is a hybrid electric vehicle capable of driving using either an electric motor or an engine as appropriate. The use of the secondary battery of one embodiment of the present invention allows fabrication of a high-mileage vehicle. The automobile 8400 includes the secondary battery. As the secondary battery, the modules of the secondary batteries illustrated in FIGS. 23C and 23D can be arranged to be used in a floor portion in the automobile. Alternatively, a battery pack in which a plurality of secondary batteries each of which is illustrated in FIGS. 26A and 26B are combined may be placed in the floor portion in the automobile. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 38B illustrates an automobile 8500 including the secondary battery. The automobile 8500 can be charged when the secondary battery is supplied with electric power from external charging equipment by a plug-in system and/or a contactless power feeding system, for example. In FIG. 38B, a secondary battery 8024 included in the automobile 8500 is charged with the use of a ground-based charging apparatus 8021 through a cable 8022. In charge, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 38C shows an example of a motorcycle including the secondary battery of one embodiment of the present invention. A motor scooter 8600 illustrated in FIG. 38C includes a secondary battery 8602, side mirrors 8601, and indicators 8603. The secondary battery 8602 can supply electric power to the indicators 8603.

In the motor scooter 8600 illustrated in FIG. 38C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased charge and discharge capacity. Thus, the secondary battery itself can be made more compact and lightweight. The compact and lightweight secondary battery contributes to a reduction in the weight of a vehicle and hence increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

In this example, the positive electrode active material 100 of one embodiment of the present invention was formed and its characteristics were analyzed.

### <Formation of Positive Electrode Active Material>

Samples formed in this example are described in accordance with the formation methods in FIG. 2 and FIGS. 3A to 3C.

As the LiMO₂ in Step S14 in FIG. 2, with the use of cobalt as the transition metal M, a commercially available lithium cobalt oxide (Cellseed C-10N produced by NIPPON CHEMICAL INDUSTRIAL CO., LTD.) not containing any added element was prepared. The initial heating in Step S15 was performed on the lithium cobalt oxide, which was put in a crucible covered with a lid, in a muffle furnace at 850° C. for 2 hours. No flowing was performed after the muffle furnace was filled with an oxygen atmosphere (i.e., O₂ purging was performed). The collected amount after the initial heating showed a slight decrease in weight. The decrease in weight was probably caused by elimination of impurities from the LCO.

In accordance with Step S21 and Step S41 shown in FIGS. 3A and 3B, Mg, F, Ni, and Al were separately added as the added elements. In accordance with Step S21 shown in FIG. 3A, LiF and MgF₂ were prepared as the F source and the Mg source, respectively. The LiF and MgF₂ were weighed so that LiF:MgF₂=1:3 (molar ratio). Then, the LiF and MgF₂ were mixed into dehydrated acetone and the mixture was stirred at a rotating speed of 400 rpm for 12 hours, whereby an added element source X_{A} was produced. In the mixing, a ball mill was used and a grinding medium was zirconium oxide balls. In the mixing ball mill, which had a capacity of 45 mL, the F source and Mg source weighing approximately 10 g in total were put together with 20 mL of dehydrated acetone and 22 g of zirconium oxide balls (1 mm ϕ) and mixed. Then, the mixture was made to pass through a sieve with an aperture of 300 μm, whereby the added element source X_{A} having a uniform particle diameter was obtained.

Next, the added element source X_{A} was weighed to be 1 at % of the transition metal M, and mixed with the LCO subjected to the initial heating by a dry method. At this time, stirring was performed at a rotating speed of 150 rpm for 1 hour. These conditions were milder than those of the stirring in the production of the added element source X_{A}. Finally, the mixture was made to pass through a sieve with an aperture of 300 μm, whereby a mixture A having a uniform particle diameter was obtained.

Then, the mixture A was heated. The heating was performed at 900° C. for 20 hours. During the heating, the mixture A was in a crucible covered with a lid. The crucible was filled with an atmosphere containing oxygen and entry and exit of the oxygen were blocked. By the heating, LCO (a composite oxide A) containing Mg and F was obtained.

Then, an added element source X_{B} was added to the composite oxide A. In accordance with Step S41 shown in FIG. 3B, nickel hydroxide and aluminum hydroxide were prepared as the Ni source and the Al source, respectively. The nickel hydroxide and the aluminum hydroxide were each weighed to be 0.5 at % of the transition metal M, and were mixed with the composite oxide A by a dry method. At this time, stirring was performed at a rotating speed of 150 rpm for 1 hour. In the mixing, a ball mill was used and a grinding medium was zirconium oxide balls. In the mixing ball mill, which had a capacity of 45 mL, the Ni source and Al source weighing approximately 7.5 g in total were put together with 22 g of zirconium oxide balls (1 mm ϕ) and mixed. These conditions were milder than those of the stirring in the production of the added element source X_{A}. Finally, the mixture was made to pass through a sieve with an aperture of 300 μm, whereby a mixture B having a uniform particle diameter was obtained.

Then, the mixture B was heated. The heating was performed at 850° C. for 10 hours. During the heating, the mixture B was in a crucible covered with a lid. The crucible was filled with an atmosphere containing oxygen and entry and exit of the oxygen were blocked. By the heating, LCO containing Mg, F, Ni, and Al was obtained. The positive electrode active material (composite oxide) obtained through the above steps was used as Sample 1-1.

Sample 1-2 was formed in the same manner as Sample 1-1 except that the heating time in Step S15 was 10 hours.

Sample 1-3 was formed in the same manner as Sample 1-1 except that the heating temperature in Step S15 was 750° C.

Sample 1-4 was formed in the same manner as Sample 1-1 except that the heating temperature in Step S15 was 900° C.

Sample 1-5 was formed in the same manner as Sample 1-1 except that the heating temperature in Step S15 was 950° C.

In formation of Sample 2, the heating in Step S15 was not performed and the heating in Step S53 was performed with the oxygen flow rate set to 10 L/min.

As Sample 10, which was a reference, lithium cobalt oxide (Cellseed C-10N produced by NIPPON CHEMICAL INDUSTRIAL CO., LTD.) not subjected to any treatment was used.

As Sample 11, lithium cobalt oxide which was only subjected to the heating in Step S15 was used.

Table 1 lists the formation conditions of Samples 1-1, 1-2, 1-3, 1-4, 1-5, 2, 10, and 11. As shown in Table 1, the commonality of Samples 1-1 to 1-5 is that they were formed in the following manner: the initial heating was performed on LiCoO₂ not containing any added element, a magnesium source, a fluorine source, a nickel source, and an aluminum source were added, and then, heating was performed; therefore, all of Samples 1-1 to 1-5 may be referred to as Sample 1 to be distinguished from the samples not having the commonality.

TABLE 1
Formation conditions

| | | Initial | Added | Heating | Added | Heating |
|---|---|---|---|---|---|---|
| | | heating | element | ° C. | element | ° C. |
| | LiMO₂ | ° C. (hour) | source | (hour) | source | (hour) |
| Sample 1-1 | LiCoO₂ | 850 (2) | LiF | 900 (20) | Ni(OH)₂ | 850 (10) |
| Sample 1-2 | | 850 (10) | MgF₂ | | Al(OH)₃ | |
| Sample 1-3 | | 750 (2) | | | | |
| Sample 1-4 | | 900 (2) | | | | |
| Sample 1-5 | | 950 (2) | | | | |
| Sample 2 | LiCoO₂ | — | LiF | 900 (20) | Ni(OH)₂ | 850 (10) |
| | | | MgF₂ | | Al(OH)₃ | |
| Sample 10 | LiCoO₂ | — | — | — | — | — |
| (reference) | | | | | | |
| Sample 11 | | 850 (2) | — | — | — | — |

### <SEM>

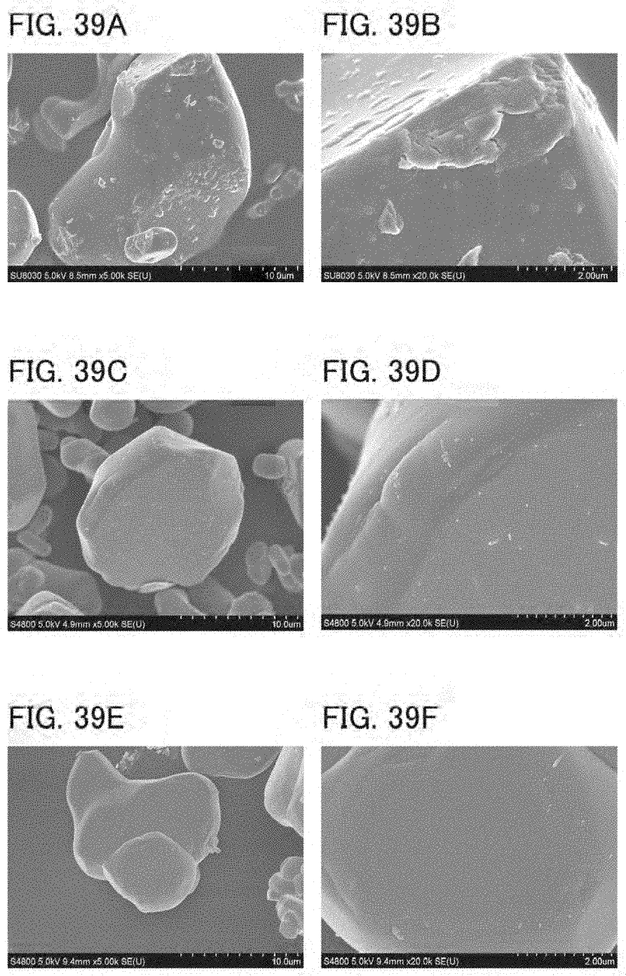

FIGS. 39A to 39F show results of observation using a scanning electron microscope (SEM). The SEM observation in this example was conducted with the use of an SU8030 scanning electron microscope produced by Hitachi High-Tech Corporation under measurement conditions where the acceleration voltage was 5 kV and the magnification was 5000 times or 20000 times.

FIGS. 39A and 39B show SEM images of Sample 10, which was pre-synthesized lithium cobalt oxide (LCO) (Cellseed C-10N produced by NIPPON CHEMICAL INDUSTRIAL CO., LTD.). FIG. 39A shows an overall view of the LCO. FIG. 39B is an enlarged view of the particle which is shown in FIG. 39A, and shows part of the LCO. Both SEM observation results show a rough surface of the LCO, to which a foreign matter seems to be attached. The pre-synthesized LCO was found to have a surface with much unevenness.

FIGS. 39C and 39D are SEM images of Sample 11 (Cellseed C-10N (LCO) on which the heat treatment was performed). FIG. 39C shows an overall view of the LCO. FIG. 39D is an enlarged view of FIG. 39C and shows part of the LCO. Both SEM observation results showed that the LCO had a smooth surface. The LCO subjected to the initial heating was found to have a surface with reduced unevenness.

FIGS. 39E and 39F show SEM images of Sample 1-1 (Cellseed C-10N (LCO) on which the heat treatment was performed and which contained Mg, F, Ni, and Al as the added elements). FIG. 39E shows an overall view of the LCO. FIG. 39F is an enlarged view of FIG. 39E and shows part of the LCO. Both SEM observation results showed that the LCO had a smooth surface. The surface of this LCO was smoother than that of the LCO on which the initial heating was only performed. The LCO which was subjected to the initial heating and to which the added elements were added was found to have a surface with reduced unevenness.

The SEM observation results showed that the initial heating makes a surface of LCO smooth. It can be deemed that the initial heating conditioned the LCO surface and reduced a shift in a crystal and the like, thereby making the surface smooth. It was found that the surface of the LCO maintained the smoothness or had increased smoothness in the case where the added elements were added after the initial heating.

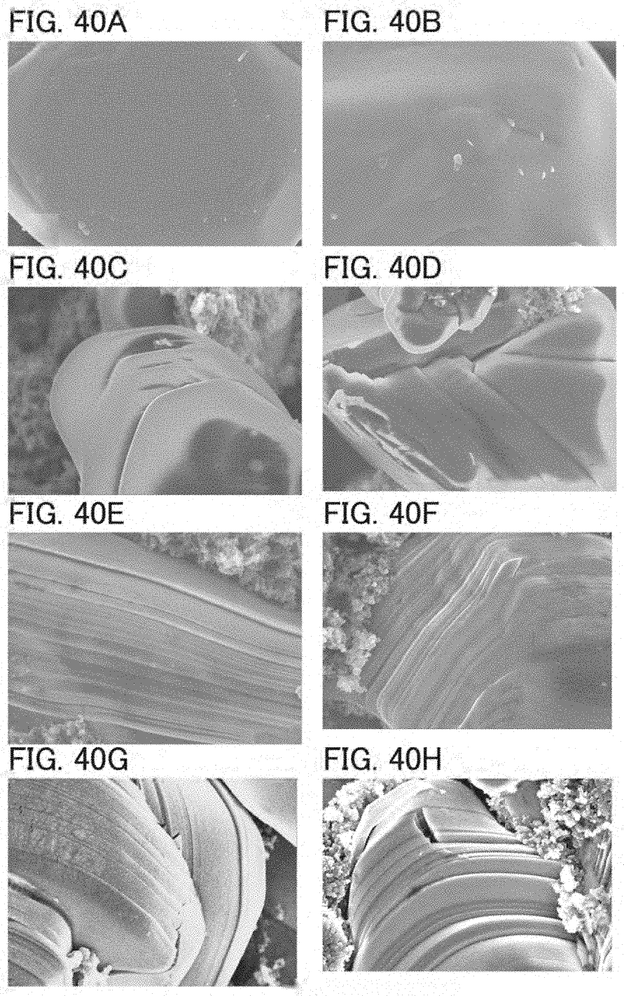

Next, the state of the completed LCO in powder form, that of the LCO before pressing, that of the LCO after pressing, and that of the LCO after a cycle test were observed with a SEM. First, the state of the powder is described. FIG. 40A shows a SEM image of Sample 1-1, on which the initial heating was performed. This image corresponds to FIG. 39F. FIG. 40B shows Sample 10, on which the initial heating was not performed. From FIGS. 40A and 40B, it was found that Sample 1-1, on which the initial heating was performed, had a smooth surface to which few foreign matters were attached.

Next, the state before pressing is described. The LCO before pressing refers to LCO obtained in the following manner: a slurry was formed by mixing an active material, a conductive material, and the like under predetermined conditions, the slurry was applied to a current collector, and a solvent of the slurry was volatilized. The slurry was formed by mixing, at 2000 rpm, LCO in powder form as the active material, acetylene black (AB) as the conductive material, and PVDF as a binder at a ratio LCO:AB:PVDF=95:3:2 (wt %). The solvent of the slurry was NMP, which was volatilized after the slurry was applied to an aluminum current collector. FIG. 40C shows a SEM image of Sample 1-1, on which the initial heating was performed, before pressing. FIG. 40D shows a SEM image of Sample 10, on which the initial heating was not performed, before pressing. FIGS. 40C and 40D showed that a crack was generated at a surface and the like of the LCO by the mixing.

Next, the state after pressing is described. The LCO after pressing refers to the slurry on the current collector which was pressed after the volatilization of the solvent. The pressing consisted of pressure application at 210 kN/m and subsequent pressure application at 1467 kN/m. FIG. 40E shows a SEM image of Sample 1-1, on which the initial heating was performed, after the pressing. FIG. 40F shows a SEM image of Sample 10, on which the initial heating was not performed, after the pressing. FIGS. 40E and 40F showed that slipping was caused at a surface and the like of the LCO by the pressing.

### <Slipping>

Slipping, or a stacking fault, refers to deformation of LCO along the lattice fringe direction (a-b plane direction) by pressing. The deformation includes forward and backward shifts of lattice fringes. When lattice fringes are shifted forward and backward from each other, steps are generated on the particle surface which is in the perpendicular direction with respect to the lattice fringes (the c-axis direction). The steps on the surface can be observed as lines horizontally crossing the image in each of FIGS. 40E and 40F.

Next, the state after a cycle test is described. Half cells including the LCO after the pressing were formed for the cycle test and measurement was performed.

As the electrolyte solution used in the half cells, a mixture of ethylene carbonate (EC) and diethyl carbonate (DEC) at a volume ratio of 3:7 to which vinylene carbonate (VC) was added as an additive at 2 wt % was prepared. As an electrolyte contained in the electrolyte solution, 1 mol/L lithium hexafluorophosphate (LiPF₆) was used.

As a separator used in the half cells, polypropylene was used. As a counter electrode used in the half cells, a lithium metal was prepared. Coin-type half cells were thus fabricated and their cycle performance was measured.

A discharge rate and a charge rate as cycle conditions are described. The discharge rate refers to the relative ratio of a current in discharge to the battery capacity and is expressed in a unit C. A current of approximately 1 C in a battery with a rated capacity X (Ah) is X A. The case where discharge is performed at a current of 2X A is rephrased as follows: discharge is performed at 2 C. The case where discharge is performed at a current of X/5 A is rephrased as follows: discharge is performed at 0.2 C. Similarly, for the charge rate, the case where charge is performed at a current of 2X A is rephrased as follows: charge is performed at 2 C, and the case where charge is performed at a current of X/5 A is rephrased as follows: charge is performed at 0.2 C.

The fabricated half cells each underwent 50 cycles of charge and discharge at a charge rate of 0.5 C (1 C=200 mA/g), a discharge rate of 0.5 C, a charge and discharge voltage of 4.6 V, and a measurement temperature of 25° C. FIG. 40G shows a SEM image of Sample 1-1, on which the initial heating was performed, after the cycle test. FIG. 40H shows a SEM image of Sample 10, on which the initial heating was not performed, after the cycle test. FIGS. 40G and 40H were compared, with a focus on the state of the slipping after the cycle test. It was shown that the slipping in Sample 1-1 (FIG. 40G) did not proceed as much as that in Sample 10 (FIG. 40H) and Sample 1-1 in FIG. 40G was in almost the same state as Sample 1-1 after the pressing. In Sample 10 (FIG. 40H), on which the initial heating was not performed, the slipping proceeded and the steps increased; thus, distinct line patterns appeared.

The SEM observation results showed that in the LCO whose surface has been made smooth by the initial heating, the progress of slipping can be suppressed in the period from the end of the pressing to the end of the cycle test. It is inferred that slipping proceeds after the cycle test and the slipping and other defects lead to deterioration. The initial heating is preferable because it can at least suppress the progress of slipping.

### <STEM and Energy Dispersive X-Ray Spectroscopy (EDX)>

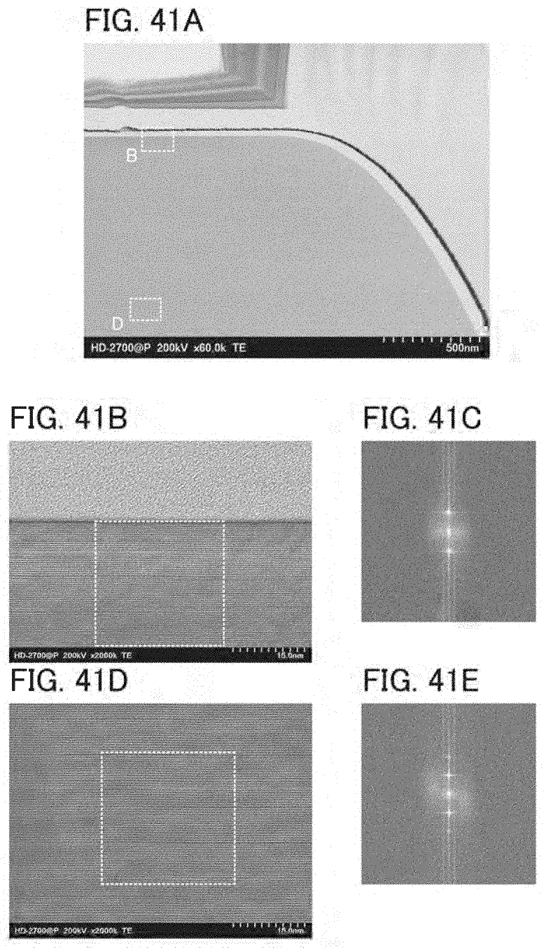

Next, surface analysis (for example, element mapping) of the added elements of LCO was conducted by STEM-EDX. The STEM-EDX analysis was conducted with the use of HD-2700 produced by Hitachi High-Tech Corporation under measurement conditions where the acceleration voltage was 200 kV and the magnification was 600000 times or 2000000 times. FIG. 41A shows a cross-sectional STEM image of Sample 2 (LCO containing at least Mg and Al as the added elements) before pressing. The magnification is 600000 times, and the regions separately observed at a magnification of 2000000 times are framed. The samples for the STEM-EDX analysis was cut in a manner to obtain a cross section of a positive electrode active material particle which is perpendicular to a flat surface of the positive electrode active material particle. To take STEM images, the observation sample was coated with a carbon film (pretreatment for observation).

FIG. 41B shows results of observation of the region denoted by the frame with B in FIG. 41A at a magnification of 2000000 times. Lattice fringes which indicate crystal planes corresponding to Co layers and the like of the LCO are shown. The lattice fringes are parallel to the top surface. Note that a region in which lattice fringes can be observed has crystallinity.

FIG. 41C shows results of fast Fourier transform (FFT) analysis performed on the cross-sectional STEM image in FIG. 41B. FFT analysis enables extraction of periodic components from an image and observation of bright spots corresponding to atomic arrangement in a crystal region. In an FFT pattern, a reciprocal lattice point of a crystal structure appears as a bright spot; thus, a clear bright spot suggests high crystallinity and a halo pattern as an FFT pattern suggests low crystallinity. Clear bright spots are seen in FIG. 41C, which indicates high crystallinity.

FIG. 41D shows results of observation of the region denoted by the frame with D in FIG. 41A at a magnification of 2000000 times. Lattice fringes indicating crystals of the LCO can be observed. Again, the lattice fringes are parallel to the top surface.

FIG. 41E shows results of FFT performed on the cross-sectional STEM image in FIG. 41D. Clear bright spots are seen, which indicates high crystallinity.

In FIGS. 41C and 41E, bright spots derived from the (001) plane of the LCO are seen. The angle formed by the lattice fringe and the bright spot in FIG. 41C is the same as that in FIG. 41E, which shows that the same crystal plane continues from the region denoted by the frame with B to the region denoted by the frame with D. Furthermore, the surface in FIG. 41B is assumed to be the surface of the LCO having a (001) orientation.

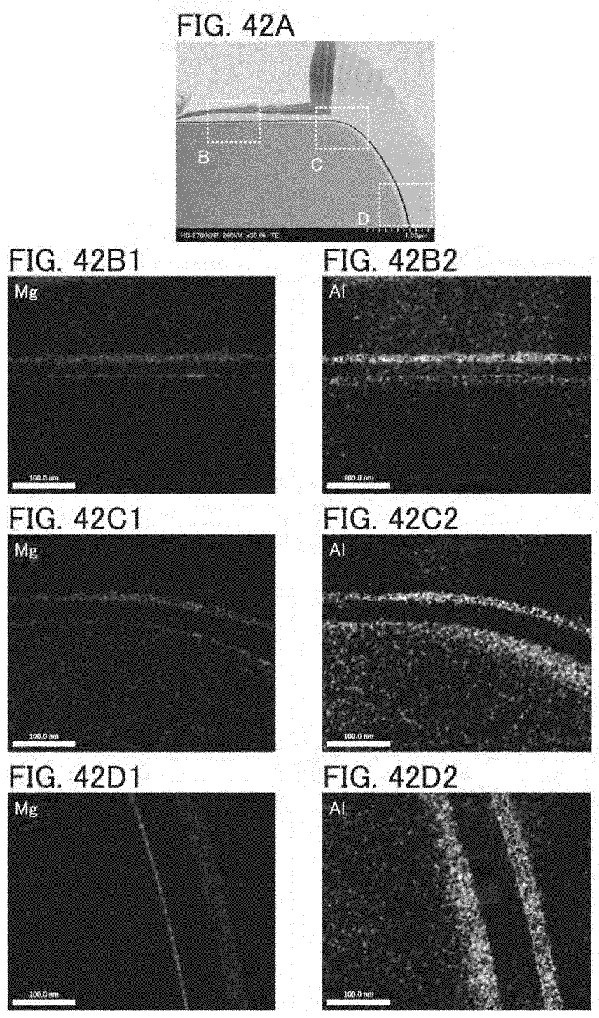

FIG. 42A shows a cross-sectional STEM image that includes the region shown in FIG. 41A. The regions subjected to EDX surface analysis of Mg and Al concentrations are framed. FIGS. 42B1 and 42B2 correspond to the region denoted by the frame with B and respectively show element mapping images of Mg atoms and Al atoms. FIGS. 42C1 and 42C2 correspond to the region denoted by the frame with C and respectively show element mapping images of Mg atoms and Al atoms. FIGS. 42D1 and 42D2 correspond to the region denoted by the frame with D and respectively show element mapping images of Mg atoms and Al atoms. In the EDX element mapping images, a region where the count is below a lower limit of the detection is denoted in black, and as the count is increased, the black region becomes white.

As shown in FIGS. 42B1, 42B2, 42C1, 42C2, 42D1, and 42D2, Mg atoms and Al atoms are present in a large amount relatively in the surface portion. Note that the outer one out of the two white regions indicates the position of the carbon film. FIGS. 42B1, 42B2, 42C1, 42C2, and 42D2 showed that the concentrations of Mg atoms and Al atoms are higher in the surface portion, although Mg atoms and Al atoms also exist in the inner portion. In each of the analyzed regions, the distribution of Al is broader than that of Mg in the surface portion.

The distributions of Mg and Al are different between observation regions. In FIGS. 42B1 and 42B2 in which the surface is estimated to be the surface of the LCO having a (001) orientation, the distributions of Mg and Al are limited within a portion at a shallow depth from the surface. Specifically, the distribution of Mg is partly discontinuous as clearly observed in FIG. 42B1.

In FIGS. 42C1, 42C2, 42D1, and 42D2 in which the surface is estimated not to have a (001) orientation, Mg and Al are distributed to a deeper portion. Specifically, in the portion denoted by the frame with C in FIG. 42A, where the surface changes from the (001) plane to a crystal plane other than the (001) plane, Al is distributed deeper as the angle formed by the (001) plane and the surface becomes larger, as clearly shown in FIG. 42C2. As shown in FIG. 42C1, Mg is distributed in a similar manner.

The frame with D in FIG. 42A denotes a portion where the angle between the surface and an estimated (001) plane is as large as 60° or more. As shown in FIGS. 42D1 and 42D2, Mg and Al are distributed deeper (more away) from the surface than in the above two portions and the distributions are continuous.

It was thus found that the added elements such as magnesium and aluminum do not easily enter the (001) plane of the crystal structure belonging to R-3m of the positive electrode active material 100, i.e., a surface parallel to the crystal fringe, but easily enter the other surfaces.

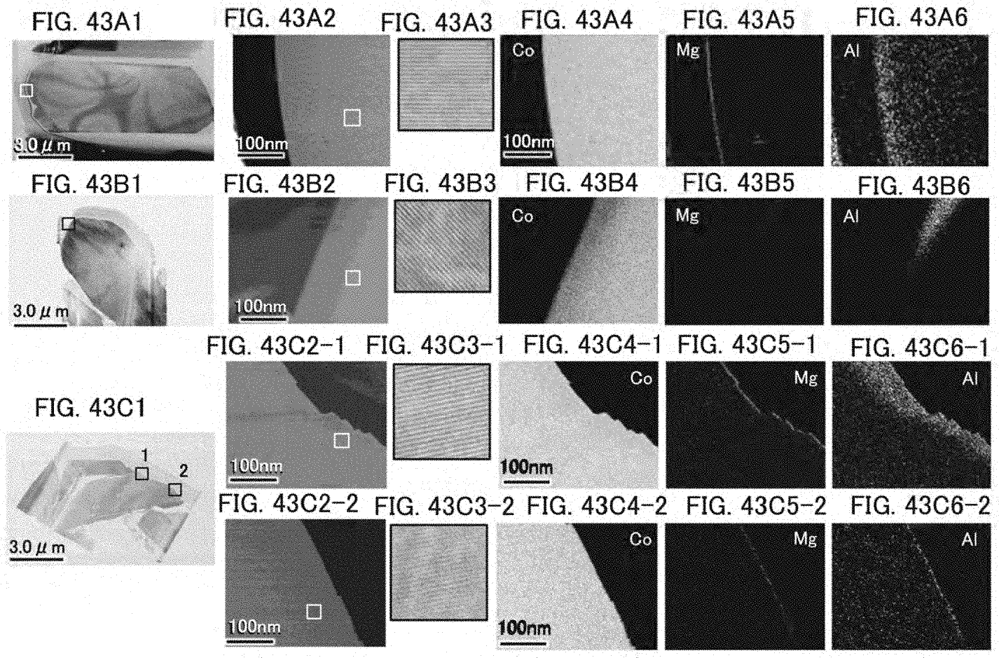

In a similar manner, Sample 2 was subjected to STEM-EDX surface analysis before and after a charge and discharge cycle test. FIGS. 43A1 to 43A6 are STEM images and EDX mapping images before the charge and discharge cycle test. FIGS. 43B1 to 43B6, 43C1, 43C2-1 to 43C6-1, and 43C2-2 to 43C6-2 are STEM images and EDX mapping images after 50 cycles.

FIG. 43A1 is a STEM (TE) image in which an overall view of the LCO can be observed. FIG. 43A2 shows a higher magnification STEM (ZC) image of the portion denoted by the frame in FIG. 43A1. FIG. 43A3 shows a higher magnification STEM (TE) image of the portion denoted by the frame in FIG. 43A2. The crystal fringe in FIG. 43A3 suggests that the surface in FIG. 43A2 is not estimated to have a (001) orientation and the angle between the (001) plane and the surface is almost 90°.

FIGS. 43A4, 43A5, and 43A6 are mapping images of cobalt, magnesium, and aluminum, respectively. Each mapping image shows the same region as FIG. 43A2. It is obvious that cobalt is uniformly distributed throughout the LCO and the concentrations of magnesium and aluminum are higher in the surface portion than in the inner portion.

FIG. 43B1 is a STEM (TE) image in which an overall view of the LCO can be observed. FIG. 43B2 shows a higher magnification STEM (ZC) image of the portion denoted by the frame in FIG. 43B1. FIG. 43B3 shows a higher magnification STEM (TE) image of the portion denoted by the frame in FIG. 43B2. The crystal fringe in FIG. 43B3 suggests that the surface in FIG. 43B2 is not estimated to have a (001) orientation and the angle between the (001) plane and the surface is almost 90°.

FIGS. 43B4, 43B5, and 43B6 are mapping images of cobalt, magnesium, and aluminum, respectively. Each mapping image shows the same region as FIG. 43B2. Here, the surface portion includes a portion where magnesium or aluminum was not observed despite the fact that the surface does not have a (001) orientation.

FIG. 43C1 is a STEM (TE) image in which an overall view of the LCO can be observed. FIG. 43C2-1 shows a higher magnification STEM (ZC) image of the portion denoted by the frame with 1 in FIG. 43C1. FIG. 43C3-1 shows a higher magnification STEM (TE) image of the portion denoted by the frame in FIG. 43C2-1. FIG. 43C2-2 shows a higher magnification STEM (ZC) image of the portion denoted by the frame with 2 in FIG. 43C1. FIG. 43C3-2 shows a higher magnification STEM (TE) image of the portion denoted by the frame in FIG. 43C2-2.

The crystal fringes in FIGS. 43C3-1 and 43C3-2 showed that both of the surfaces are not estimated to have a (001) orientation and the angle between the (001) plane and the surface is almost 90°. It was also found that slipping parallel to the (001) plane occurred in the region in FIG. 43C2-1.

FIGS. 43C4-1 and 43C4-2 are mapping images of cobalt, FIGS. 43C5-1 and 43C5-2 are those of magnesium, and FIGS. 43C6-1 and 43C6-2 are those of aluminum.

The mapping images in FIGS. 43C4-1 to 43C6-1 show the same region as FIG. 43C2-1, and the mapping images in FIGS. 43C4-2 to 43C6-2 show the same region as FIG. 43C2-2.

As can be seen in FIGS. 43C5-1 and 43C6-1, the distributions of magnesium and aluminum are discontinuous in the surface portion owing to the slipping.

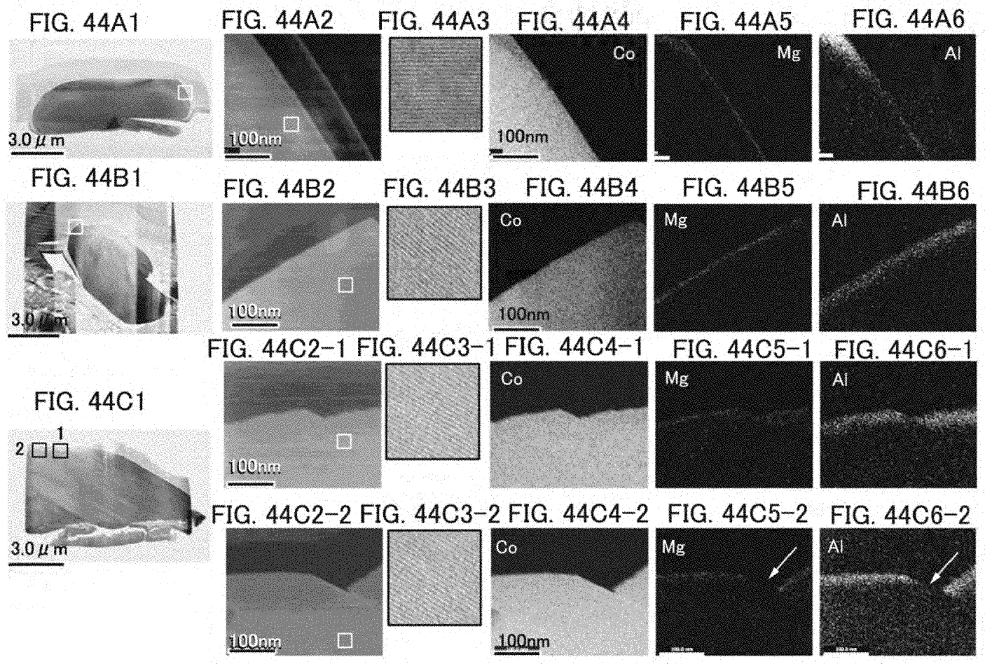

Next, in a similar manner, Sample 1-1 was subjected to STEM-EDX surface analysis before and after a charge and discharge cycle test. FIGS. 44A1 to 44A6 are STEM images and EDX mapping images before the charge and discharge cycle test. FIGS. 44B1 to 44B6, 44C1, 44C2-1 to 44C6-1, and 44C2-2 to 44C6-2 are STEM images and EDX mapping images after 50 cycles.

FIG. 44A1 is a STEM (TE) image in which an overall view of the LCO can be observed. FIG. 44A2 shows a higher magnification STEM (ZC) image of the portion denoted by the frame in FIG. 44A1. FIG. 44A3 shows a higher magnification STEM

(TE) image of the portion denoted by the frame in FIG. 44A2. The crystal fringe in FIG. 44A3 suggests that the surface in FIG. 44A2 is not estimated to have a (001) orientation and the angle between the (001) plane and the surface is approximately 45°.

FIGS. 44A4, 44A5, and 44A6 are mapping images of cobalt, magnesium, and aluminum, respectively. Each mapping image shows the same region as FIG. 44A2. It is obvious that cobalt is uniformly distributed throughout the LCO and the concentrations of magnesium and aluminum are higher in the surface portion than in the inner portion.

Also in FIGS. 44B1 to 44B6, 44C1, 44C2-1 to 44C6-1, and 44C2-2 to 44C6-2, the concentrations of magnesium and aluminum are obviously higher in the surface portion than in the inner portion. As in Sample 2, slipping parallel to the (001) plane resulted in discontinuous distributions of magnesium and aluminum in the surface portion. In FIGS. 44C5-2 and 44C6-2, the arrows denote the portion where the distributions of magnesium and aluminum are discontinuous owing to the slipping.

In Sample 2, the surface portion includes a portion where magnesium or aluminum was not observed despite the fact that the surface does not have a (001) orientation; meanwhile, such a portion was not observed in Sample 1-1. The initial heating probably improved the distributions of the added elements such as magnesium and aluminum.

### <Particle Size Distribution and Specific Surface Area>

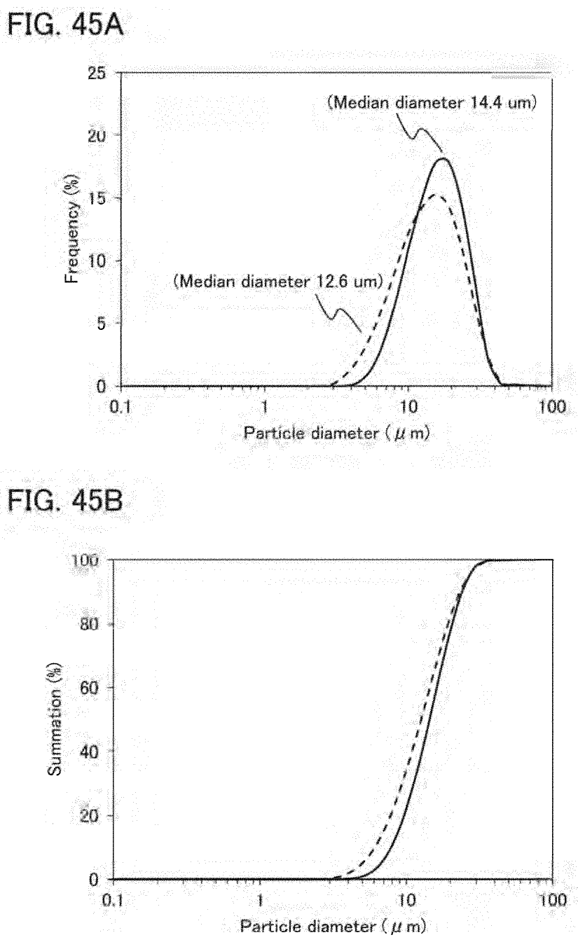

Next, FIGS. 45A and 45B show results of measuring particle size distribution before and after the initial heating. The measurement was performed with a particle size distribution analyzer using a laser diffraction and scattering method. FIG. 45A shows the frequency and FIG. 45B shows the results of a summation. The dotted line denotes the results of Sample 10, which is the pre-synthesized lithium cobalt oxide (LCO) (Cellseed C-10N produced by NIPPON CHEMICAL INDUSTRIAL CO., LTD.), whereas the solid line denotes the results of Sample 11 (Cellseed C-10N (LCO) on which the heat treatment was performed).

Next, Table 2 shows results of measuring the specific surface areas of Sample 10 and Sample 11. The measurement was performed with a specific surface area analyzer using a constant-volume gas adsorption method.

TABLE 2

| | Specific surface area |
|---|---|
| Sample 10 | 0.314 m²/g |
| Sample 11 | 0.169 m²/g |

The particle size distribution showed that the median diameter increased through the heating. The specific surface area decreased through the heating, meaning that the surface became smooth and the shape became nearly spherical. These results are consistent with the results of the SEM observation.

### <Unevenness of Active Material Surface>

In this example, unevenness of the surfaces of Sample 1-1, Sample 10, and Sample 11 was measured by the following method to evaluate the smoothness of the surfaces of the active materials.

First, scanning electron microscope (SEM) images of Sample 1-1, Sample 10, and Sample 11 were taken. At this time, Sample 1-1, Sample 10, and Sample 11 were subjected to the SEM measurement under the same conditions. Examples of the measurement conditions include acceleration voltage and a magnification. Conductive coating was performed on the samples as pretreatment for the SEM observation in this example. Specifically, platinum sputtering was performed for 20 seconds. An SU8030 scanning electron microscope produced by Hitachi High-Tech Corporation was used for the observation. The measurement conditions were as follows: the acceleration voltage was 5 kV, the magnification was 5000 times, the working distance was 5.0 mm, the emission current was 9 μA to 10.5 μA, and the extraction voltage was 5.8 kV. All the samples were measured under the same conditions both in an SE(U) mode (upper secondary electron detector) and an auto brightness contrast control (ABC) mode, and observed in an autofocus mode.

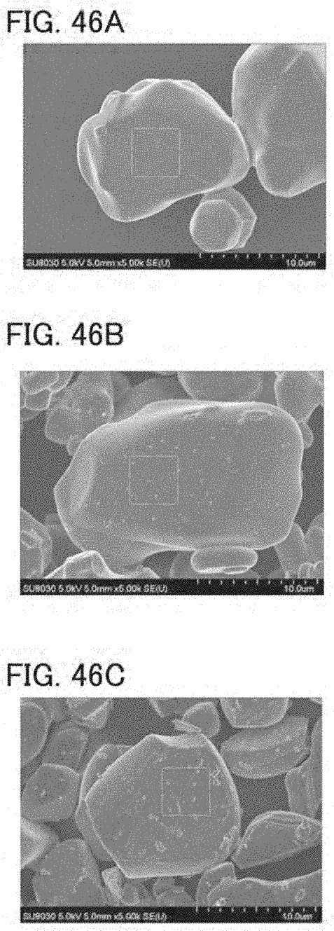

FIGS. 46A, 46B, and 46C show SEM images of Sample 1-1, Sample 11, and Sample 10, respectively. In the SEM images in FIGS. 46A to 46C, a region to be subjected to the subsequent image analysis is framed. The area of the target region was 4 μm x 4 μm in all the positive electrode active materials. The target region was set horizontal as an SEM observation surface.

FIGS. 46A and 46B show the positive electrode active materials on which the initial heating was performed. It was found that these positive electrode materials had little surface unevenness as compared to the positive electrode material in FIG. 46C on which the initial heating was not performed. Moreover, it was also found that the number of foreign matters attached to a surface, which might cause unevenness, was small. In addition, Sample 1-1 and Sample 11 in FIGS. 46A and 46B seem to have rounded corners. It can be thus understood that the samples on which the initial heating has been performed have smooth surfaces. Sample 1-1, which was formed by adding the added element after the initial heating, was found to maintain the surface smoothness achieved by the initial heating.

It can be thus understood that the positive electrode active materials on which the initial heating has been performed have smooth surfaces.

Here, the present inventors noticed that the taken images of the surface states of the positive electrode active materials in FIGS. 46A to 46C showed a variation in luminance. The present inventors considered the feasibility of quantification of information on surface unevenness by image analysis utilizing the variation in luminance.

Thus, in this example, the images shown in FIGS. 46A to 46C were analyzed using image processing software ImageJ to quantify the surface smoothness of the positive electrode active materials. Note that ImageJ is merely an example and the image processing software for this analysis is not limited to ImageJ.

First, the images shown in FIGS. 46A to 46C were converted into 8-bit images (which are referred to as grayscale images) with the use of ImageJ. The grayscale images, in which one pixel is expressed with 8 bits, include luminance (brightness information). For example, in an 8-bit grayscale image, luminance can be represented by 2⁸=256 gradation levels. A dark portion has a low gradation level and a bright portion has a high gradation level. The variation in luminance was quantified in relation to the number of gradation levels. The value obtained by the quantification is referred to as a grayscale value. By obtaining such a grayscale value, the unevenness of the positive electrode active materials can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the above manner, 8-bit grayscale images were obtained from the images of Sample 1-1, Sample 11, and Sample 10, and grayscale values and luminance histograms were also obtained.

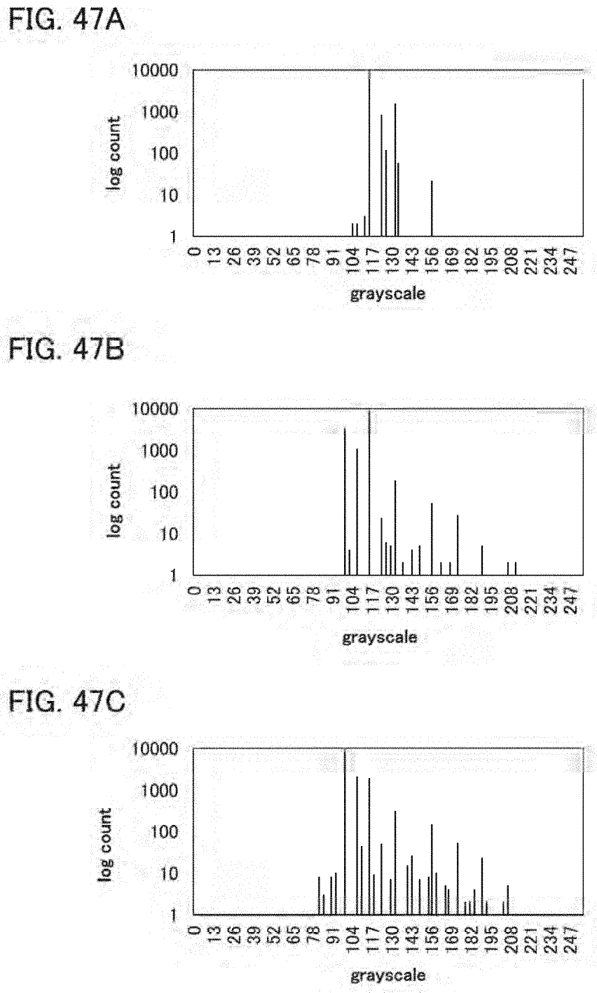

FIGS. 47A to 47C show grayscale values of Sample 1-1, Sample 11, and Sample 10. The x-axis represents the grayscale value, whereas the y-axis represents the count number. The count number is a value corresponding to the proportion of the grayscale value on the x-axis. The count number is on a logarithmic scale.

As described above, the grayscale value relates to surface unevenness. Thus, the grayscale values suggested that the descending order of the surface flatness of the positive electrode active materials was as follows: Sample 1-1, Sample 11, and Sample 10. It was found that Sample 1-1 on which the initial heating was performed had the smoothest surface. It was also found that Sample 11 on which the initial heating was performed had a smoother surface than Sample 10 on which the initial heating was not performed.

The range from the minimum grayscale value to the maximum grayscale value in each sample can be found out. The maximum value and the minimum value of Sample 1-1 are 206 and 96, respectively; the maximum value and the minimum value of Sample 11 are 206 and 82, respectively; and the maximum value and the minimum value of Sample 10 are 211 and 99, respectively.

Sample 1-1 has the smallest difference between the maximum value and the minimum value, which means a small height difference in surface unevenness. Sample 11 was found to have a small height difference in surface unevenness as compared to Sample 10. The height differences in surface unevenness of Samples 1-1 and 11 is small and it can be understood that performing the initial heating makes the surface smooth.

Furthermore, a standard deviation of the grayscale values was evaluated. The standard deviation, which is a measure of a variation in data, is small when a variation in the grayscale values is small. Since the grayscale values presumably correspond to unevenness, a small variation in the grayscale values means a small variation in unevenness, or flatness. The standard deviation of Sample 1-1 was 5.816, that of Sample 11 was 7.218, and that of Sample 10 was 11.514. The standard deviations suggested that the ascending order of the variation in surface unevenness of the positive electrode active materials was as follows: Sample 1-1, Sample 11, and Sample 10. Sample 1-1 on which the initial heating was performed was found to have a small variation in surface unevenness and have a smooth surface. It was also shown that Sample 11 on which the initial heating was performed had a smaller variation in surface unevenness and a smoother surface than Sample 10 on which the initial heating was not performed.

Table 3 below lists the minimum value, the maximum value, the difference between the maximum value and the minimum value (the maximum value−the minimum value), and the standard deviation.

TABLE 3

| | | | Maximum | | |
|---|---|---|---|---|---|
| | | | value- | | |
| | Minimum | Maximum | minimum | Standard | Initial |
| | value | value | value | deviation | heating |
| Sample 1-1 | 99 | 173 | 74 | 5.816 | Performed |
| Sample 11 | 99 | 211 | 112 | 7.218 | Performed |
| Sample 10 | 82 | 206 | 124 | 11.514 | Not performed |

The above results show that in Sample 1-1 and Sample 11 having smooth surfaces, the difference between the maximum grayscale value and the minimum grayscale value is less than or equal to 120. This difference is preferably less than or equal to 115, further preferably greater than or equal to 70 and less than or equal to 115. The results also show that the standard deviation of the grayscale values is less than or equal to 11 in of Sample 1-1 and Sample 11 having smooth surfaces. The standard deviation is preferably less than or equal to 8.

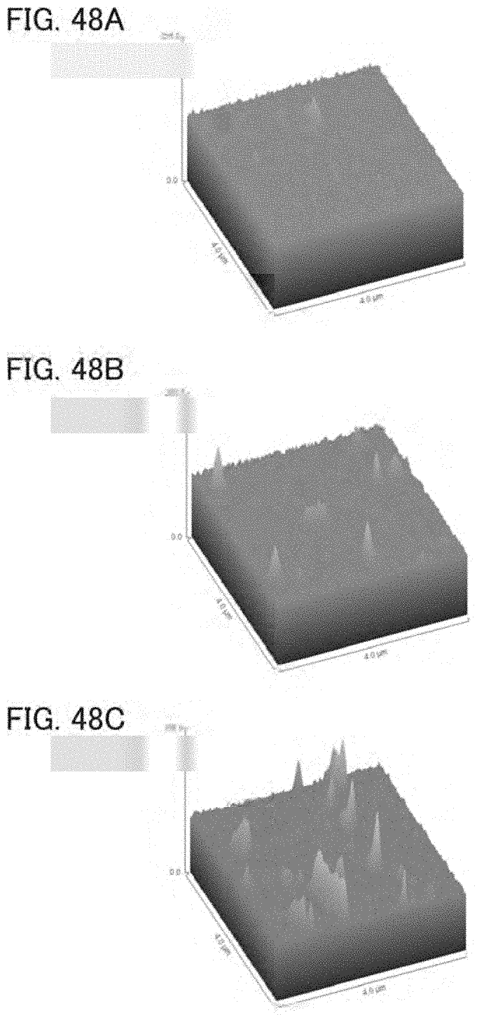

FIGS. 48A to 48C show luminance histograms of Sample 1-1, Sample 11, and Sample 10.

A luminance histogram can three-dimensionally express unevenness based on the grayscale values with a target range represented as a flat plane. Unevenness of a positive electrode active material can be more easily determined with a luminance histogram than by direct observation of the unevenness. The luminance histograms in FIGS. 48A to 48C suggested that the descending order of the surface flatness of the positive electrode active materials was as follows: Sample 1-1, Sample 11, and Sample 10. It was found that Sample 1-1 on which the initial heating was performed had the smoothest surface. It was also found that Sample 11 on which the initial heating was performed had a smoother surface than Sample 10 on which the initial heating was not performed.

Eight samples were formed under the same conditions as each of Sample 1-1, Sample 11, and Sample 10 and were subjected to image analysis in a manner similar to that in this example. The examination of the eight samples showed that these samples had a tendency similar to Sample 1-1, Sample 11, and Sample 10.

Such image analysis enables quantitative determination of smoothness. It was found that the positive electrode active material on which the initial heating has been performed has a smooth surface with little unevenness.

### <Charge and Discharge Cycle Performance of Half Cell>

In this example, half cells were fabricated using the positive electrode active materials of embodiments of the present invention and their cycle performance was evaluated. The performance of the positive electrode alone was clarified by the evaluation of the cycle performance of the half cell.

First, the half cells were fabricated using Sample 1-1 and Sample 1-2 as the positive electrode active materials. The conditions of the half cells are described below.

The positive electrode active material, acetylene black (AB) as a conductive material, and polyvinylidene fluoride (PVDF) as a binder were prepared and mixed at a weight ratio of 95:3:2 to form a slurry, and the slurry was applied to an aluminum current collector. As a solvent of the slurry, NMP was used.

After the slurry was applied to the current collector, the solvent was volatilized. Through the above steps, the positive electrode of each half cell was obtained. In each positive electrode, the loading level of the active material was approximately 7 mg/cm².

As an electrolyte solution, a mixture of ethylene carbonate (EC) and diethyl carbonate (DEC) at a volume ratio of 3:7 to which vinylene carbonate (VC) was added as an additive at 2 wt % was used. As an electrolyte contained in the electrolyte solution, 1 mol/L lithium hexafluorophosphate (LiPF₆) was used. As a separator, polypropylene was used.

A lithium metal was prepared as a counter electrode. Thus, coin-type half cells including the above positive electrodes and the like were fabricated. Their cycle performance was measured.

A discharge rate and a charge rate as cycle conditions are described. The discharge rate refers to the relative ratio of a current in discharge to the battery capacity and is expressed in a unit C. A current of approximately 1 C in a battery with a rated capacity X (Ah) is X A. The case where discharge is performed at a current of 2X A is rephrased as follows: discharge is performed at 2 C. The case where discharge is performed at a current of X/5 A is rephrased as follows: discharge is performed at 0.2 C. Similarly, for the charge rate, the case where charge is performed at a current of 2X A is rephrased as follows: charge is performed at 2 C, and the case where charge is performed at a current of X/5 A is rephrased as follows: charge is performed at 0.2 C.

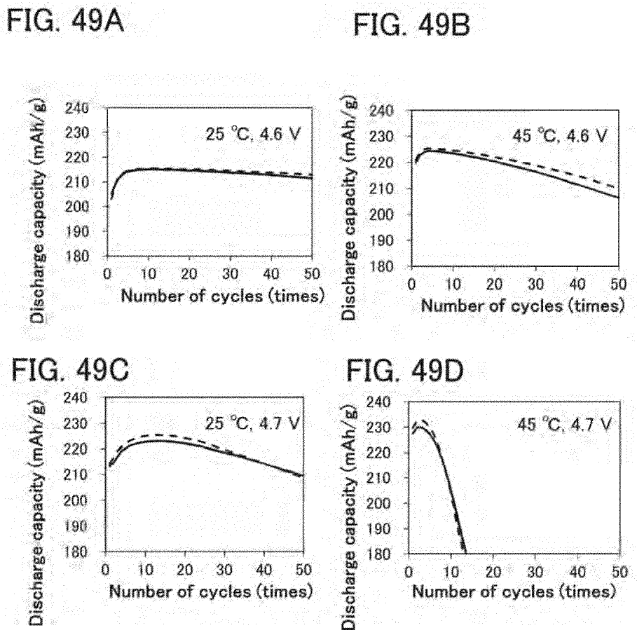

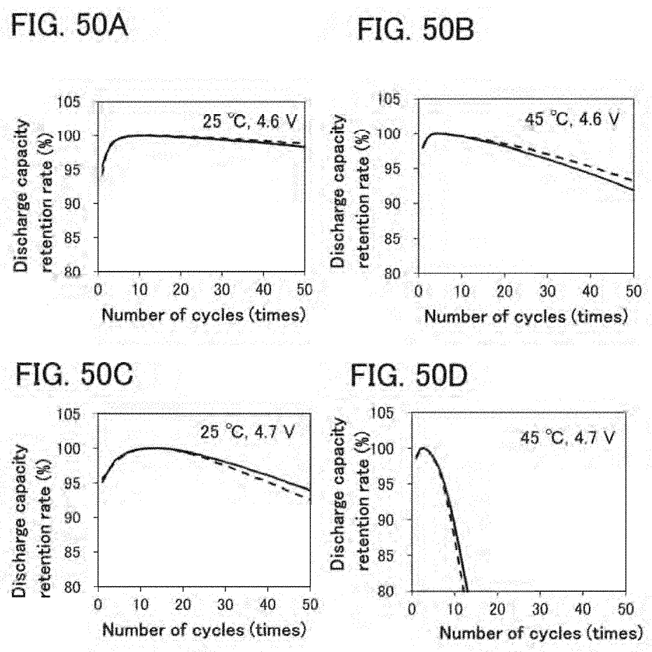

FIGS. 49A to 49D and FIGS. 50A to 50D show the cycle performance.

FIGS. 49A to 49D show the cycle performance in charge and discharge cycles each including CC/CV charge (0.5 C, 4.6 V or 4.7 V, 0.05 C cut) and CC discharge (0.5 C, 2.5 V cut), with a 10-minute break between the cycles. Note that 1 C=200 mA/g, and the measurement temperature was 25° C. or 45° C.

A set of charge and discharge is one cycle in this specification and the like, and when the number of cycles was 50, the discharge capacity retention rate (%) in the 50th cycle was calculated by (the discharge capacity in the 50th cycle/the maximum value of the discharge capacity in the 50 cycles)×100. That is, a test in which 50 cycles of charge and discharge were performed was conducted, the discharge capacity in each cycle was measured, and the ratio of the value of the discharge capacity measured in the 50th cycle to the maximum value of the discharge capacity in the 50 cycles (the maximum discharge capacity) was calculated. A higher discharge capacity retention rate enables a smaller reduction in battery capacity after repeated charge and discharge, which means favorable battery characteristics.

In measurement for charge and discharge, a battery voltage and a current flowing in a battery are preferably measured by a four-terminal method. In charge, electrons flow from a positive electrode terminal to a negative electrode terminal through a charge-discharge measuring instrument and thus, a charge current flows from the negative electrode terminal to the positive electrode terminal through the charge-discharge measuring instrument. In discharge, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and discharge current are measured with an ammeter of the charge-discharge measuring instrument, the total amount of the current flowing during one charge and the total amount of the current flowing during one discharge are respectively charge capacity and discharge capacity. For example, the total amount of the discharge current flowing during the discharge in the first cycle can be regarded as the discharge capacity in the first cycle, and the total amount of the discharge current flowing during the discharge in the 50th cycle can be regarded as the discharge capacity in the 50th cycle.

FIG. 49A shows the results when the charge and discharge voltage was 4.6 V and the measurement temperature was 25° C., FIG. 49B shows the results when the charge and discharge voltage was 4.6 V and the measurement temperature was 45° C., FIG. 49C shows the results when the charge and discharge voltage was 4.7 V and the measurement temperature was 25° C., and FIG. 49D shows the results when the charge and discharge voltage was 4.7 V and the measurement temperature was 45° C. Each graph shows a change in discharge capacity as a function of the number of cycles. The horizontal axis represents the number of cycles and the vertical axis represents discharge capacity (mAh/g) in each graph. The solid line denotes the results of Sample 1-1 and the dashed line denotes the results of Sample 1-2.

FIGS. 50A to 50D show discharge capacity retention rates which correspond to FIGS. 49A to 49D. FIG. 50A shows the results when the charge and discharge voltage was 4.6 V and the measurement temperature was 25° C., FIG. 50B shows the results when the charge and discharge voltage was 4.6 V and the measurement temperature was 45° C., FIG. 50C shows the results when the charge and discharge voltage was 4.7 V and the measurement temperature was 25° C., and FIG. 50D shows the results when the charge and discharge voltage was 4.7 V and the measurement temperature was 45° C. Each graph shows a change in discharge capacity retention rate as a function of the number of cycles. The horizontal axis represents the number of cycles and the vertical axis represents discharge capacity retention rate (%) in each graph. The solid line denotes the results of Sample 1-1 and the dashed line denotes the results of Sample 1-2.

The discharge capacities and discharge capacity retention rates of Sample 1-1 and Sample 1-2 at a charge and discharge voltage of 4.6 V and those at a charge and discharge voltage of 4.7 V were higher at a measurement temperature of 25° C. than at a measurement temperature of 45° C. The cycle performance of the half cells including Sample 1-1 and Sample 1-2 showed that the positive electrode active material of the present invention has excellent cycle performance regardless of the heating time of the initial heating. In other words, the initial heating for longer than or equal to 2 hours and shorter than or equal to 10 hours probably improves the cycle performance, indicating that the effect of the initial heating can be achieved even when the heating time is longer than or equal to 2 hours, which is relatively short.

The maximum discharge capacity of Sample 1-1 was 215.0 mAh/g when the measurement temperature was 25° C. and the charge and discharge voltage was 4.6 V, and the maximum discharge capacity of Sample 1-1 was 222.5 mAh/g when the measurement temperature was 25° C. and the charge and discharge voltage was 4.7 V.

The discharge capacity retention rates of Sample 1-1 and Sample 1-2 at a measurement temperature of 45° C. were higher at a charge and discharge voltage of 4.6 V than at a charge and discharge voltage of 4.7 V. The cycle performance of the half cells including Sample 1-1 and Sample 1-2 showed that the positive electrode active material of the present invention has excellent cycle performance regardless of the heating time of the initial heating. In other words, it was shown that the initial heating for longer than or equal to 2 hours and shorter than or equal to 10 hours improves the cycle performance and the effect of the initial heating can be achieved even when the heating time is short.

The discharge capacity is discussed in detail. For example, the discharge capacity of Sample 1-1 at a charge and discharge voltage of 4.6 V and a measurement temperature of 25° C. was found to be higher than or equal to 200 mAh/g and lower than or equal to 220 mAh/g. In this manner, the values and ranges of the discharge capacity can be read from FIGS. 49A to 49D.

The discharge capacity retention rate is discussed in detail. For example, the discharge capacity retention rate of Sample 1-1 at a charge and discharge voltage of 4.6 V and a measurement temperature of 25° C. was found to be higher than or equal to 94%. In this manner, the values and ranges of the discharge capacity retention rate can be read from FIGS. 50A to 50D.

Samples 1-1 and 1-3 to 1-5 formed as described above were used as positive electrode active materials to fabricate half cells. The conditions of the half cells are as described above. The charge and discharge characteristics of the half cells were measured.

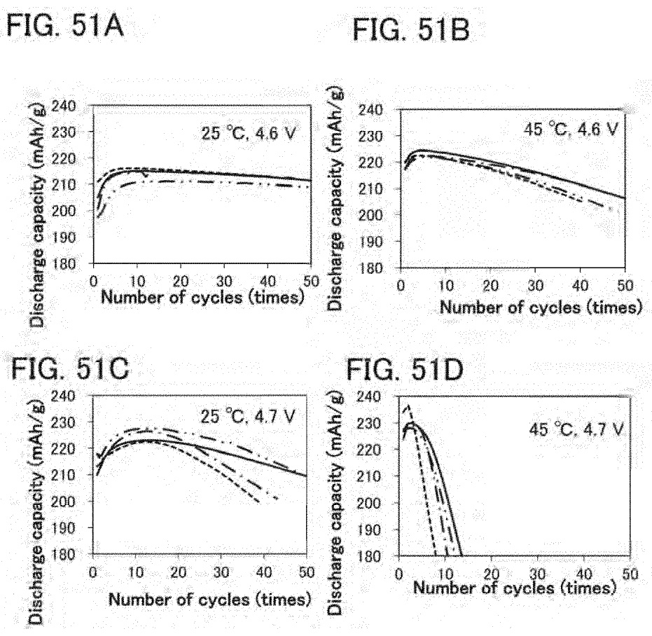

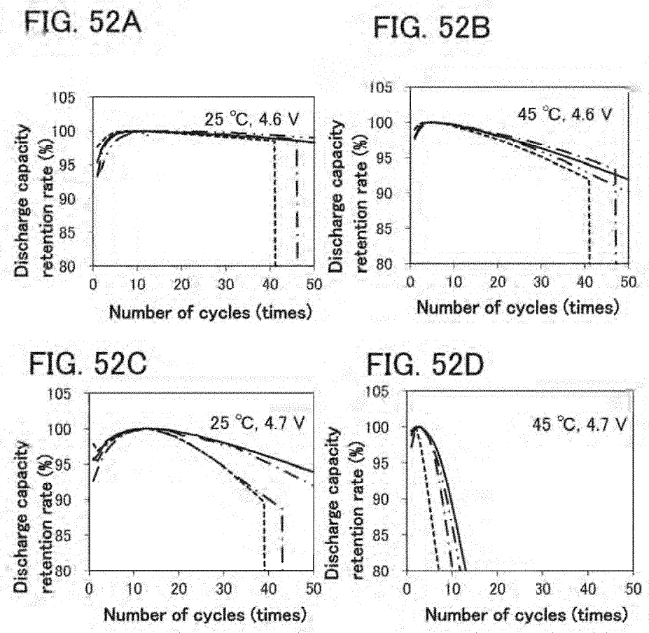

FIGS. 51A to 51D and FIGS. 52A to 52D show the cycle performance.

FIGS. 51A to 51D show the cycle performance when charge and discharge were performed at a charge rate of 0.5 C (1 C=200 mA/g) and a discharge rate of 0.5 C. FIG. 51A shows the results when the charge and discharge voltage was 4.6 V and the measurement temperature was 25° C., FIG. 51B shows the results when the charge and discharge voltage was 4.6 V and the measurement temperature was 45° C., FIG. 51C shows the results when the charge and discharge voltage was 4.7 V and the measurement temperature was 25° C., and FIG. 51D shows the results when the charge and discharge voltage was 4.7 V and the measurement temperature was 45° C. Each graph shows a change in discharge capacity as a function of the number of cycles. The horizontal axis represents the number of cycles and the vertical axis represents discharge capacity (mAh/g) in each graph. The solid line denotes the results of Sample 1-1, the dashed-two dotted line denotes the results of Sample 1-3, the dashed-dotted line denotes the results of Sample 1-4, and the dashed line denotes the results of Sample 1-5.

FIGS. 52A to 52D show discharge capacity retention rates which correspond to FIGS. 51A to 51D. FIG. 52A shows the results when the charge and discharge voltage was 4.6 V and the measurement temperature was 25° C., FIG. 52B shows the results when the charge and discharge voltage was 4.6 V and the measurement temperature was 45° C., FIG. 52C shows the results when the charge and discharge voltage was 4.7 V and the measurement temperature was 25° C., and FIG. 52D shows the results when the charge and discharge voltage was 4.7 V and the measurement temperature was 45° C. Each graph shows a change in discharge capacity retention rate as a function of the number of cycles. The horizontal axis represents the number of cycles and the vertical axis represents discharge capacity retention rate (%) in each graph. The solid line denotes the results of Sample 1-1, the dashed-two dotted line denotes the results of Sample 1-3, the dashed-dotted line denotes the results of Sample 1-4, and the dashed line denotes the results of Sample 1-5.

The discharge capacity retention rates of Samples 1-1 and 1-3 to 1-5 at a charge and discharge voltage of 4.6 V and those at a charge and discharge voltage of 4.7 V were higher at a measurement temperature of 25° C. than at a measurement temperature of 45° C. The cycle performance of the half cells including Samples 1-1 and 1-3 to 1-5 showed that the positive electrode active material of the present invention has excellent cycle performance regardless of the heating temperature of the initial heating. In other words, the initial heating at higher than or equal to 750° C. and lower than or equal to 950° C. probably improves the cycle performance and can be effective. In comparison between the samples in which the effect of the initial heating was achieved, Sample 1-1 had more favorable cycle performance than Samples 1-3 to 1-5.

The discharge capacities and discharge capacity retention rates of Samples 1-1 and 1-3 to 1-5 at a measurement temperature of 45° C. were higher at a charge and discharge voltage of 4.6 V than at a charge and discharge voltage of 4.7 V. The cycle performance of the half cells including Samples 1-1 and 1-3 to 1-5 showed that the positive electrode active material of the present invention has excellent cycle performance regardless of the heating temperature of the initial heating. In other words, the initial heating at higher than or equal to 750° C. and lower than or equal to 950° C. probably improves the cycle performance and can be effective. In comparison between the samples in which the effect of the initial heating was achieved, Sample 1-1 had more favorable cycle performance than Samples 1-3 to 1-5.

Specific values of the discharge capacity are discussed. For example, the discharge capacity of Sample 1-1 at a charge and discharge voltage of 4.6 V and a measurement temperature of 25° C. was found to be higher than or equal to 200 mAh/g and lower than or equal to 220 mAh/g. In this manner, the values and ranges of the discharge capacity can be read from FIGS. 51A to 51D.

Specific values of the discharge capacity retention rate are discussed. For example, the discharge capacity retention rate of Sample 1-1 at a charge and discharge voltage of 4.6 V and a measurement temperature of 25° C. was found to be higher than or equal to 94%. In this manner, the values and ranges of the discharge capacity retention rate can be read from FIGS. 52A to 52D.

### <Charge and Discharge Cycle Performance of Full Cell>

Next, in this example, a full cell was fabricated using the positive electrode active material of one embodiment of the present invention and its cycle performance was evaluated. Through the evaluation of the cycle performance of the full cell, the performance of a secondary battery was clarified.

First, the full cell was fabricated using Sample 1-1 as the positive electrode active material. The conditions of the full cell were similar to the conditions of the half cells described above except that graphite was used for the negative electrode. In the negative electrode, VGCF (registered trademark), carboxymethyl cellulose (CMC), and styrene butadiene rubber (SBR) were added besides graphite. CMC was added to increase viscosity, and SBR was added as a binder. Note that mixing was performed so that graphite:VGCF:CMC:SBR=96:1:1:2 (weight ratio) to form a slurry. The slurry was applied to a copper current collector and then, the solvent was volatilized.

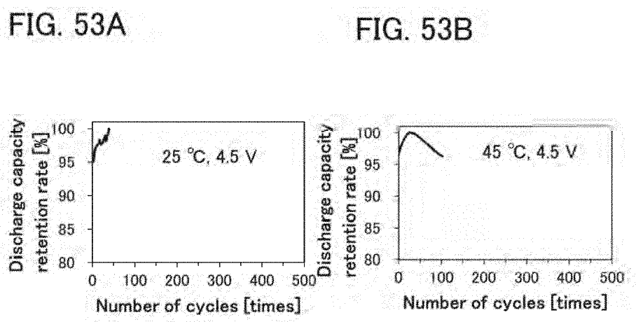

FIGS. 53A and 53B show the cycle performance.

FIG. 53A shows the discharge capacity retention rate when charge and discharge were performed at a charge rate of 0.2 C (1 C=200 mA/g), a discharge rate of 0.2 C, a charge and discharge voltage of 4.5 V, and a measurement temperature of 25° C. FIG. 53B shows the discharge capacity retention rate when charge and discharge were performed at a charge rate of 0.5 C, a discharge rate of 0.5 C, a charge and discharge voltage of 4.6 V, and a measurement temperature of 45° C. Both of the discharge capacity retention rates were high.

The maximum discharge capacity at a measurement temperature of 25° C. was 192.1 mAh/g, and the maximum discharge capacity at a measurement temperature of 45° C. was 198.5 mAh/g. The initial heating led to the high discharge capacity retention rate and the high discharge capacity.

Since graphite was used as the negative electrode of the full cell, the charge and discharge voltage was lower than that in the case of the half cell including the lithium counter electrode, by approximately 0.1 V. That is, a charge and discharge voltage of 4.5 V in the full cell is equivalent to a charge and discharge voltage of 4.6 V in the half cell.

### <Observation of the Same Portion>

Next, a surface and a surface portion in the same portion of a positive electrode active material were observed before and after the heating following the mixing of the added element.

Observation of the same portion is difficult when an ordinary formation method is employed; thus, a method was employed in which a pellet is formed, the added element is mixed, and the heating is performed. Specifically, the following process was conducted.

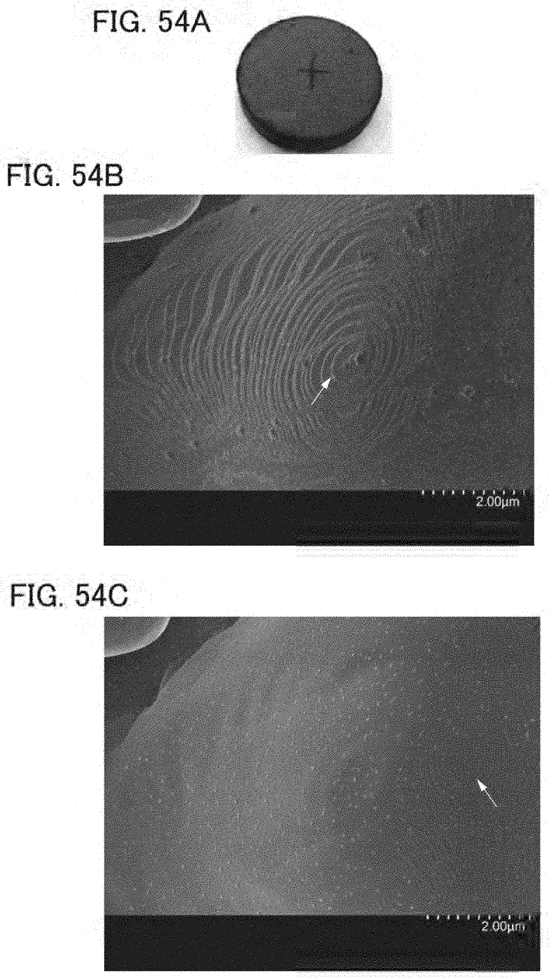

First, commercially available lithium cobalt oxide (Cellseed C-10N produced by NIPPON CHEMICAL INDUSTRIAL CO., LTD.) not containing any added element was prepared. The lithium cobalt oxide was compacted with a pellet die and molded by heating. The compacting using the pellet die was performed at 20 kN for 5 minutes. The heating was performed at 900° C. for 10 hours at an oxygen flow rate of 5 L/min. This heating doubled as the initial heating. Thus, an LCO-containing pellet (hereinafter referred to as an LCO pellet) with a diameter of 10 mm and a thickness of 2 mm shown in FIG. 54A was obtained. The pellet was marked for easy recognition of the observation portion.

The LCO pellet was observed with a SEM. FIG. 54B shows a SEM image. Although the heating for forming a pellet was performed, minute steps on the surface were observed. The steps look like stripes. The arrow in the image denotes part of the step.

Then, LiF and MgF₂ as added element sources were mixed into the LCO pellet. Both surfaces of the LCO pellet were covered with a mixture of LiF and MgF₂ at a molar ratio of 1:3. Heating was performed at 900° C. for 20 hours in a muffle furnace. No flowing was performed after the muffle furnace was filled with an oxygen atmosphere. In this manner, Sample 3 was formed. The formation conditions of Sample 3 are shown in Table 4.

TABLE 4

| | Formation conditions | | | |
|---|---|---|---|---|
| | | Initial heating | | |
| | | (heating for | Added | |
| | | forming pellet) | element | Heating |
| | LiM/O₂ | ° C. (hour) | source | ° C. (hour) |
| Sample 3 | LiCoO₂ | 900 (10) | LiF MgF₂ | 900 (20) |

FIG. 54C shows a SEM image taken after the mixing of the added element and the heating. FIG. 54C shows the same portion as FIG. 54B. The stripe-like steps seen in FIG. 54B disappeared and smoothness was seen. On the other hand, a step was newly generated at a different position. This step was smaller than the step seen in FIG. 54B. The arrow in the image denotes part of the newly generated step.

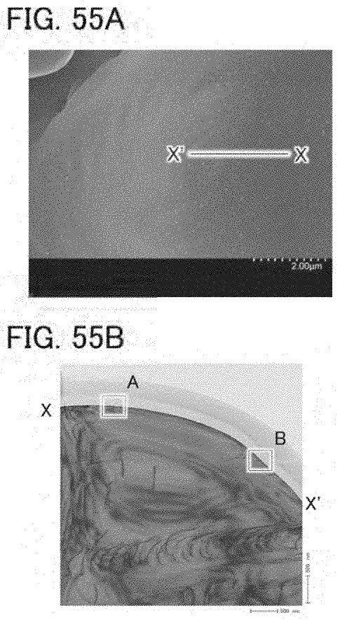

Next, Sample 3 was subjected to cross-sectional STEM-EDX measurement. In FIG. 55A, the line X-X′ denotes a portion subjected to processing for taking out a cross section. In this cross section, there are both the portion which had included the stripe-like step before the heating but became smooth and the portion of the new step.

FIG. 55B shows a cross-sectional STEM image at the line X-X′. The portion denoted by the frame with A in FIG. 55B substantially corresponds to the portion where the new step was generated. In this portion, a depression of the surface can be seen, and this depression was probably observed as the new step. The portion denoted by the frame with B in FIG. 55B substantially corresponds to the portion where the stripe-like step was smoothened. A substantially flat surface can be observed.

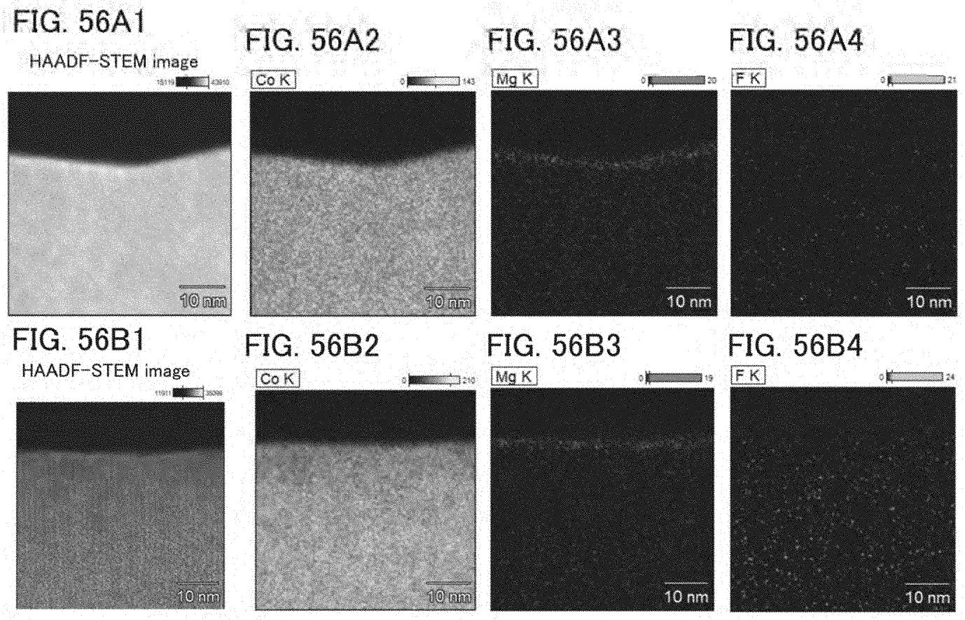

FIG. 56A1 shows a higher magnification HAADF-STEM image of the portion in and near the frame with A in FIG. 55B. From FIG. 56A1, it was found that a step, i.e., the difference in height between a depression and a projection in a cross-sectional view, is less than or equal to 10 nm, preferably less than or equal to 3 nm, further preferably less than or equal to 1 nm. FIG. 56B1 shows a higher magnification HAADF-STEM image of the portion in and near the frame with B in FIG. 55B. From FIG. 56B1, it was found that a step, i.e., the difference in height between a depression and a projection in a cross-sectional view, is less than or equal to 1 nm.

FIG. 56A2 shows a mapping image of cobalt in the same region as FIG. 56A1, FIG. 56A3 shows a mapping image of magnesium in the same region as FIG. 56A1, and FIG. 56A4 shows a mapping image of fluorine in the same region as FIG. 56A1. In a similar manner, FIG. 56B2 shows a mapping image of cobalt in the same region as FIG. 56B1, FIG. 56B3 shows a mapping image of magnesium in the same region as FIG. 56B1, and FIG. 56B4 shows a mapping image of fluorine in the same region as FIG. 56B1.

In each region, uneven distribution of magnesium in the surface portion was observed. Magnesium was distributed having a substantially uniform thickness along the surface shape. The concentration of fluorine was below a quantitative lower limit in each region.

Since magnesium was distributed along the surface shape of the LCO in each region, it was suggested that the stripe-like steps which had existed before the heating disappeared as a result of melting of the LCO and moving of Co and the surface of the LCO was thus smoothened.

### Example 2

In this example, the positive electrode active material 100 of one embodiment of the present invention was formed and a dQ/dVvsV curve of its charge curve and the crystal structure after charge were analyzed.

### <Formation of Positive Electrode Active Material and Half Cell>

Positive electrode active materials similar to Sample 1-1 in Example 1 on which the initial heating was performed, Sample 2 on which the initial heating was not performed, and Sample 10 as a reference were formed, and half cells were formed using these materials. At the time of formation of the positive electrodes, pressing was not performed.

<Charging dQ/dVvsV>

The thus formed half cells were each charged to obtain a charge curve, and a dQ/dVvsV curve was calculated from the charge curve. Specifically, voltage (V) and charge capacity (Q), which changed over time, were obtained from a charge and discharge control device, and a difference in voltage and a difference in charge capacity were calculated. To minimize the adverse effects of minute noise, the moving average for 500 class intervals was calculated for the difference in voltage and the difference in charge capacity. The moving average of the difference in charge capacity was differentiated with the moving average of the difference in voltage (dQ/dV). The results were graphed with the horizontal axis representing the voltage to produce a dQ/dVvsV curve.

The measurement temperature was 25° C. and charge to 4.9 V at 10 mA/g was performed. Note that only at the time of the first charge, discharge to 2.5 V at 0.5 C was performed before measurement of dQ/dV was started.

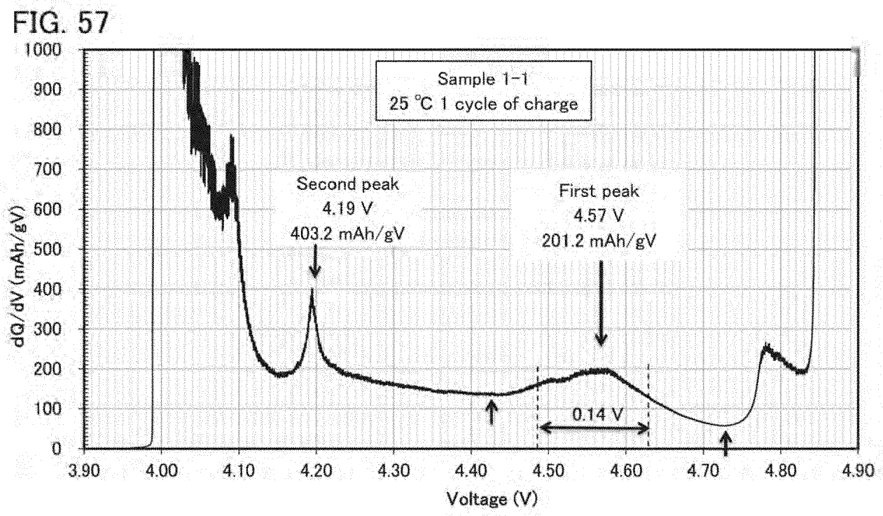

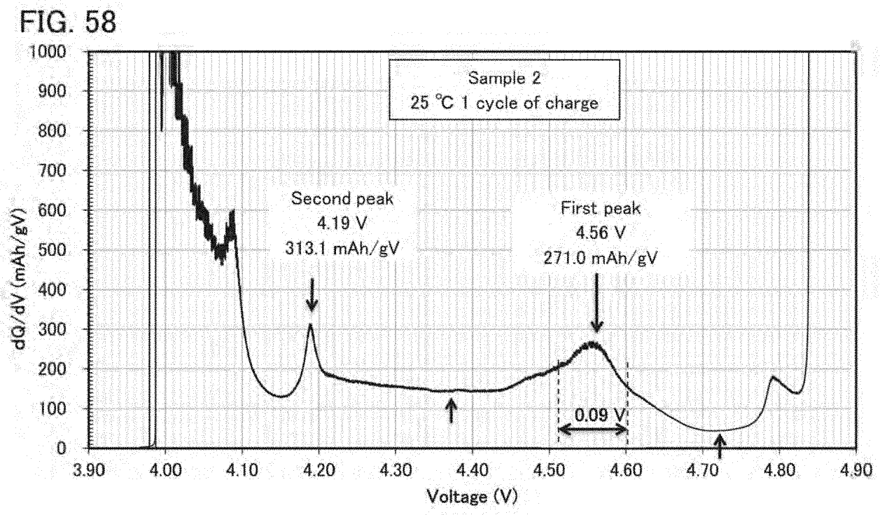

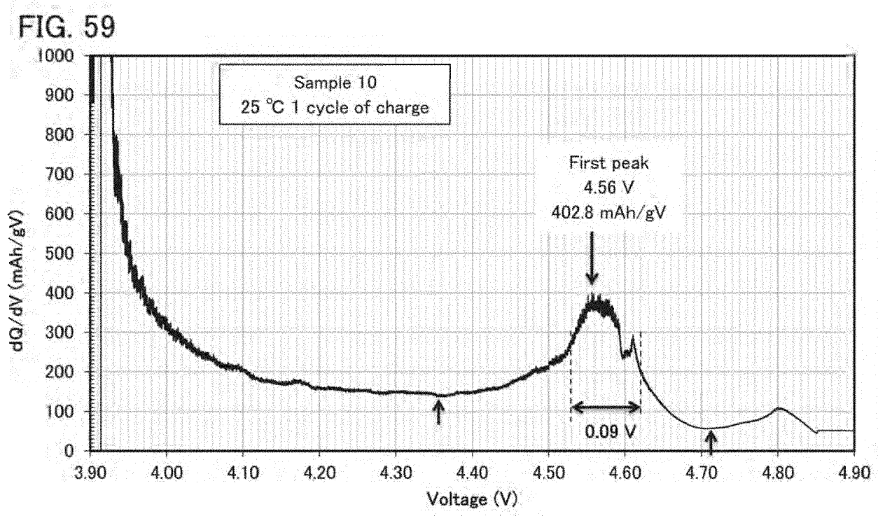

FIG. 57 shows a dQ/dVvsV curve of Sample 1-1, FIG. 58 shows that of Sample 2, and FIG. 59 shows that of Sample 10. Each curve was obtained in the first charge after the half cell was formed.

As shown in FIG. 57, the dQ/dVvsV curve of Sample 1-1 on which the initial heating was performed has a broad peak at around 4.55 V. Specifically, the maximum value in the range of 4.5 V to 4.6 V is 201.2 mAh/gV at 4.57 V. This is regarded as the first peak. The minimum value in the range of 4.3 V to 4.5 V is 130.7 mAh/gV at 4.43 V, which is regarded as the first minimum value. The minimum value in the range of 4.6 V to 4.8 V is 56.6 mAh/gV at 4.73 V, which is regarded as the second minimum value.

The first minimum value and the second minimum value are denoted by upward arrows in the graph.

An average value HWHM₁ of the first peak and the first minimum value is 166.7 mAh/gV at 4.49 V. An average value HWHM₂ of the first peak and the second minimum value is 128.3 mAh/gV at 4.63 V. The HWHM₁ and HWHM₂ are denoted by dotted lines in the graph. Accordingly, the difference between the HWHM₁ and HWHM₂, i.e., the full width at half maximum of the first peak in this specification and the like, is 0.14 V, which is greater than 0.10 V.

There is also a sharp peak at around 4.2 V. Specifically, the maximum value in the range of 4.15 V to 4.25 V is 403.2 mAh/gV at 4.19 V. This is regarded as the second peak. The first peak/the second peak is 0.50, which is less than 0.8.

Meanwhile, as shown in FIG. 58, the peak at around 4.55 V in the dQ/dVvsV curve of Sample 2 on which the initial heating was not performed is sharper than that in the dQ/dVvsV curve of Sample 1-1. Specifically, the maximum value in the range of 4.5 V to 4.6 V is 271.0 mAh/gV at 4.56 V. This is regarded as the first peak. The minimum value in the range of 4.3 V to 4.5 V is 141.1 mAh/gV at 4.37 V, which is regarded as the first minimum value. The minimum value in the range of 4.6 V to 4.8 V is 43.5 mAh/gV at 4.72 V, which is regarded as the second minimum value.

The average value HWHM₁ of the first peak and the first minimum value is 206.4 mAh/gV at 4.51 V. The average value HWHM₂ of the first peak and the second minimum value is 157.7 mAh/gV at 4.60 V. The difference between the HWHM₁ and HWHM₂, i.e., the full width at half maximum of the first peak, is 0.09 V, which is less than 0.10 V.

There is also a sharp peak at around 4.2 V. Specifically, the maximum value in the range of 4.15 V to 4.25 V is 313.1 mAh/gV at 4.19 V. This is regarded as the second peak. The first peak/the second peak is 0.87, which is greater than 0.8.

As shown in FIG. 59, the peak at around 4.55 V in the dQ/dVvsV curve of Sample 10 not containing any added element is also sharper than that in the dQ/dVvsV curve of Sample 1-1. Specifically, the maximum value in the range of 4.5 V to 4.6 V is 402.8 mAh/gV at 4.56 V. This is regarded as the first peak. The minimum value in the range of 4.3 V to 4.5 V is 136.2 mAh/gV at 4.36 V, which is regarded as the first minimum value. The minimum value in the range of 4.6 V to 4.8 V is 55.9 mAh/gV at 4.71 V, which is regarded as the second minimum value.

The average value HWHM₁ of the first peak and the first minimum value is 271.0 mAh/gV at 4.53 V. The average value HWHM₂ of the first peak and the second minimum value is 223.2 mAh/gV at 4.62 V. The difference between the HWHM₁ and HWHM₂, i.e., the full width at half maximum of the first peak, is 0.09 V, which is also less than 0.10 V.

As described above, the full width at half maximum of the first peak at around 4.55 V of Sample 1-1 on which the initial heating was performed is greater than 0.10 V, which means that the first peak is sufficiently broad. This indicates that a change in the energy necessary for extraction of lithium at around 4.55 V is small and a change in the crystal structure is small. Accordingly, the positive electrode active material hardly suffers a shift in CoO₂ layers and a volume change and is relatively stable even when the charge depth is large.

### <XRD>

Next, XRD measurement was performed after charge of half cells including Sample 1-1 and Sample 2, which were fabricated as in Example 1.

In the first charge, the charge voltage was 4.5 V, 4.55 V, 4.6 V, 4.7 V, 4.75 V, or 4.8 V. The charge temperature was 25° C. or 45° C. The charge method was CC charge (10 mA/g, each voltage).

For the fifth charge, first, four cycles of charge and discharge were performed, where the charge was CCCV charge (100 mA/g, 4.7 V, 10 mA/gcut), the discharge was CC discharge (2.5 V, 100 mA/gcut), and a 10-minute break was taken between the cycles; then, as the fifth charge, CC charge (10 mA/g, each voltage) was performed.

For the 15th charge or the 50th charge, similarly, 14 cycles of charge and discharge or 49 cycles of charge and discharge were performed, where the charge was CCCV charge (100 mA/g, 4.7 V, 10 mA/gcut), the discharge was CC discharge (2.5 V, 100 mA/gcut), and a 10-minute break was taken between the cycles; then, CC charge (10 mA/g, each voltage) was performed.

Immediately after completion of the charge, each half cell in a charged state was disassembled in a glove box with an argon atmosphere to take out the positive electrode, and the positive electrode was washed with dimethyl carbonate (DMC) to remove the electrolyte solution. The positive electrode taken out was attached to a flat substrate with a double-sided adhesive tape and sealed in a dedicated cell in an argon atmosphere. The position of the positive electrode active material layer was adjusted to the measurement plane required by the apparatus. The XRD measurement was performed at room temperature irrespective of the charge temperature.

The apparatus and conditions adopted in the XRD measurement were as follows.

XRD apparatus: D8 ADVANCE produced by Bruker AXS
X-ray source: CuKα₁ radiation

### Output: 40 kV, 40 mA

Slit system: Div. Slit, 0.5°

### Detector: LynxEye

Scanning method: 2θ/θ continuous scanning
Measurement range (2θ): from 15° to 75°
Step width (2θ): 0.01°
Counting time: 1 second/step
Rotation of sample stage: 15 rpm

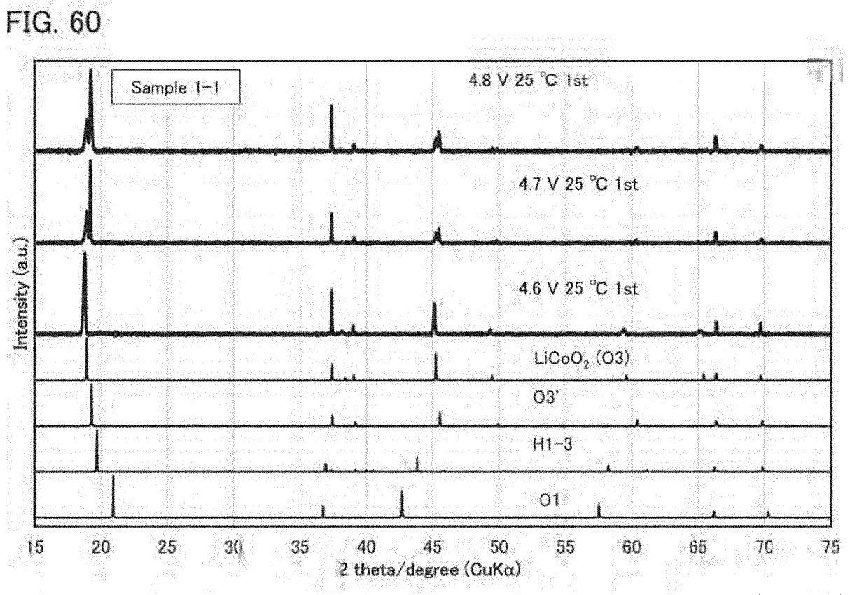

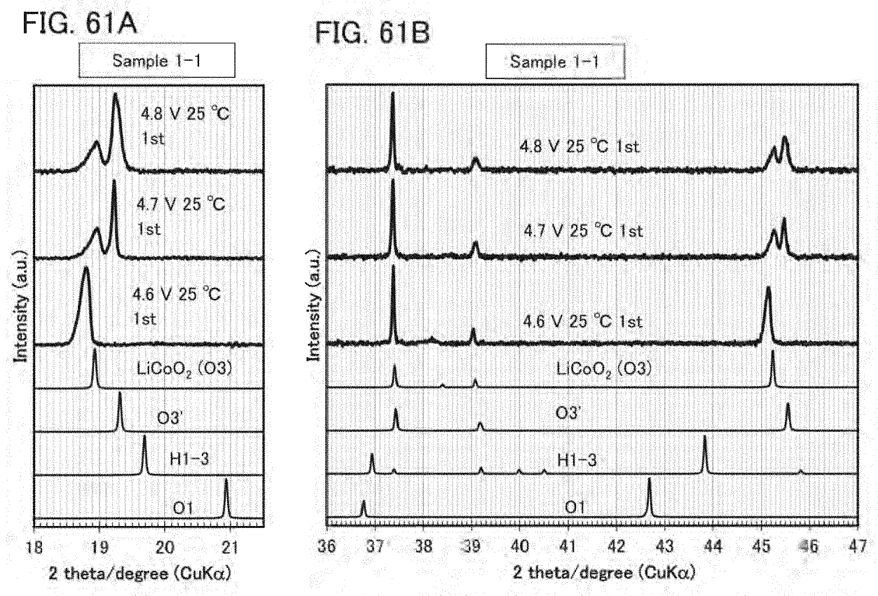

FIG. 60 shows XRD patterns of Sample 1-1 after the first charge at 25° C. and different charge voltages. FIG. 61A shows enlarged patterns in the range of 18°≤2θ≤21.5°, and FIG. 61B shows enlarged patterns in the range of 36°≤2θ≤47°. XRD patterns of P1, H1-3, O3′, and LiCoO₂ (O3) are also shown as references.

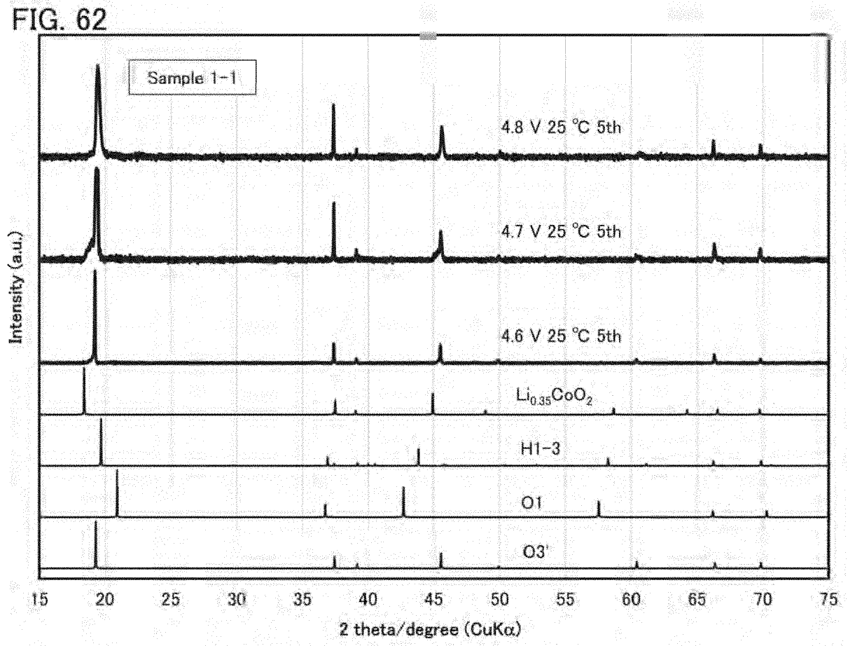

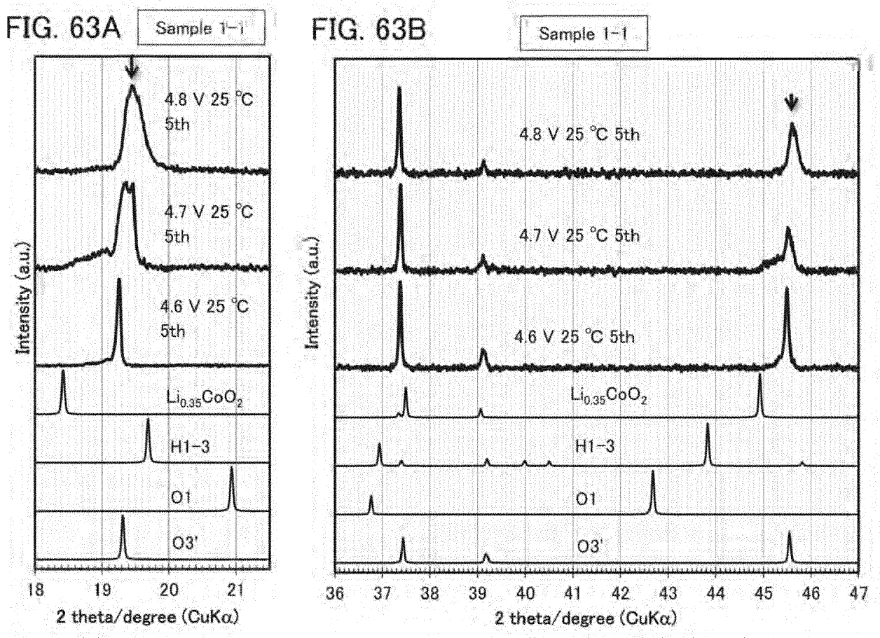

FIG. 62 shows XRD patterns of Sample 1-1 after the fifth charge at 25° C. and different charge voltages. FIG. 63A shows enlarged patterns in the range of 18°≤2θ≤21.5°, and FIG. 63B shows enlarged patterns in the range of 36°≤2θ≤47°. XRD patterns of O3′, O1, H1-3, and Li_{0.35}CoO₂ are also shown as references.

It was shown from FIG. 60, FIGS. 61A and 61B, FIG. 62, and FIGS. 63A and 63B that in the case where the charge temperature was 25° C. and the charge voltage was 4.6 V, the sample had the O3′ type structure after the fifth charge. It was suggested that in the case where the charge voltage was 4.7 V, the O3′ type structure appeared after the first charge and the sample had the O3″ type structure exhibiting peaks at 2θ of 19.47±0.10° and 2θ of 45.62±0.05° as well as the O3′ type structure after the fifth charge. It was suggested that in the case where the charge voltage was 4.8 V, the O3′ type structure appeared after the first charge and the sample had mainly the O3″ type structure after the fifth charge. In FIGS. 63A and 63B, the peak at 2θ of 19.47±0.10° and the peak at 2θ of 45.62±0.05° are denoted by arrows.

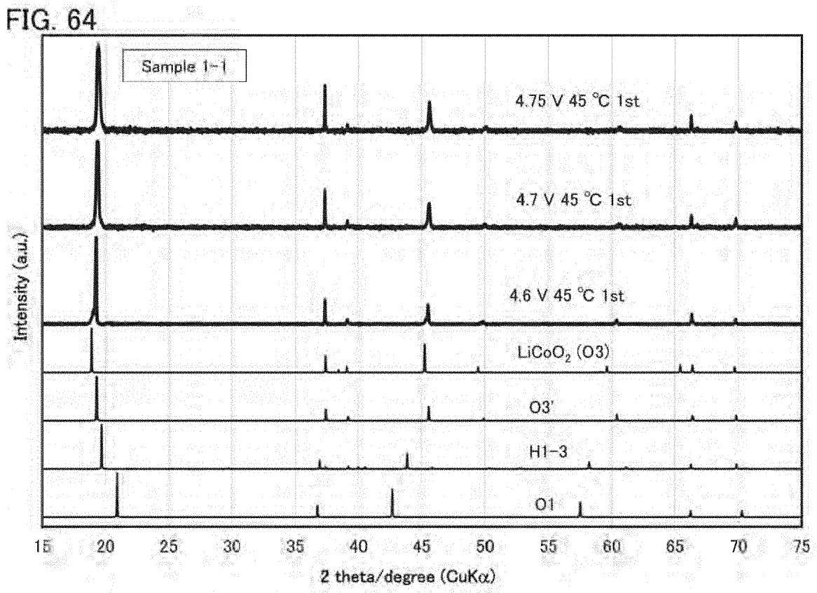

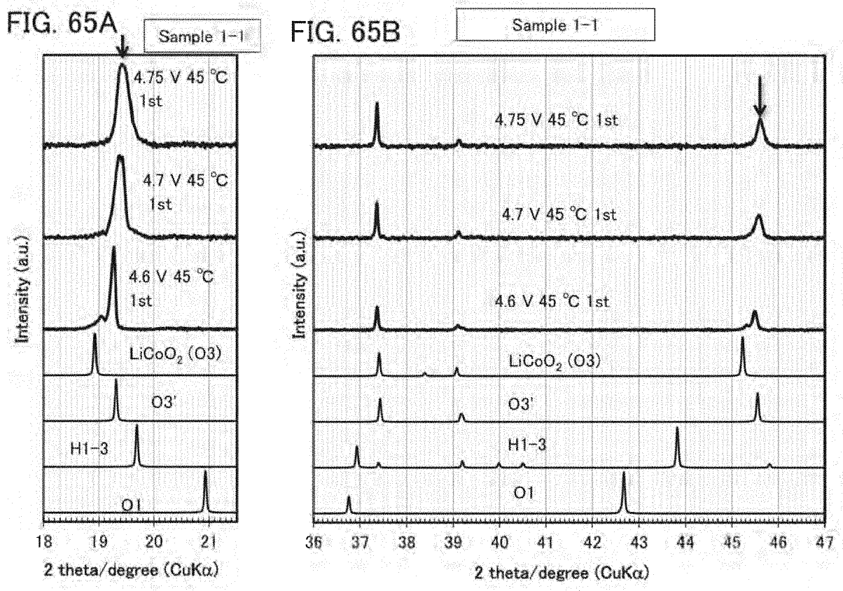

FIG. 64 shows XRD patterns of Sample 1-1 after the first charge at 45° C. and different charge voltages. FIG. 65A shows enlarged patterns in the range of 18°≤2θ≤21.5°, and FIG. 65B shows enlarged patterns in the range of 36°≤2θ≤47°. XRD patterns of O1, H1-3, O3′, and LiCoO₂ (O3) are also shown as references.

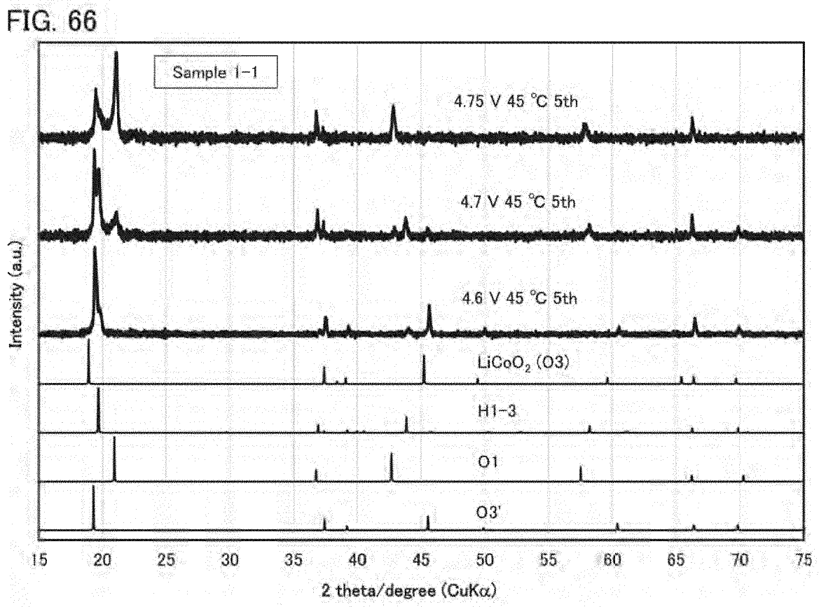

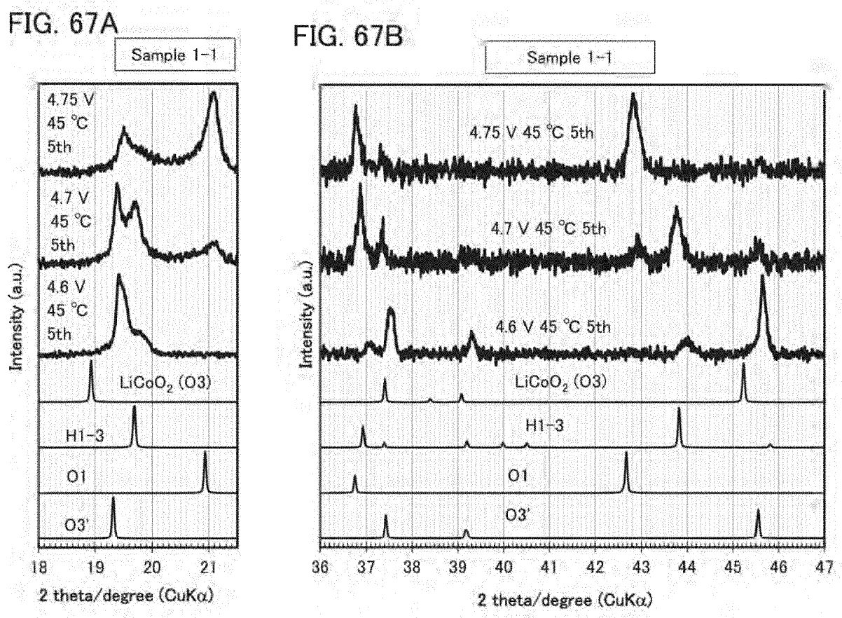

FIG. 66 shows XRD patterns of Sample 1-1 after the fifth charge at 45° C. and different charge voltages. FIG. 67A shows enlarged patterns in the range of 18°≤2θ≤21.5°, and FIG. 67B shows enlarged patterns in the range of 36°≤2θ≤47°. XRD patterns of O3′, O1, H1-3, and LiCoO₂ (O3) are also shown as references.

It was shown from FIG. 64, FIGS. 65A and 65B, FIG. 66, and FIGS. 67A and 67B that in the case where the charge temperature was 45° C. and the charge voltage was 4.6 V, the O3′ type structure appeared after the first charge and the O3″ type structure and the H1-3 type structure appeared after the fifth charge. It was suggested that in the case where the charge voltage was 4.7 V, the proportion of the H1-3 type structure was higher after the fifth charge. It was suggested that in the case where the charge voltage was 4.75 V, the O3″ type structure appeared after the first charge and the sample had the 01 type structure after the fifth charge. In FIGS. 65A and 65B, the peak at 2θ of 19.47±0.10° and the peak at 2θ of 45.62±0.05° are denoted by arrows.

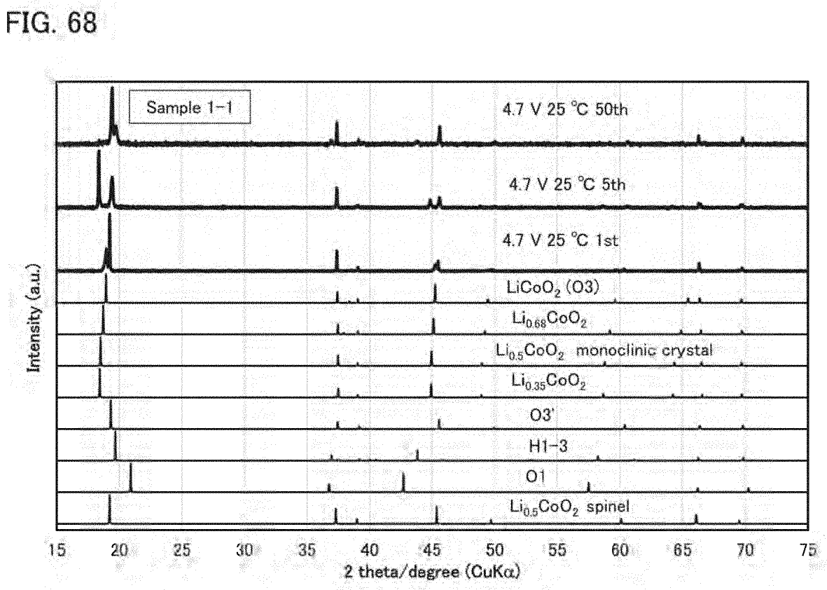

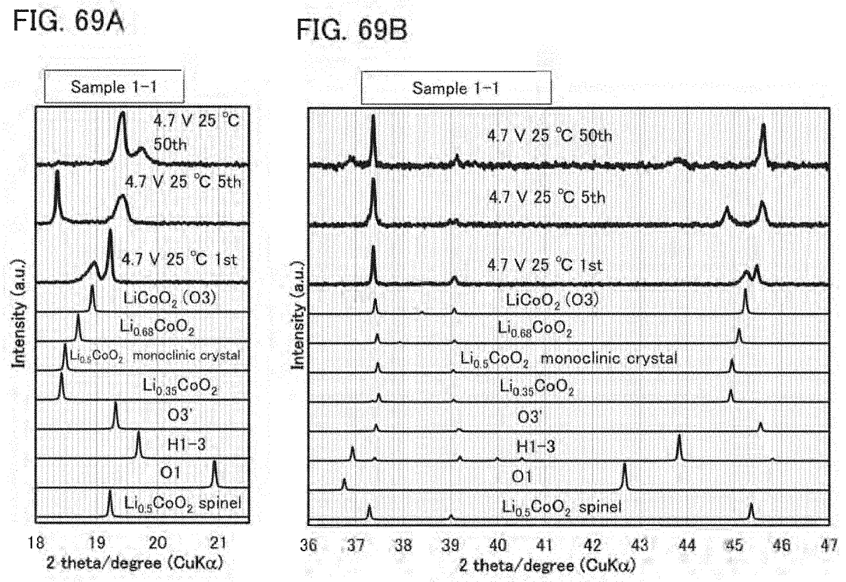

FIG. 68 shows XRD patterns of Sample 1-1 after the first charge, the fifth charge, and the 50th charge at 25° C. and 4.7 V. FIG. 69A shows enlarged patterns in the range of 18°≤2θ≤21.5°, and FIG. 69B shows enlarged patterns in the range of 36°≤2θ≤47°. XRD patterns of Li_{0.5}CoO₂ spinel, O1, H1-3, O3′, Li_{0.35}CoO₂, Li_{0.5}CoO₂ monoclinic crystal, Li_{0.68}CoO₂, and LiCoO₂ (O3) are also shown as references.

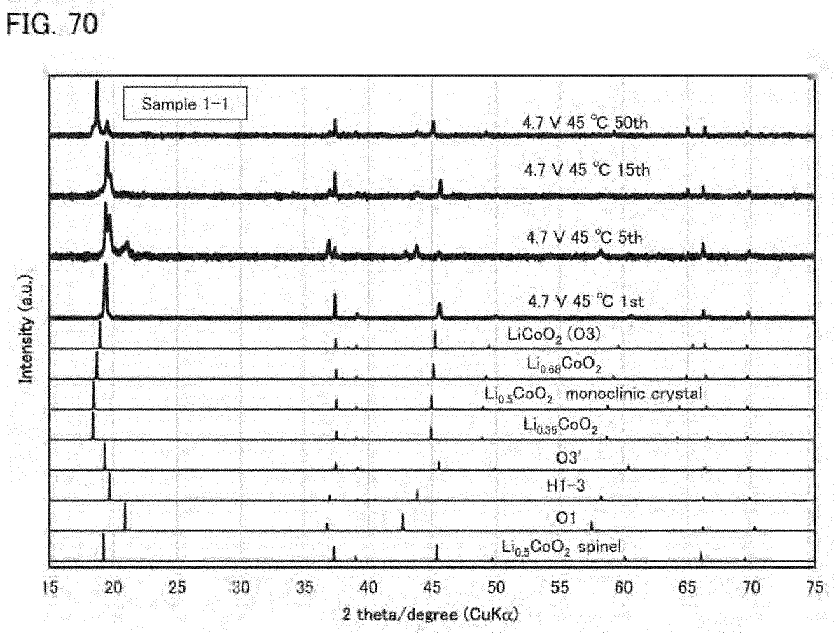

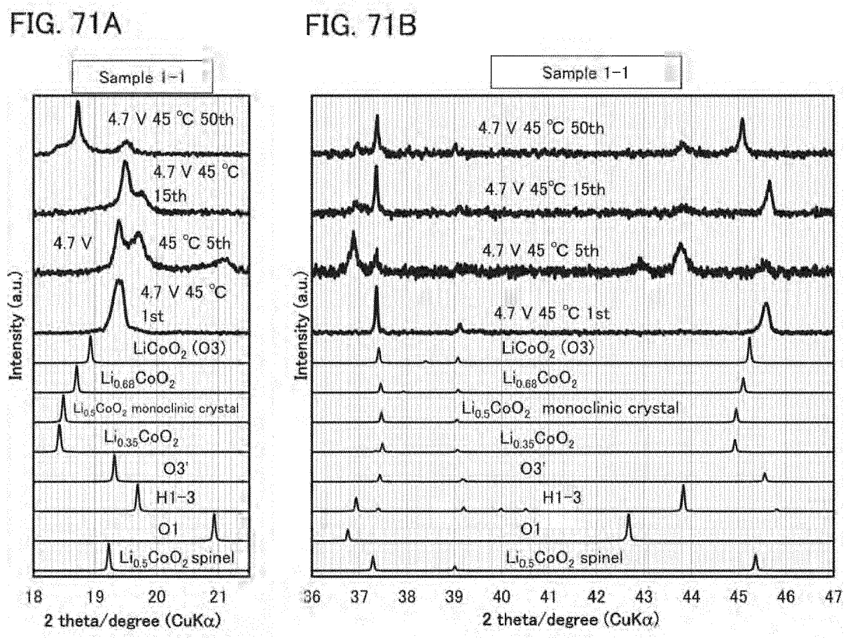

FIG. 70 shows XRD patterns of Sample 1-1 after the first charge, the fifth charge, the 15th charge, and the 50th charge at 45° C. and 4.7 V. FIG. 71A shows enlarged patterns in the range of 18°≤2θ≤21.5°, and FIG. 71B shows enlarged patterns in the range of 36°≤2θ≤47°. XRD patterns of Li_{0.5}CoO₂ spinel, O1, H1-3, O3′, Li_{0.35}CoO₂, Li_{0.5}CoO₂ monoclinic crystal, Li_{0.68}CoO₂, and LiCoO₂ (O3) are also shown as references.

It was suggested that in the case where the charge temperature was 45° C. and the charge voltage was 4.7 V, the sample had mainly the crystal structure of Li_{0.68}CoO₂ after the 50th charge and the charge depth decreased.

Table 5 and Table 6 list typical reciprocal lattice points (hkl), peak positions (2θ (degree)) corresponding to the typical reciprocal lattice points, and full widths at half maximum (FWHM) of the peaks for some XRD patterns in FIG. 60, FIGS. 61A and 61B, FIG. 62, FIGS. 63A and 63B, FIG. 64, FIGS. 65A and 65B, and FIG. 66.

TABLE 5

| | Sample and | | | |
|---|---|---|---|---|
| | conditions of | | 2θ | FWHM |
| | charge | hkl | (degree) | (degree) |
| FIG. | Sample 1-1 | 003 | 19.26 | 0.1282 |
| 60 | 4.8 V 25° C. 1st | 101 | 37.37 | 0.0554 |
| | | 012 | 39.09 | 0.1334 |
| | | 006 | 39.09 | 0.1336 |
| | | 104 | 45.49 | 0.1090 |
| | Sample 1-1 | 003 | 19.22 | 0.0603 |
| | 4.7 V 25° C. 1st | 101 | 37.37 | 0.0548 |
| | | 012 | 39.08 | 0.1041 |
| | | 006 | 39.08 | 0.1041 |
| | | 104 | 45.47 | 0.0746 |
| | Sample 1-1 | 003 | 18.78 | 0.1673 |
| | 4.6 V 25° C. 1st | 101 | 37.38 | 0.0471 |
| | | 006 | 38.16 | 0.2395 |
| | | 012 | 39.03 | 0.0642 |
| | | 104 | 45.13 | 0.1346 |
| FIG. | Sample 1-1 | 003 | 19.47 | 0.2750 |
| 62 | 4.8 V 25° C. 5th | 101 | 37.36 | 0.0614 |
| | | 012 | 39.13 | 0.0668 |
| | | 006 | 39.13 | 0.0672 |
| | | 104 | 45.62 | 0.2058 |
| | Sample 1-1 | 003 | 19.37 | 0.1013 |
| | 4.7 V 25° C. 5th | 101 | 37.37 | 0.0565 |
| | | 012 | 39.12 | 0.0584 |
| | | 006 | 39.12 | 0.0584 |
| | | 104 | 45.57 | 0.0993 |
| | Sample 1-1 | 003 | 19.25 | 0.0761 |
| | 4.6 V 25° C. 5th | 101 | 37.40 | 0.0552 |
| | | 012 | 38.99 | 0.0552 |
| | | 006 | 38.99 | 0.0548 |
| | | 104 | 46.18 | 0.9819 |

TABLE 6

| | Sample and | | | |
|---|---|---|---|---|
| | conditions of | | 2θ | FWHM |
| | charge | hkl | (degree) | (degree) |
| FIG. | Sample 1-1 | 003 | 19.44 | 0.2441 |
| 64 | 4.75 V 45° C. 1st | 101 | 37.36 | 0.0558 |
| | | 012 | 39.12 | 0.0742 |
| | | 006 | 39.12 | 0.0745 |
| | | 104 | 45.61 | 0.1655 |
| | Sample 1-1 | 003 | 19.38 | 0.2060 |
| | 4.7 V 45° C. 1st | 101 | 37.36 | 0.0553 |
| | | 012 | 39.12 | 0.0667 |
| | | 006 | 39.12 | 0.0669 |
| | | 104 | 45.57 | 0.1735 |
| | Sample 1-1 | 003 | 19.26 | 0.0932 |
| | 4.6 V 45° C. 1st | 101 | 37.36 | 0.0577 |
| | | 012 | 39.11 | 0.1273 |
| | | 006 | 39.11 | 0.1266 |
| | | 104 | 45.49 | 0.0997 |
| FIG. | Sample 1-1 | 003 | 19.51 | 0.1996 |
| 66 | 4.75 V 45° C. 5th | 101 | 37.33 | 0.0780 |
| | | 012 | 37.92 | 1.8963 |
| | | 006 | 38.21 | 1.5897 |
| | | 104 | 45.59 | 0.1321 |
| | Sample 1-1 | 003 | 19.39 | 0.1127 |
| | 4.7 V 45° C. 5th | 101 | 37.35 | 0.0797 |
| | | 012 | 39.22 | 0.3804 |
| | | 006 | 39.25 | 0.5196 |
| | | 104 | 45.54 | 0.2581 |

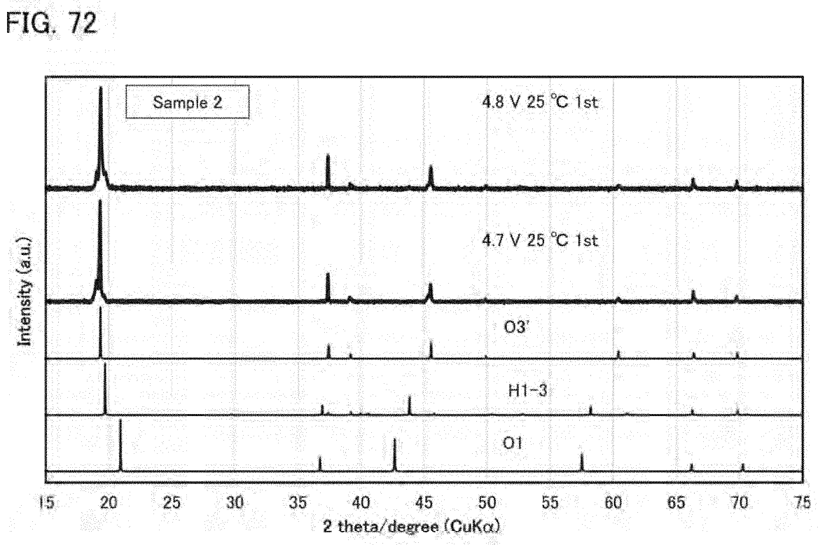

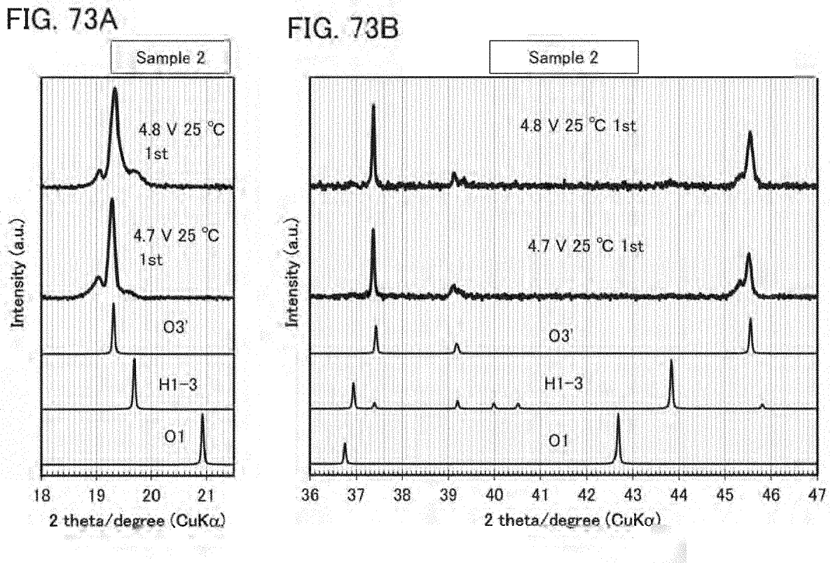

FIG. 72 shows XRD patterns of Sample 2 after the first charge at 25° C. FIG. 73A shows enlarged patterns in the range of 18°≤2θ≤21.5°, and FIG. 73B shows enlarged patterns in the range of 36°≤2θ≤47°. XRD patterns of O1, H1-3, and O3′ are also shown as references.

It was shown from FIG. 72 and FIGS. 73A and 73B that in the case where the charge temperature was 25° C. and the charge voltage was 4.7 V or 4.8 V, the O3′ type structure appeared after the first charge.

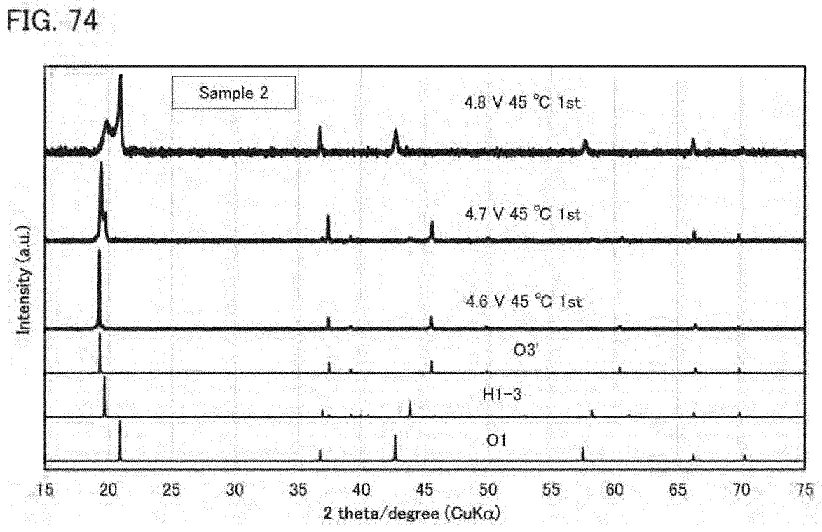

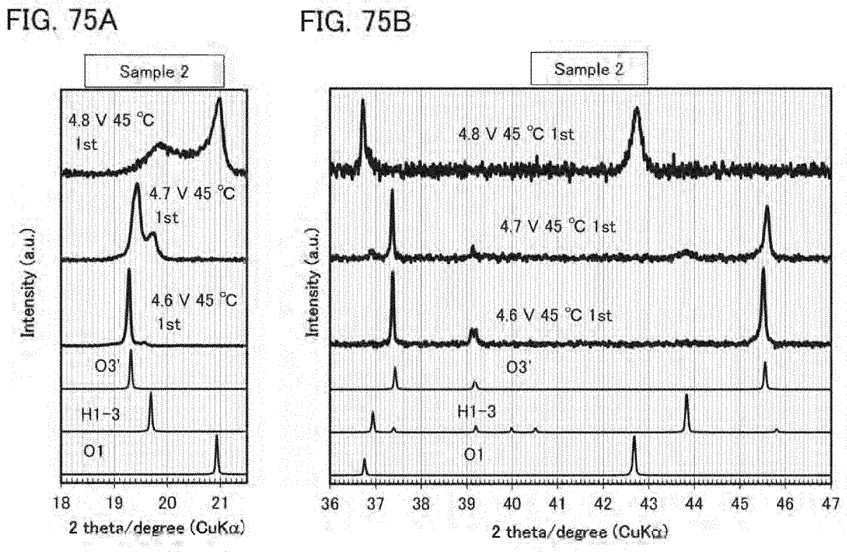

FIG. 74 shows XRD patterns of Sample 2 after the first charge at 45° C. and different charge voltages. FIG. 75A shows enlarged patterns in the range of 18°≤2θ≤21.5°, and FIG. 75B shows enlarged patterns in the range of 36°≤2θ≤47°. XRD patterns of O1, H1-3, and O3′ are also shown as references.

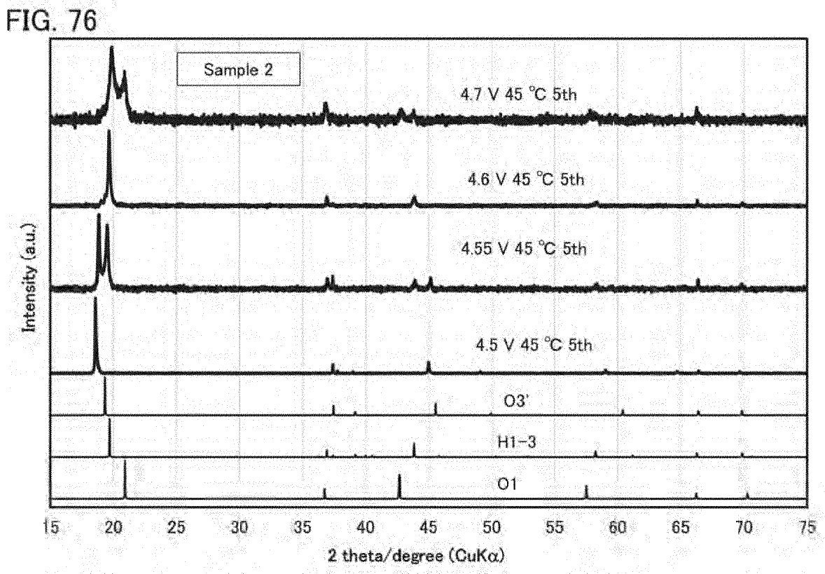

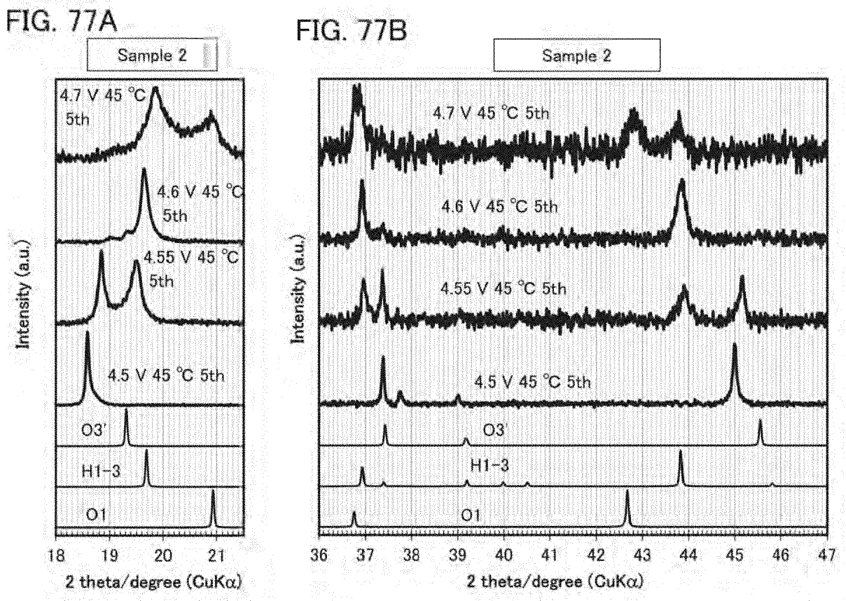

FIG. 76 shows XRD patterns of Sample 2 after the fifth charge at 45° C. and different charge voltages. FIG. 77A shows enlarged patterns in the range of 18°≤2θ≤21.5°, and FIG. 77B shows enlarged patterns in the range of 36°≤2θ≤47°. XRD patterns of O1, H1-3, and O3′ are also shown as references.

It was shown from FIG. 74, FIGS. 75A and 75B, FIG. 76, and FIGS. 77A and 77B that in the case where the charge temperature was 45° C. and the charge voltage was 4.6 V, the O3′ type structure appeared after the first charge and the H1-3 type structure appeared after the fifth charge. In the case where the charge voltage was 4.7 V, the H1-3 type structure already appeared after the first charge and the O3′ type structure and the O3″ type structure hardly appeared after the fifth charge. In the case where the charge voltage was 4.8 V, the O1 type structure already appeared after the first charge.

It was thus shown that as compared to the positive electrode active material of Sample 2 on which the initial heating was not performed, the positive electrode active material of Sample 1-1 on which the initial heating was performed in its formation was unlikely to be changed into the H1-3 type structure and likely to maintain its crystal structure even when charge and discharge with a larger charge depth due to a high voltage and/or a high temperature, for example, are performed.

It was also suggested that Sample 1-1 has mainly the O3″ type structure after charge under certain charge conditions, e.g., after the fifth charge at 25° C. and 4.8 V and after the first charge at 45° C. and 4.75 V.

### <Rietveld Analysis>

Next, Rietveld analysis was conducted with the use of the XRD patterns of Sample 1-1 described above.

For the Rietveld analysis, an analysis program RIETAN-FP (see F. Izumi and K. Momma, Solid State Phenom., 130, 2007, pp. 15-20) was used.

In the Rietveld analysis, multiphase analysis was conducted to determine the abundance of the O3 type structure, the O3′ type structure, the H1-3 type structure, and the O1 type structure in each sample. Here, the abundance of an amorphous portion in Sample 1-1 not undergoing a charge and discharge cycle was assumed to be zero. The abundance of an amorphous portion in a positive electrode after charge was the remainder of subtraction of the total abundance of the O3 type structure, the O3′ type structure, the H1-3 type structure, and the O1 type structure in the positive electrode after charge from the total abundance of the O3 type structure, the O3′ type structure, the H1-3 type structure, and the O1 type structure in Sample 1-1. Here, the abundance of an amorphous portion in the positive electrode after charge can be regarded as the abundance of an amorphous portion generated or increased by a charge and discharge cycle.

In the Rietveld analysis, the scale factor was a value output by RIETAN-FP. The abundance ratio of each of the O3 type structure, the O3′ type structure, the H1-3 type structure, and the O1 type structure was calculated in molar fraction from the number of the multiplicity factors of the crystal structure and the number of the chemical formula units in a unit cell for the crystal structure. In the Rietveld analysis in this example, each sample was standardized with white noise in the range including no significant signals in the XRD measurement in this example (2θ=greater than or equal to 23° and less than or equal to 27°), and each abundance is not an absolute value but a relative value.

Table 7 lists the abundance ratios (by percentages) of the O3 type structure, the O3′ type structure, the H1-3 type structure, the O1 type structure, and an amorphous portion in Sample 1-1 not undergoing a charge and discharge cycle and those in a positive electrode of a half cell including Sample 1-1 after the first charge or the fifth charge. The temperature at the time of the charge and discharge was 25° C. or 45° C.

TABLE 7

| | xRD analysis | |
|---|---|---|
| | Crystal | Abundance |
| Conditions of charge | structure | ratio (%) |
| Sample 1-1 (without | O3 | 100 |
| charge and discharge) | | |
| Sample 1-1 | O3 | 44 |
| 25° C., 4.7 V 1st | O3′ | 34 |
| | Amorphous | 22 |
| Sample 1-1 | O3 | 32 |
| 25° C., 4.7 V 5th | O3′ | 51 |
| | Amorphous | 17 |
| Sample 1-1 | O3 | 56 |
| 45° C., 4.7 V 1st | O3′ | 32 |
| | Amorphous | 12 |
| Sample 1-1 | O3 | 11 |
| 45° C., 4.7 V 5th | O3′ | 15 |
| | H1-3 | 23 |
| | O1 | 12 |
| | Amorphous | 39 |

It was shown from Table 7 that in the case where charge was performed five or more times at 45° C., the XRD pattern became broad and the proportion of the amorphous region increased.

### Example 3

In this example, resistance components of Sample 1-1 on which the initial heating was performed and Sample 10 (reference) in Example 1 were analyzed.

### <Measurement of Powder Resistivity>

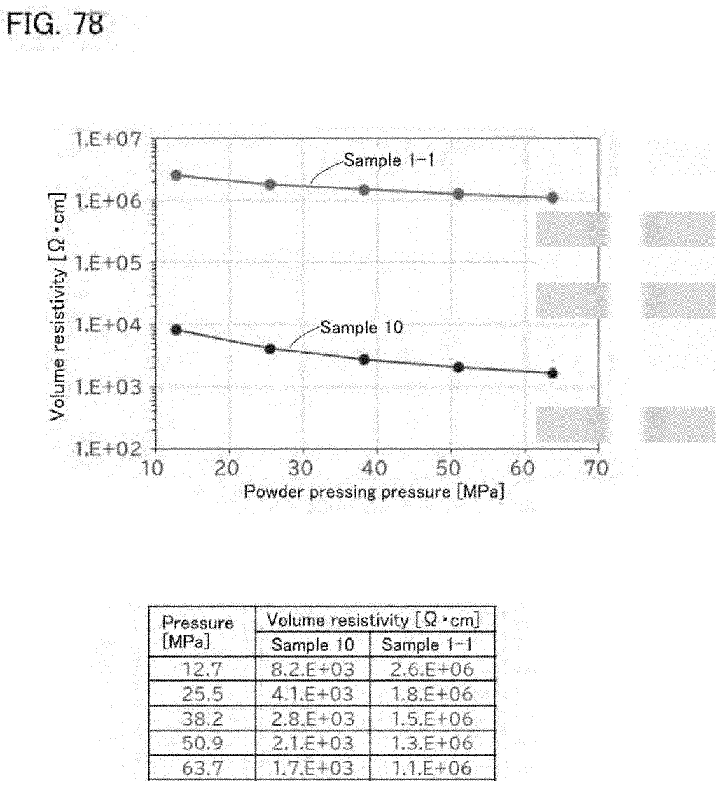

The powder resistivity of Sample 1-1 on which the initial heating was performed and Sample 10 (reference) in Example 1 was measured. As a measurement system, MCP-PD51 (produced by Mitsubishi Chemical Analytech Co., Ltd.) was used; for a device with a four probe method, Loresta-GP and Hiresta-GP were used properly. FIG. 78 shows the results of the powder resistivity measurement.

In FIG. 78, the horizontal axis represents powder pressing pressure and the vertical axis represents volume resistivity. As shown in FIG. 78, Sample 1-1 had higher volume resistivity, i.e., higher powder resistivity, than Sample 10. Since one difference between Sample 1-1 and Sample 10 is the presence or absence of the added element in the surface portion of the active material particle, it can be thus inferred that the presence of the added element in the surface portion leads to a higher powder resistivity.

### <Current-Rest-Method>

Half cells were fabricated using Sample 1-1 on which the initial heating was performed and Sample 10 (reference) in Example 1 and were subjected to measurement by a current-rest-method. The positive electrodes and half cells were fabricated in manners similar to those of the half cells in Example 1. Note that the pressing in the formation of the positive electrode was performed at 210 kN/m.

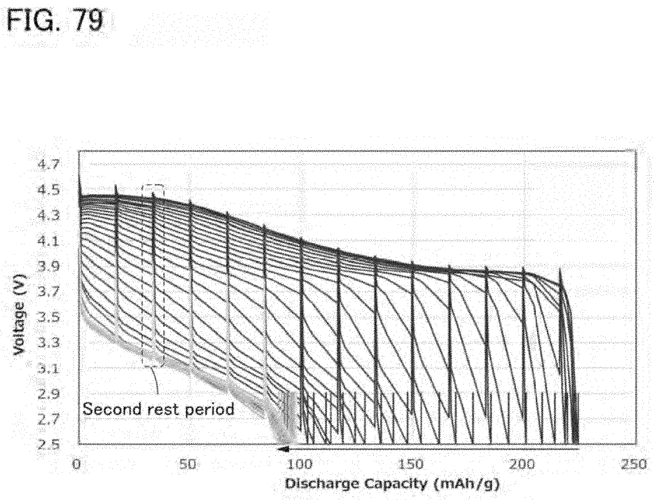

The conditions of the measurement by a current-rest-method are as follows. An HJ1010 SD8 battery charge/discharge system produced by HOKUTO DENKO CORPORATION was used as a measurement system. The charge was constant current constant voltage (CCCV) charge in which constant current charge to 4.70 V was performed at a current rate of 0.5 C and constant voltage charge at 4.70 V was performed until the charge current fell below 0.05 C. The discharge was performed by repeating constant current discharge at 0.5 C for 10 minutes and a 2-minute break (without charge or discharge) until the discharge voltage reached 2.50 V. Note that 38 cycles of the above charge and discharge were performed. FIG. 79 shows a graph in which discharge curves of Sample 1-1 in 25 cycles are overlapped.

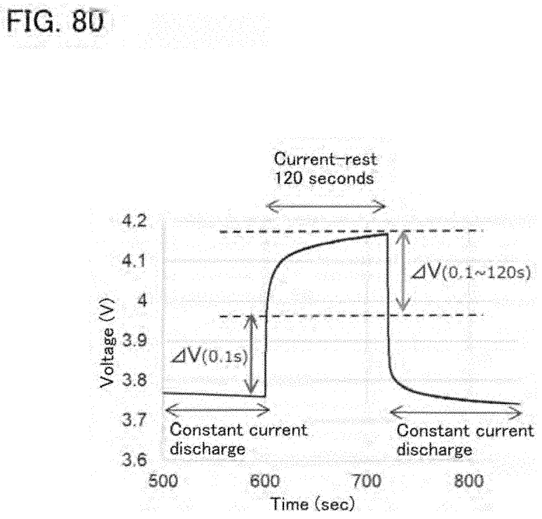

FIG. 80 illustrates an analysis method of internal resistance. The difference between the battery voltage just before a rest period and the battery voltage after 0.1 seconds after the rest period starts is ΔV(0.1 s). The difference between the battery voltage after 0.1 seconds after the rest period starts and the battery voltage after 120 seconds after the rest period starts (the battery voltage when the rest period ends) is ΔV(0.1 to 120 s). ΔV(0.1 s) divided by the current value of the constant current discharge is a resistance component R(0.1 s) with a high response speed, and ΔV(0.1 to 120 s) divided by the current value of the constant current discharge is a resistance component R(0.1 to 120 s) with a low response speed. The resistance component R(0.1 s) with a high response speed can be attributed mainly to electrical resistance (electronic conduction resistance) and movement of lithium ions in the electrolyte solution, whereas the resistance component R(0.1 to 120 s) with a low response speed can be attributed mainly to lithium diffusion resistance in the active material particles.

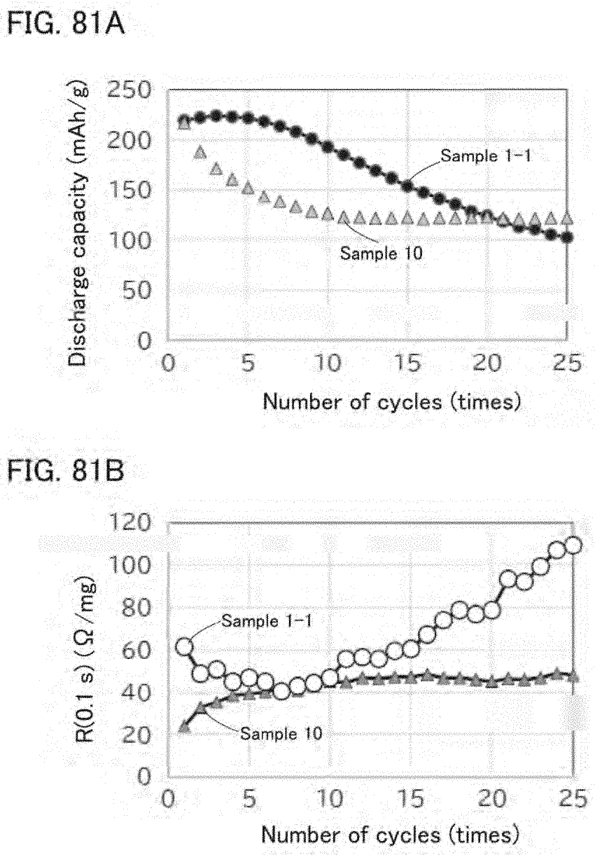

Next, results of the analysis by a current-rest-method are described below. For the second rest period, which is denoted by the dotted line in FIG. 79, the resistance component R(0.1 s) with a high response speed and the resistance component R(0.1 to 120 s) with a low response speed were analyzed using the analysis method illustrated in FIG. 80. As the analysis results of Sample 1-1 and Sample 10, FIG. 81A shows a change in discharge capacity up to the 25th cycle, and FIG. 81B shows a change in the resistance component R(0.1 s) with a high response speed up to the 25th cycle. In each graph, circles denote the results of the half cell including Sample 1-1 and triangles denote the results of the half cell including Sample 10.

As shown in FIG. 81A, as the charge and discharge cycles proceeded, the discharge capacity of Sample 1-1 tended to decrease after increasing. As shown in FIG. 81B, the resistance component R(0.1 s) with a high response speed in Sample 1-1 tended to increase after decreasing; thus, in Sample 1-1, the tendency of a change in discharge capacity probably related to the tendency of a change in the resistance component R(0.1 s) with a high response speed. In other words, in Sample 1-1, the discharge capacity probably increased as the resistance component R(0.1 s) with a high response speed decreased. Note that in Sample 10, the discharge capacity only decreased and the resistance component R(0.1 s) with a high response speed only increased. One difference between Sample 1-1 and Sample 10 is the presence or absence of the added element in the surface portion of the active material particle, and it is probable that the decrease in the resistance component R(0.1 s) with a high response speed shown in FIG. 81B reflects a change in the surface portion containing the added element. The resistance component R(0.1 s) with a high response speed in Sample 1-1 tended to decrease until the seventh charge and discharge in FIG. 81B.

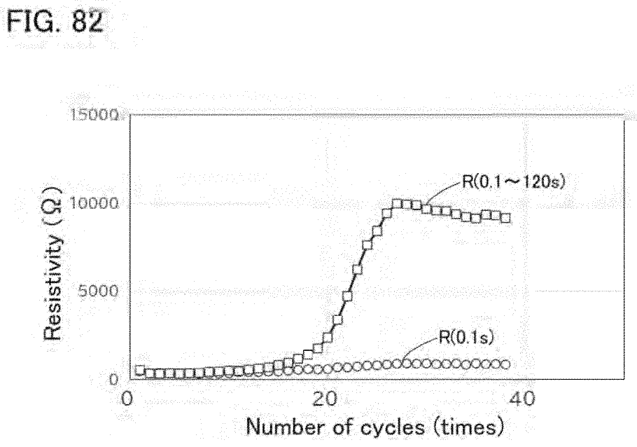

Next, FIG. 82 shows a change in the resistance component R(0.1 s) with a high response speed and the resistance component R(0.1 to 120 s) with a low response speed in Sample 1-1 up to the 38th cycle. Squares denote the change in the resistance component R(0.1 to 120 s) with a low response speed, whereas circles denote the change in the resistance component R(0.1 s) with a high response speed.

As shown in FIG. 82, the resistance component R(0.1 to 120 s) with a low response speed changed more than the resistance component R(0.1 s) with a high response speed. The resistance component R(0.1 to 120 s) with a low response speed abruptly increased around the 20th cycle and was substantially constant from the 27th cycle. It is thus presumable that when Sample 1-1 significantly degrades under charge and discharge cycle conditions at 4.70 V and 45° C., the lithium diffusion resistance, which is a main factor of the resistance component R(0.1 to 120 s) with a low response speed, is extremely high.

This application is based on Japanese Patent Application Serial No. 2020-179129 filed with Japan Patent Office on Oct. 26, 2020, Japanese Patent Application Serial No. 2020-186325 filed with Japan Patent Office on Nov. 9, 2020, and Japanese Patent Application Serial No. 2021-047835 filed with Japan Patent Office on Mar. 22, 2021, the entire contents of which are hereby incorporated by reference.

What is claimed is:

1. A secondary battery comprising a positive electrode,
wherein, to form a battery, the positive electrode is used as a positive electrode, a lithium metal is used for a negative electrode, and 1 mol/L lithium hexafluorophosphate and a mixture comprising ethylene carbonate (EC) and diethyl carbonate (DEC) at a volume ratio of 3:7 and vinylene carbonate at 2 wt % are used for an electrolyte solution,
wherein the battery is subjected to charge to 4.9 V at 10 mA/g in a 25-° C. environment,
wherein capacitance (Q) and voltage (V) are measured during the charge,
wherein a dQ/dVvsV curve obtained by differentiation of the capacitance (Q) with the voltage (V) (dQ/dV) has a first peak at greater than or equal to 4.5 V and less than or equal to 4.6 V, and
wherein the first peak has a full width at half maximum of greater than or equal to 0.10.

2. The secondary battery according to claim 1,
wherein the dQ/dVvsV curve has a second peak at greater than or equal to 4.15 V and less than or equal to 4.25 V, and
wherein a ratio P1/P2 between an intensity P1 of the first peak and an intensity P2 of the second peak is less than or equal to 0.8.

3. The secondary battery according to claim 1,
wherein the positive electrode comprises a positive electrode active material, and
wherein the positive electrode active material has a layered rock-salt crystal structure.

4. The secondary battery according to claim 3,
wherein the positive electrode active material comprises lithium, a transition metal M, magnesium, and fluorine.

5. The secondary battery according to claim 4,
wherein the positive electrode active material further comprises aluminum or titanium.

6. The secondary battery according to claim 1,
wherein the positive electrode comprises a positive electrode active material, and
wherein the positive electrode active material comprises a transition metal M.

7. The secondary battery according to claim 6,
wherein greater than or equal to 90 at % of the transition metal M is cobalt.

8. The secondary battery according to claim 1,
wherein at an initial stage of charge and discharge cycles of the battery, a resistance component R(0.1 s) with a high response speed measured by a current-rest-method is lower in n+1-th discharge than in n-th discharge and n+1-th discharge capacity is higher than n-th discharge capacity, and
wherein n is a natural number larger than 1.

9. The secondary battery according to claim 1,
wherein in charge and discharge cycles of the battery, a resistance component R(0.1 s) with a high response speed has a minimum value in any of second to tenth discharge and discharge capacity is highest in any of the second to tenth discharge, and
wherein the resistance component R(0.1 s) with a high response speed is a value obtained by performing a first step of performing constant current discharge at a current value of 100 mA/g for 5 minutes and a second step of performing a 2-minute break in which charge and discharge are not performed, and dividing, by the current value, a difference between voltage after 0.1 seconds after start of the second step and final voltage in the first step.

10. An electronic device comprising:
the secondary battery according to claim 1;
a display portion; and
a sensor.

11. A secondary battery comprising a positive electrode,
wherein, to form a battery, the positive electrode is used as a positive electrode, a lithium metal is used for a negative electrode, and 1 mol/L lithium hexafluorophosphate and a mixture comprising ethylene carbonate (EC) and diethyl carbonate (DEC) at a volume ratio of 3:7 and vinylene carbonate at 2 wt % are used for an electrolyte solution,
wherein the battery is subjected to constant current charge to 4.75 V at 10 mA/g in a 45-° C. environment,
wherein the positive electrode of the battery is analyzed by powder X-ray diffraction with CuKα₁ radiation in an argon atmosphere after the constant current charge, and
wherein an XRD pattern of the positive electrode has at least a diffraction peak at 2θ of 19.47±0.10° and a diffraction peak at 2θ of 45.62±0.05°.

12. The secondary battery according to claim 11,
wherein the positive electrode comprises a positive electrode active material, and
wherein the positive electrode active material has a layered rock-salt crystal structure.

13. The secondary battery according to claim 12,
wherein the positive electrode active material comprises lithium, a transition metal M, magnesium, and fluorine.

14. The secondary battery according to claim 13,
wherein the positive electrode active material further comprises aluminum or titanium.

15. The secondary battery according to claim 11,
wherein the positive electrode comprises a positive electrode active material, and
wherein the positive electrode active material comprises a transition metal M.

16. The secondary battery according to claim 15,
wherein greater than or equal to 90 at % of the transition metal M is cobalt.

17. The secondary battery according to claim 11,
wherein at an initial stage of charge and discharge cycles of the battery, a resistance component R(0.1 s) with a high response speed measured by a current-rest-method is lower in n+1-th discharge than in n-th discharge and n+1-th discharge capacity is higher than n-th discharge capacity, and
wherein n is a natural number larger than 1.

18. The secondary battery according to claim 11,
wherein in charge and discharge cycles of the battery, a resistance component R(0.1 s) with a high response speed has a minimum value in any of second to tenth discharge and discharge capacity is highest in any of the second to tenth discharge, and
wherein the resistance component R(0.1 s) with a high response speed is a value obtained by performing a first step of performing constant current discharge at a current value of 100 mA/g for 5 minutes and a second step of performing a 2-minute break in which charge and discharge are not performed, and dividing, by the current value, a difference between voltage after 0.1 seconds after start of the second step and final voltage in the first step.

19. An electronic device comprising:
the secondary battery according to claim 11;
a display portion; and
a sensor.

20. A secondary battery comprising a positive electrode,
wherein, to form a battery, the positive electrode is used as a positive electrode, a lithium metal is used for a negative electrode, and 1 mol/L lithium hexafluorophosphate and a mixture comprising ethylene carbonate (EC) and diethyl carbonate (DEC) at a volume ratio of 3:7 and vinylene carbonate at 2 wt % are used for an electrolyte solution,
wherein the battery is subjected to charge and discharge alternately repeated four times and subsequent constant current charge to 4.8 V at 10 mA/g in a 25-° C. environment, the charge being constant current charge to 4.8 V at 100 mA/g and subsequent constant voltage charge to 10 mA/g, the discharge being constant current discharge to 2.5 V at 100 mA/g,
wherein the positive electrode of the battery is analyzed by powder X-ray diffraction with CuKα₁ radiation in an argon atmosphere after the constant current charge to 4.8 V at 10 mA/g, and
wherein an XRD pattern of the positive electrode has at least a diffraction peak at 2θ of 19.47±0.10° and a diffraction peak at 2θ of 45.62±0.05°.

21. The secondary battery according to claim 20,
wherein the positive electrode comprises a positive electrode active material, and
wherein the positive electrode active material has a layered rock-salt crystal structure.

22. The secondary battery according to claim 21,
wherein the positive electrode active material comprises lithium, a transition metal M, magnesium, and fluorine.

23. The secondary battery according to claim 22,
wherein the positive electrode active material further comprises aluminum or titanium.

24. The secondary battery according to claim 20,
wherein the positive electrode comprises a positive electrode active material, and
wherein the positive electrode active material comprises a transition metal M.

25. The secondary battery according to claim 24,
wherein greater than or equal to 90 at % of the transition metal M is cobalt.

26. The secondary battery according to claim 20,
wherein at an initial stage of charge and discharge cycles of the battery, a resistance component R(0.1 s) with a high response speed measured by a current-rest-method is lower in n+1-th discharge than in n-th discharge and n+1-th discharge capacity is higher than n-th discharge capacity, and
wherein n is a natural number larger than 1.

27. The secondary battery according to claim 20,
wherein in charge and discharge cycles of the battery, a resistance component R(0.1 s) with a high response speed has a minimum value in any of second to tenth discharge and discharge capacity is highest in any of the second to tenth discharge, and
wherein the resistance component R(0.1 s) with a high response speed is a value obtained by performing a first step of performing constant current discharge at a current value of 100 mA/g for 5 minutes and a second step of performing a 2-minute break in which charge and discharge are not performed, and dividing, by the current value, a difference between voltage after 0.1 seconds after start of the second step and final voltage in the first step.

28. An electronic device comprising:
the secondary battery according to claim 20;
a display portion; and
a sensor.
